(19) United States
(12) Patent Application Publication
(10) Pub. No.: US 2026/0230700 A1
(43) Pub. Date: Aug. 6, 2026

(54) USER INTERFACES FOR MEDIA GENERATION

(71) Applicant: Apple Inc., Cupertino, CA (US)

(72) Inventors: Fiona P. O'LEARY, Palo Alto, CA (US); Sean Z. AMADIO, San Francisco, CA (US); Jeffrey T. BERNSTEIN, San Francisco, CA (US); Mark K. HAUENSTEIN, Richmond (GB)

(21) Appl. No.: 19/453,990

(22) Filed: Jan. 20, 2026

Related U.S. Application Data
(60) Provisional application No. 63/755,169, filed on Feb. 6, 2025.

(51) Int. Cl. H04N 23/62; G06F 3/01; G06F 3/16; H04N 23/63

(52) U.S. Cl. CPC H04N 23/62; H04N 23/632; G06F 3/017; G06F 3/167

(57) ABSTRACT

The present disclosure generally relates to generating media items using computer systems. In some examples, when a captured field-of-view of an environment includes a representation of particular content, a process is automatically initiated to replace the representation of the content with a repositioned representation. In some examples, after reframing a camera view in response to a first set of inputs, changes to the framing of the camera view are reversed in response to an air gesture. In some examples, a camera view is reframed based on both detected gesture inputs and speech inputs detected along with the gesture inputs.

### CROSS-REFERENCE TO RELATED APPLICATIONS

This application claims priority to U.S. Provisional Patent Application No. 63/755,169, entitled “USER INTERFACES FOR MEDIA GENERATION,” filed on Feb. 6, 2025, the content of which is incorporated by reference in its entirety for all purposes.

### FIELD

The present disclosure relates generally to computer user interfaces, and more specifically to techniques for providing user interfaces for generating media items.

### BACKGROUND

Electronic devices such as smart phones, tablets, and wearable devices, provide user interfaces for creating visual media (e.g., photo and video media) using one or more cameras. Example user interfaces for creating visual media using a camera can be interacted with (e.g., controlled) using displayed software controls, such as interactive user interface elements that can be interacted with via a touch-sensitive surface of a display, to compose, capture, view, and edit media via the electronic devices.

### BRIEF SUMMARY

Some techniques for generating media items using electronic devices, however, are generally cumbersome and inefficient. For example, some existing techniques use a complex and time-consuming user interface, which may include multiple key presses or keystrokes and/or frequent use of a control device such as a mouse, trackpad, or stylus. Some existing techniques also require knowledge and expertise with sophisticated software, such as media editing software. Existing techniques require more time than necessary, wasting user time and device energy. This latter consideration is particularly important in battery-operated devices.

Accordingly, the present technique provides electronic devices with faster, more efficient methods and interfaces for generating media items. Such methods and interfaces optionally complement or replace other methods for generating media items. Such methods and interfaces reduce the cognitive burden on a user and produce a more efficient human-machine interface. Such methods and interfaces reduce the number of inputs and time needed to perform media operations and provide additional control options without cluttering the interface with additional displayed controls. For battery-operated computing devices, such methods and interfaces conserve power and increase the time between battery charges.

In accordance with some embodiments, a method performed at a computer system that is in communication with one or more display generation components and one or more input devices including one or more cameras is described. The method includes: detecting, via the one or more input devices, a sequence of one or more inputs corresponding to a request to capture media corresponding to an environment; in response to detecting the sequence of one or more inputs corresponding to the request to capture media corresponding to the environment, capturing, via the one or more cameras, a representation of a field-of-view of the environment; and after capturing the representation of the field-of-view of the environment, in accordance with a determination that the representation of the field-of-view of the environment includes a first representation of a first type of object in a first position in the representation of the field-of-view of the environment, initiating a process for displaying the representation of the field-of-view of the environment with a second representation of the first type of object in a second position in the representation of the field-of-view of the environment that is different from the first position in the representation of the field-of-view of the environment.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices including one or more cameras, the one or more programs including instructions for: detecting, via the one or more input devices, a sequence of one or more inputs corresponding to a request to capture media corresponding to an environment; in response to detecting the sequence of one or more inputs corresponding to the request to capture media corresponding to the environment, capturing, via the one or more cameras, a representation of a field-of-view of the environment; and after capturing the representation of the field-of-view of the environment, in accordance with a determination that the representation of the field-of-view of the environment includes a first representation of a first type of object in a first position in the representation of the field-of-view of the environment, initiating a process for displaying the representation of the field-of-view of the environment with a second representation of the first type of object in a second position in the representation of the field-of-view of the environment that is different from the first position in the representation of the field-of-view of the environment.

In accordance with some embodiments, a transitory computer-readable storage medium is described. The transitory computer-readable storage medium stores one or more programs configured to be executed by one or more processors of a computer system that is in communication with one or more display generation components and one or more input devices including one or more cameras, the one or more programs including instructions for: detecting, via the one or more input devices, a sequence of one or more inputs corresponding to a request to capture media corresponding to an environment; in response to detecting the sequence of one or more inputs corresponding to the request to capture media corresponding to the environment, capturing, via the one or more cameras, a representation of a field-of-view of the environment; and after capturing the representation of the field-of-view of the environment, in accordance with a determination that the representation of the field-of-view of the environment includes a first representation of a first type of object in a first position in the representation of the field-of-view of the environment, initiating a process for displaying the representation of the field-of-view of the environment with a second representation of the first type of object in a second position in the representation of the field-of-view of the environment that is different from the first position in the representation of the field-of-view of the environment.

In accordance with some embodiments, a computer system is described. The computer system is configured to communicate with one or more display generation components and one or more input devices including one or more cameras, and the computer system comprises: one or more processors; and memory storing one or more programs configured to be executed by the one or more processors, the one or more programs including instructions for: detecting, via the one or more input devices, a sequence of one or more inputs corresponding to a request to capture media corresponding to an environment; in response to detecting the sequence of one or more inputs corresponding to the request to capture media corresponding to the environment, capturing, via the one or more cameras, a representation of a field-of-view of the environment; and after capturing the representation of the field-of-view of the environment, in accordance with a determination that the representation of the field-of-view of the environment includes a first representation of a first type of object in a first position in the representation of the field-of-view of the environment, initiating a process for displaying the representation of the field-of-view of the environment with a second representation of the first type of object in a second position in the representation of the field-of-view of the environment that is different from the first position in the representation of the field-of-view of the environment.

In accordance with some embodiments, a computer system is described. The computer system is configured to communicate with one or more display generation components and one or more input devices including one or more cameras, and the computer system comprises: means for: detecting, via the one or more input devices, a sequence of one or more inputs corresponding to a request to capture media corresponding to an environment; means for, in response to detecting the sequence of one or more inputs corresponding to the request to capture media corresponding to the environment, capturing, via the one or more cameras, a representation of a field-of-view of the environment; and means for, after capturing the representation of the field-of-view of the environment, in accordance with a determination that the representation of the field-of-view of the environment includes a first representation of a first type of object in a first position in the representation of the field-of-view of the environment, initiating a process for displaying the representation of the field-of-view of the environment with a second representation of the first type of object in a second position in the representation of the field-of-view of the environment that is different from the first position in the representation of the field-of-view of the environment.

In accordance with some embodiments, a computer program product is described. The computer program product is configured to be executed by one or more processors of a computer system that is in communication with one or more display generation components and one or more input devices including one or more cameras, the one or more programs including instructions for: detecting, via the one or more input devices, a sequence of one or more inputs corresponding to a request to capture media corresponding to an environment; in response to detecting the sequence of one or more inputs corresponding to the request to capture media corresponding to the environment, capturing, via the one or more cameras, a representation of a field-of-view of the environment; and after capturing the representation of the field-of-view of the environment, in accordance with a determination that the representation of the field-of-view of the environment includes a first representation of a first type of object in a first position in the representation of the field-of-view of the environment, initiating a process for displaying the representation of the field-of-view of the environment with a second representation of the first type of object in a second position in the representation of the field-of-view of the environment that is different from the first position in the representation of the field-of-view of the environment.

In accordance with some embodiments, a method performed at a computer system that is in communication with one or more display generation components and one or more input devices including one or more cameras is described. The method includes: while displaying, via the one or more display generation components, a camera view that includes a representation of a first field-of-view of an environment, detecting, via the one or more input devices, a first set of one or more inputs corresponding to a request to reframe the camera view; in response to detecting the first set of one or more inputs corresponding to a request to reframe the camera view, reframing the camera view to include a representation of a respective changed field-of-view of the environment that is different from the first field-of-view of the environment; after reframing the camera view, detecting, via the one or more cameras, an air gesture; and in response to detecting the air gesture, reframing the camera view to include a representation of a third field-of-view of the environment that is different from the respective changed field-of-view of the environment.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices including one or more cameras, the one or more programs including instructions for: while displaying, via the one or more display generation components, a camera view that includes a representation of a first field-of-view of an environment, detecting, via the one or more input devices, a first set of one or more inputs corresponding to a request to reframe the camera view; in response to detecting the first set of one or more inputs corresponding to a request to reframe the camera view, reframing the camera view to include a representation of a respective changed field-of-view of the environment that is different from the first field-of-view of the environment; after reframing the camera view, detecting, via the one or more cameras, an air gesture; and in response to detecting the air gesture, reframing the camera view to include a representation of a third field-of-view of the environment that is different from the respective changed field-of-view of the environment.

In accordance with some embodiments, a transitory computer-readable storage medium is described. The transitory computer-readable storage medium stores one or more programs configured to be executed by one or more processors of a computer system that is in communication with one or more display generation components and one or more input devices including one or more cameras, the one or more programs including instructions for: while displaying, via the one or more display generation components, a camera view that includes a representation of a first field-of-view of an environment, detecting, via the one or more input devices, a first set of one or more inputs corresponding to a request to reframe the camera view; in response to detecting the first set of one or more inputs corresponding to a request to reframe the camera view, reframing the camera view to include a representation of a respective changed field-of-view of the environment that is different from the first field-of-view of the environment; after reframing the camera view, detecting, via the one or more cameras, an air gesture; and in response to detecting the air gesture, reframing the camera view to include a representation of a third field-of-view of the environment that is different from the respective changed field-of-view of the environment.

In accordance with some embodiments, a computer system is described. The computer system is configured to communicate with one or more display generation components and one or more input devices including one or more cameras, and the computer system comprises: one or more processors; and memory storing one or more programs configured to be executed by the one or more processors, the one or more programs including instructions for: while displaying, via the one or more display generation components, a camera view that includes a representation of a first field-of-view of an environment, detecting, via the one or more input devices, a first set of one or more inputs corresponding to a request to reframe the camera view; in response to detecting the first set of one or more inputs corresponding to a request to reframe the camera view, reframing the camera view to include a representation of a respective changed field-of-view of the environment that is different from the first field-of-view of the environment; after reframing the camera view, detecting, via the one or more cameras, an air gesture; and in response to detecting the air gesture, reframing the camera view to include a representation of a third field-of-view of the environment that is different from the respective changed field-of-view of the environment.

In accordance with some embodiments, a computer system is described. The computer system is configured to communicate with one or more display generation components and one or more input devices including one or more cameras, and the computer system comprises: means for, while displaying, via the one or more display generation components, a camera view that includes a representation of a first field-of-view of an environment, detecting, via the one or more input devices, a first set of one or more inputs corresponding to a request to reframe the camera view; means for, in response to detecting the first set of one or more inputs corresponding to a request to reframe the camera view, reframing the camera view to include a representation of a respective changed field-of-view of the environment that is different from the first field-of-view of the environment; means for, after reframing the camera view, detecting, via the one or more cameras, an air gesture; and means for, in response to detecting the air gesture, reframing the camera view to include a representation of a third field-of-view of the environment that is different from the respective changed field-of-view of the environment.

In accordance with some embodiments, a computer program product is described. The computer program product is configured to be executed by one or more processors of a computer system that is in communication with one or more display generation components and one or more input devices including one or more cameras, the one or more programs including instructions for: while displaying, via the one or more display generation components, a camera view that includes a representation of a first field-of-view of an environment, detecting, via the one or more input devices, a first set of one or more inputs corresponding to a request to reframe the camera view; in response to detecting the first set of one or more inputs corresponding to a request to reframe the camera view, reframing the camera view to include a representation of a respective changed field-of-view of the environment that is different from the first field-of-view of the environment; after reframing the camera view, detecting, via the one or more cameras, an air gesture; and in response to detecting the air gesture, reframing the camera view to include a representation of a third field-of-view of the environment that is different from the respective changed field-of-view of the environment.

In accordance with some embodiments, a method performed at a computer system that is in communication with one or more display generation components and one or more input devices including one or more cameras is described. The method includes: while displaying, via the one or more display generation components, a camera viewfinder including a representation of a first field-of-view of an environment captured using the one or more cameras, detecting, via the one or more input devices, a first set of one or more gesture inputs for reframing the camera viewfinder; and in response to detecting the first set of one or more gesture inputs for reframing the camera viewfinder: in accordance with a determination that the first set of one or more gesture inputs for reframing the camera viewfinder satisfies a first set of criteria that includes a requirement that the one or more gesture inputs were detected along with a first speech input in order for the first set of criteria to be met, displaying, in the camera viewfinder, a representation of a second field-of-view of the environment that is different from the first field-of-view of the environment; and in accordance with a determination that the first set of one or more gesture inputs for reframing the camera viewfinder satisfies a second set of criteria that includes a requirement that the one or more gesture inputs were detected along with a second speech input, different from the first speech input, in order for the second set of criteria to be met, displaying, in the camera viewfinder, a representation of a third field-of-view of the environment that is different from the first field-of-view of the environment and different from the second field-of-view of the environment.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices including one or more cameras, the one or more programs including instructions for: while displaying, via the one or more display generation components, a camera viewfinder including a representation of a first field-of-view of an environment captured using the one or more cameras, detecting, via the one or more input devices, a first set of one or more gesture inputs for reframing the camera viewfinder; and in response to detecting the first set of one or more gesture inputs for reframing the camera viewfinder: in accordance with a determination that the first set of one or more gesture inputs for reframing the camera viewfinder satisfies a first set of criteria that includes a requirement that the one or more gesture inputs were detected along with a first speech input in order for the first set of criteria to be met, displaying, in the camera viewfinder, a representation of a second field-of-view of the environment that is different from the first field-of-view of the environment; and in accordance with a determination that the first set of one or more gesture inputs for reframing the camera viewfinder satisfies a second set of criteria that includes a requirement that the one or more gesture inputs were detected along with a second speech input, different from the first speech input, in order for the second set of criteria to be met, displaying, in the camera viewfinder, a representation of a third field-of-view of the environment that is different from the first field-of-view of the environment and different from the second field-of-view of the environment.

In accordance with some embodiments, a transitory computer-readable storage medium is described. The transitory computer-readable storage medium stores one or more programs configured to be executed by one or more processors of a computer system that is in communication with one or more display generation components and one or more input devices including one or more cameras, the one or more programs including instructions for: while displaying, via the one or more display generation components, a camera viewfinder including a representation of a first field-of-view of an environment captured using the one or more cameras, detecting, via the one or more input devices, a first set of one or more gesture inputs for reframing the camera viewfinder; and in response to detecting the first set of one or more gesture inputs for reframing the camera viewfinder: in accordance with a determination that the first set of one or more gesture inputs for reframing the camera viewfinder satisfies a first set of criteria that includes a requirement that the one or more gesture inputs were detected along with a first speech input in order for the first set of criteria to be met, displaying, in the camera viewfinder, a representation of a second field-of-view of the environment that is different from the first field-of-view of the environment; and in accordance with a determination that the first set of one or more gesture inputs for reframing the camera viewfinder satisfies a second set of criteria that includes a requirement that the one or more gesture inputs were detected along with a second speech input, different from the first speech input, in order for the second set of criteria to be met, displaying, in the camera viewfinder, a representation of a third field-of-view of the environment that is different from the first field-of-view of the environment and different from the second field-of-view of the environment.

In accordance with some embodiments, a computer system is described. The computer system is configured to communicate with one or more display generation components and one or more input devices including one or more cameras, and the computer system comprises: one or more processors; and memory storing one or more programs configured to be executed by the one or more processors, the one or more programs including instructions for: while displaying, via the one or more display generation components, a camera viewfinder including a representation of a first field-of-view of an environment captured using the one or more cameras, detecting, via the one or more input devices, a first set of one or more gesture inputs for reframing the camera viewfinder; and in response to detecting the first set of one or more gesture inputs for reframing the camera viewfinder: in accordance with a determination that the first set of one or more gesture inputs for reframing the camera viewfinder satisfies a first set of criteria that includes a requirement that the one or more gesture inputs were detected along with a first speech input in order for the first set of criteria to be met, displaying, in the camera viewfinder, a representation of a second field-of-view of the environment that is different from the first field-of-view of the environment; and in accordance with a determination that the first set of one or more gesture inputs for reframing the camera viewfinder satisfies a second set of criteria that includes a requirement that the one or more gesture inputs were detected along with a second speech input, different from the first speech input, in order for the second set of criteria to be met, displaying, in the camera viewfinder, a representation of a third field-of-view of the environment that is different from the first field-of-view of the environment and different from the second field-of-view of the environment.

In accordance with some embodiments, a computer system is described. The computer system is configured to communicate with one or more display generation components and one or more input devices including one or more cameras, and the computer system comprises: means for, while displaying, via the one or more display generation components, a camera viewfinder including a representation of a first field-of-view of an environment captured using the one or more cameras, detecting, via the one or more input devices, a first set of one or more gesture inputs for reframing the camera viewfinder; and means for, in response to detecting the first set of one or more gesture inputs for reframing the camera viewfinder: in accordance with a determination that the first set of one or more gesture inputs for reframing the camera viewfinder satisfies a first set of criteria that includes a requirement that the one or more gesture inputs were detected along with a first speech input in order for the first set of criteria to be met, displaying, in the camera viewfinder, a representation of a second field-of-view of the environment that is different from the first field-of-view of the environment; and in accordance with a determination that the first set of one or more gesture inputs for reframing the camera viewfinder satisfies a second set of criteria that includes a requirement that the one or more gesture inputs were detected along with a second speech input, different from the first speech input, in order for the second set of criteria to be met, displaying, in the camera viewfinder, a representation of a third field-of-view of the environment that is different from the first field-of-view of the environment and different from the second field-of-view of the environment.

In accordance with some embodiments, a computer program product is described. The computer program product is configured to be executed by one or more processors of a computer system that is in communication with one or more display generation components and one or more input devices including one or more cameras, the one or more programs including instructions for: while displaying, via the one or more display generation components, a camera viewfinder including a representation of a first field-of-view of an environment captured using the one or more cameras, detecting, via the one or more input devices, a first set of one or more gesture inputs for reframing the camera viewfinder; and in response to detecting the first set of one or more gesture inputs for reframing the camera viewfinder: in accordance with a determination that the first set of one or more gesture inputs for reframing the camera viewfinder satisfies a first set of criteria that includes a requirement that the one or more gesture inputs were detected along with a first speech input in order for the first set of criteria to be met, displaying, in the camera viewfinder, a representation of a second field-of-view of the environment that is different from the first field-of-view of the environment; and in accordance with a determination that the first set of one or more gesture inputs for reframing the camera viewfinder satisfies a second set of criteria that includes a requirement that the one or more gesture inputs were detected along with a second speech input, different from the first speech input, in order for the second set of criteria to be met, displaying, in the camera viewfinder, a representation of a third field-of-view of the environment that is different from the first field-of-view of the environment and different from the second field-of-view of the environment.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for generating media items, thereby increasing the effectiveness, efficiency, and user satisfaction with such devices. Such methods and interfaces may complement or replace other methods for generating media items.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIG. 5C is a block diagram illustrating functions of a digital assistant system of a personal electronic device in accordance with some embodiments.

FIGS. 6A-6L illustrate example techniques and systems for generating media with content-aware modifications, in accordance with some embodiments.

FIG. 7 illustrates a flow diagram of methods for generating media with content-aware modifications, in accordance with some embodiments.

FIGS. 8A-8AC illustrate example techniques and systems for controlling camera framing when generating media, in accordance with some embodiments.

FIG. 9 illustrates a flow diagram of methods for changing and reverting changes to framing of a camera view, in accordance with some embodiments.

FIG. 10 illustrates a flow diagram of methods for changing framing of a camera view based on speech and gesture inputs, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for generating media items. For example, an efficient user interface automatically initiates processes for modifying media items to replace or remove certain types of content, allows users to reframe and revert reframing of media captures, and/or controls reframing of media captures based on gesture and speech inputs. Such techniques can reduce the cognitive burden on a user who use computer systems to create media items, thereby enhancing productivity. Further, such techniques can reduce processor and battery power otherwise wasted on redundant user inputs.

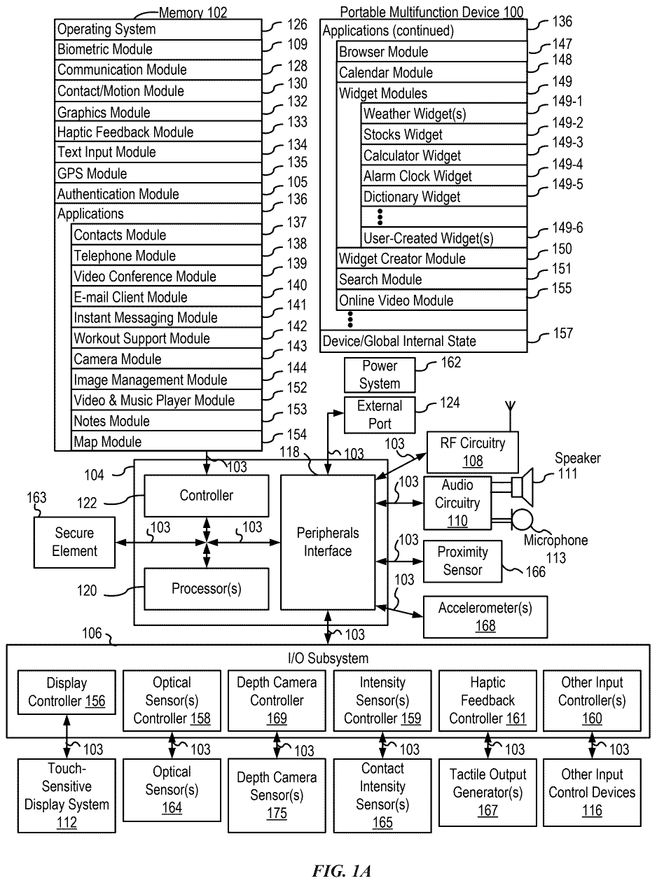

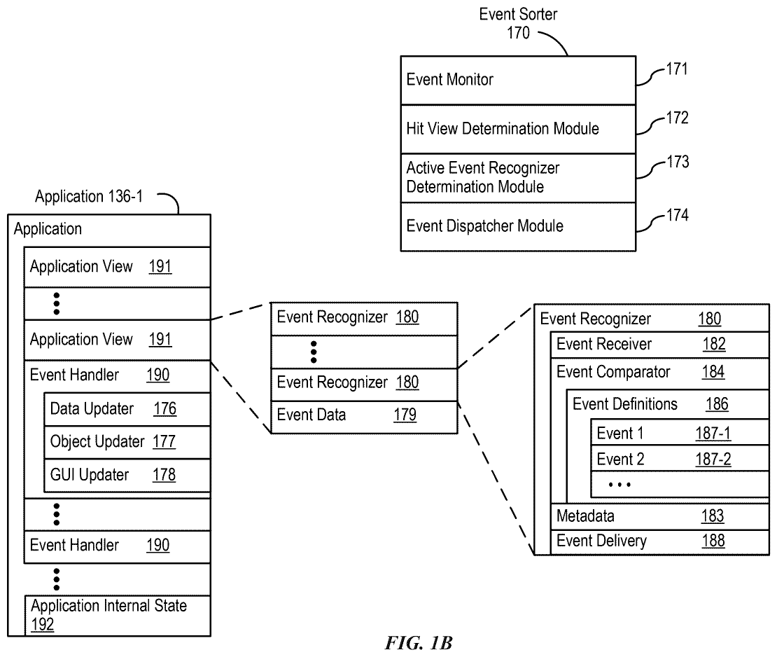

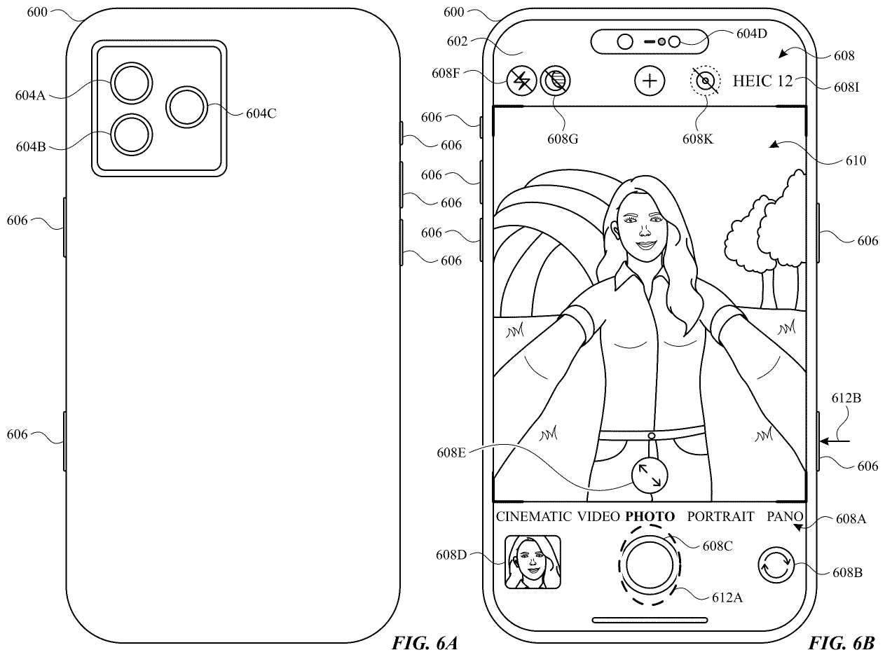

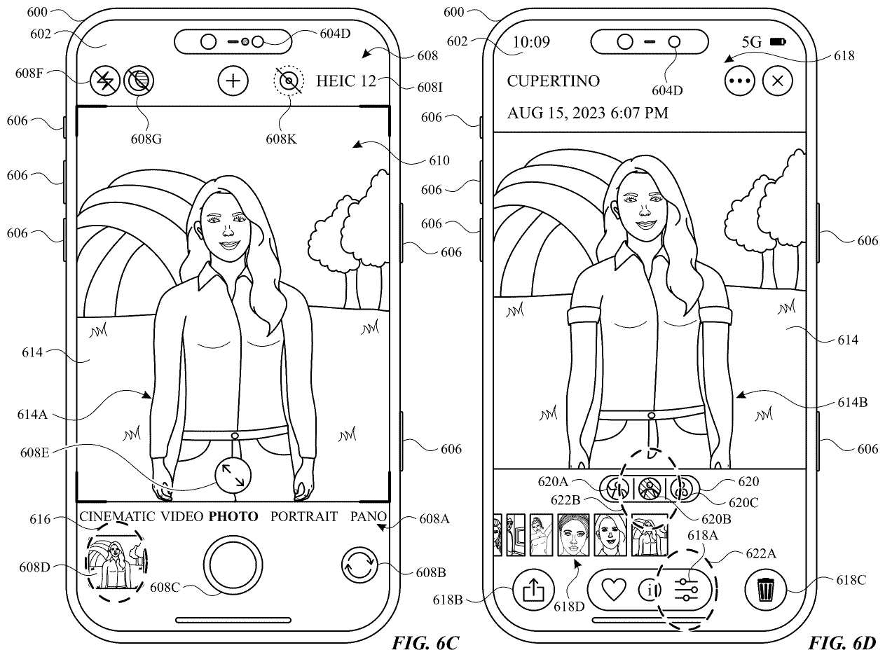

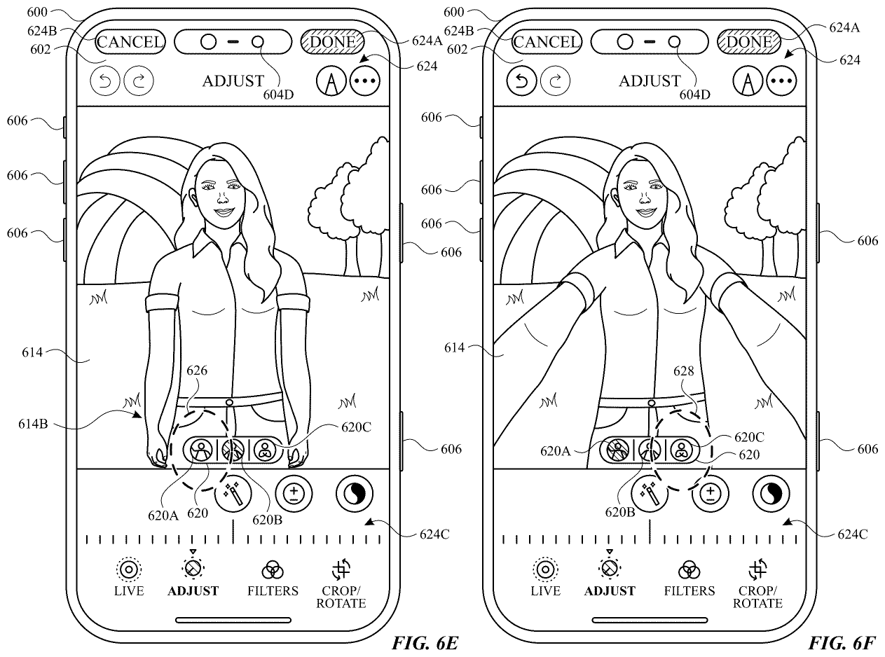

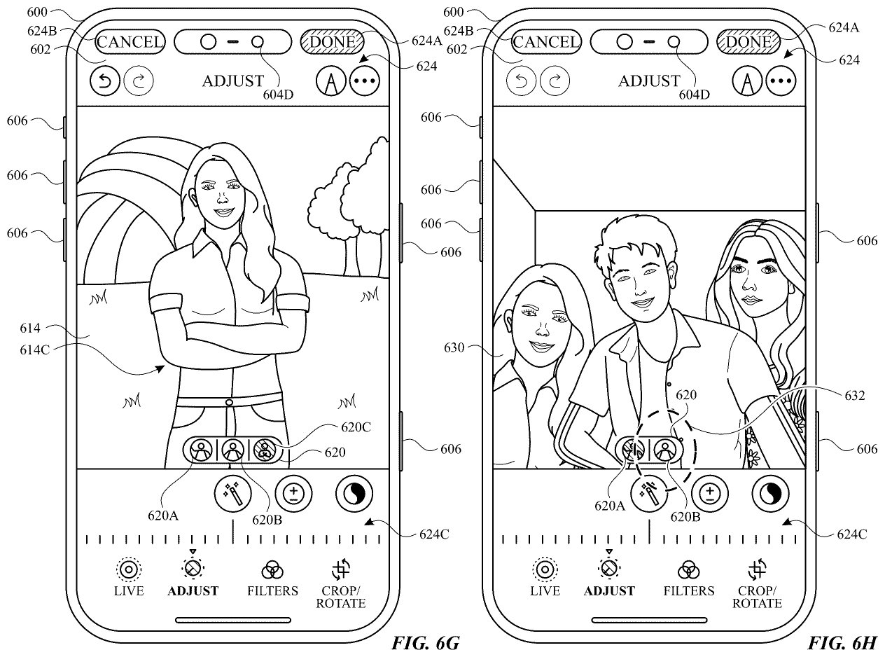

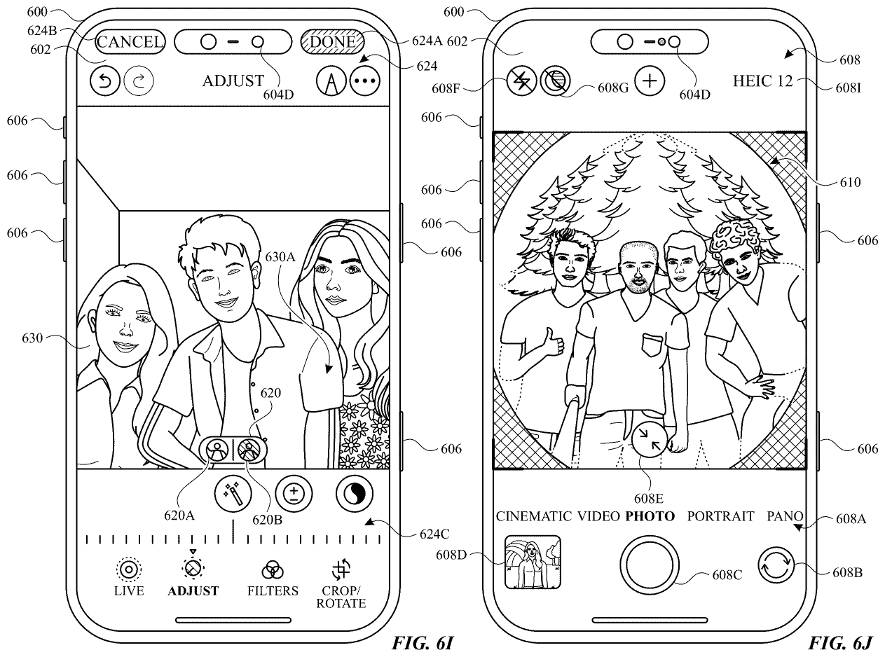

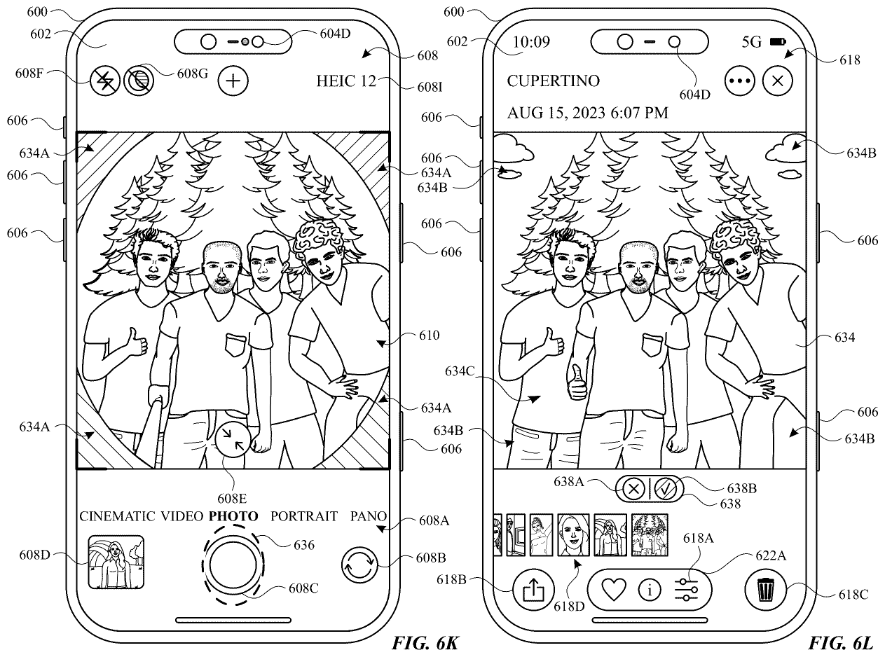

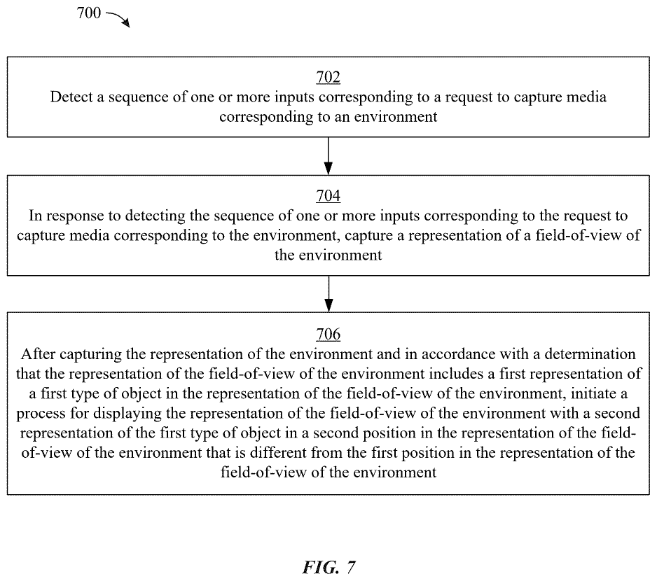

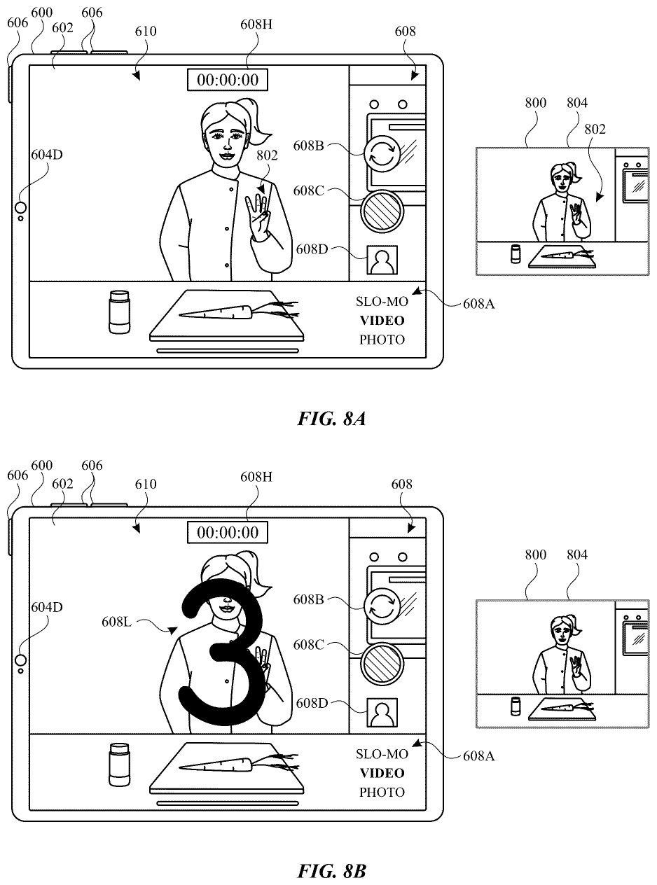

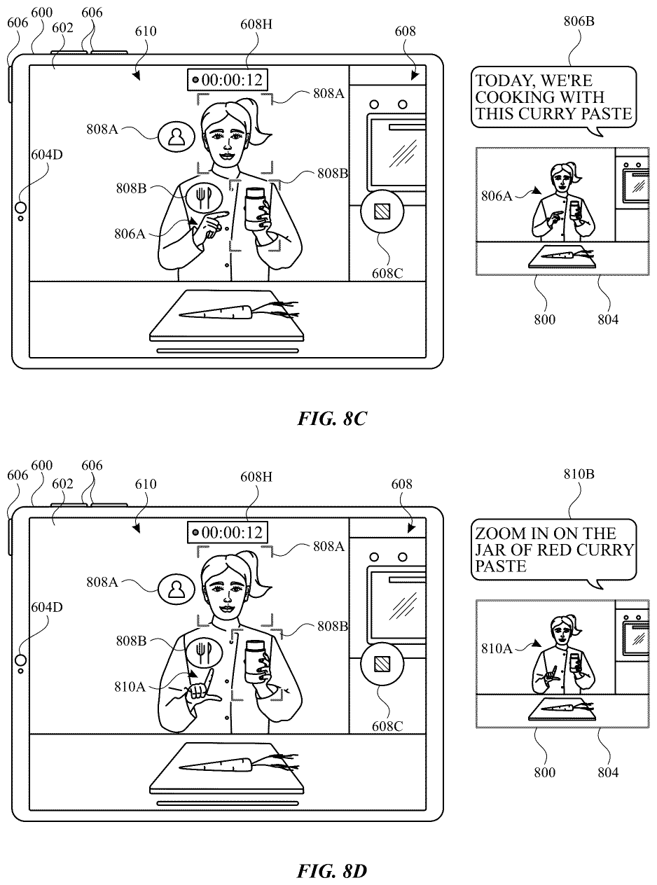

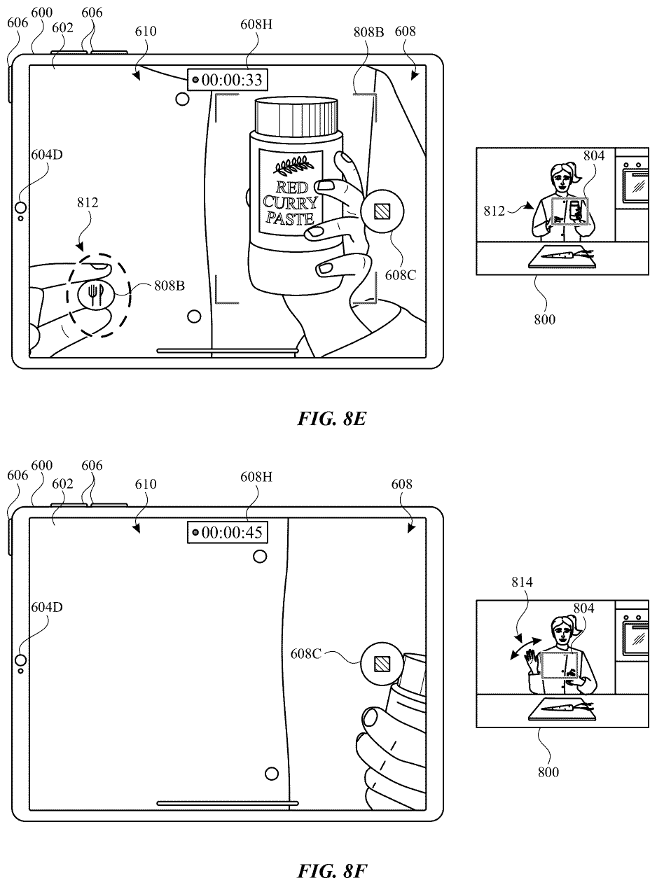

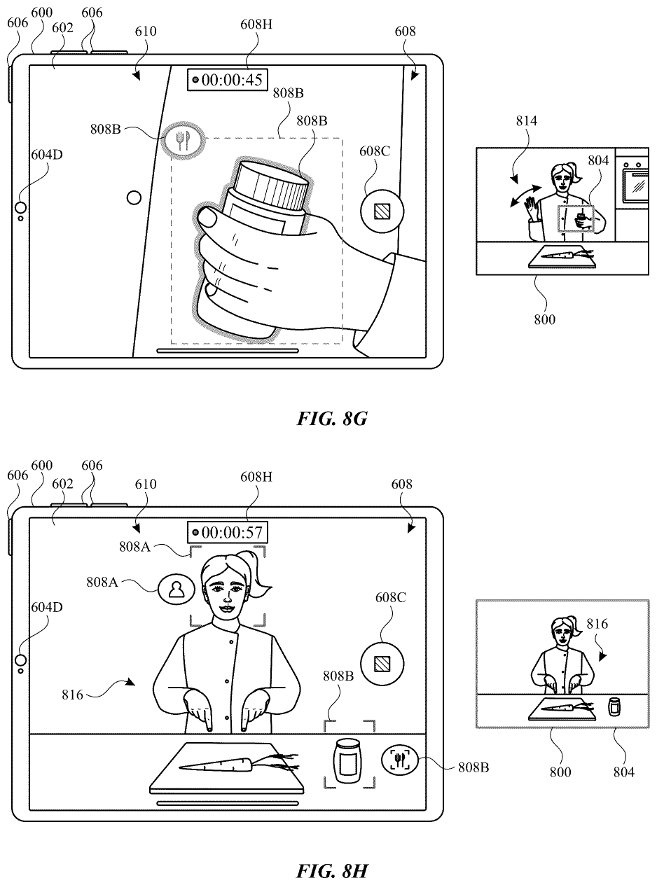

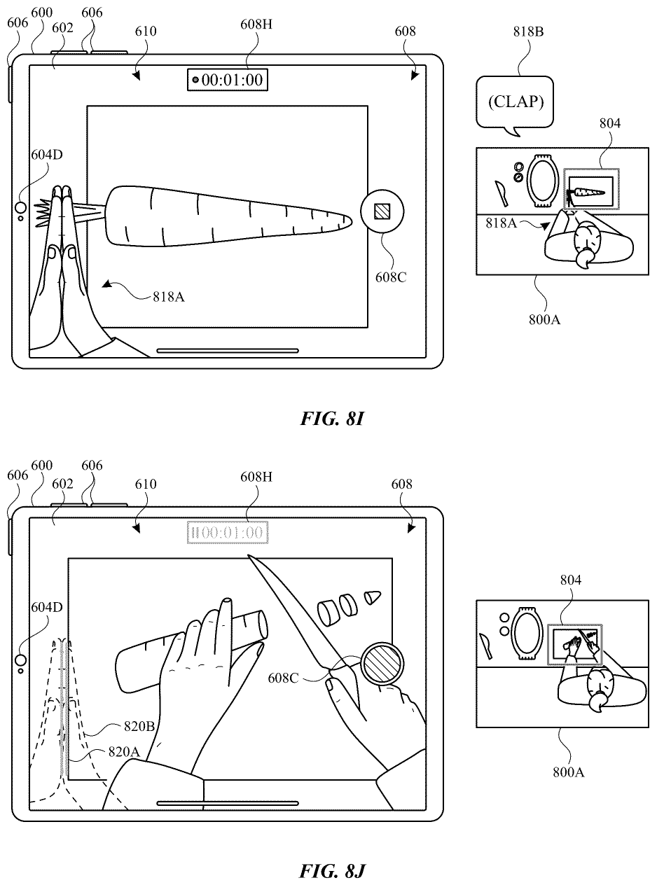

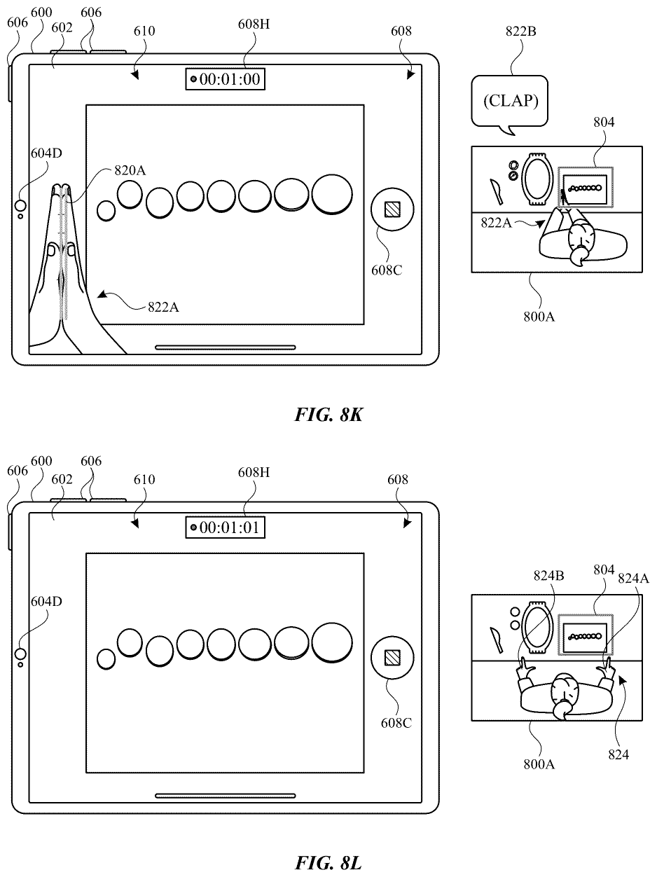

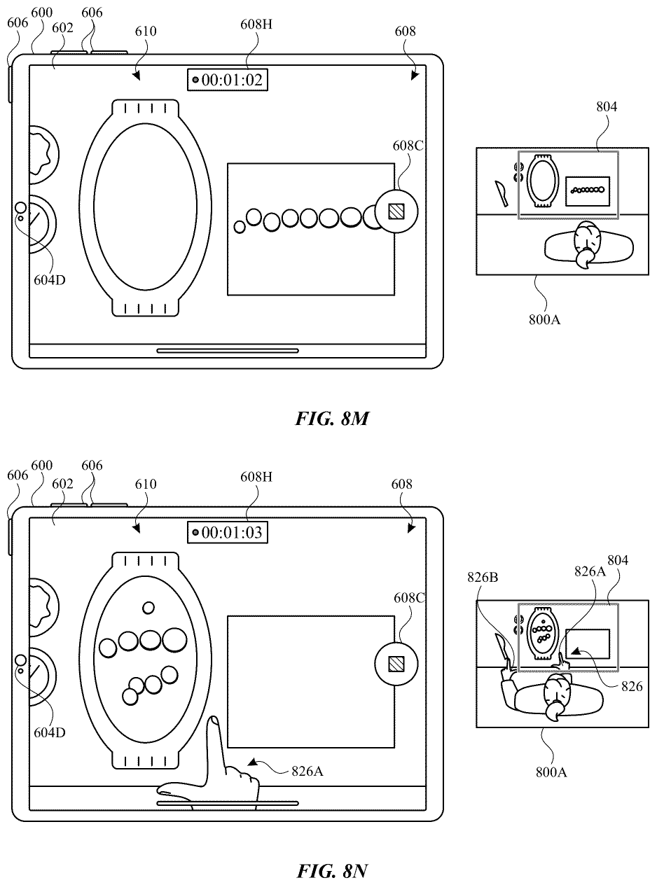

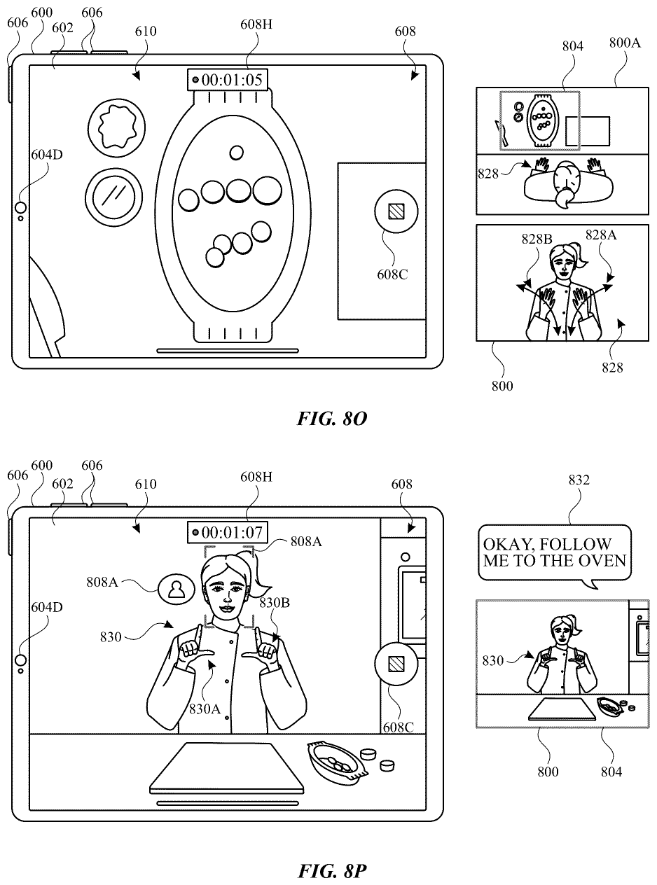

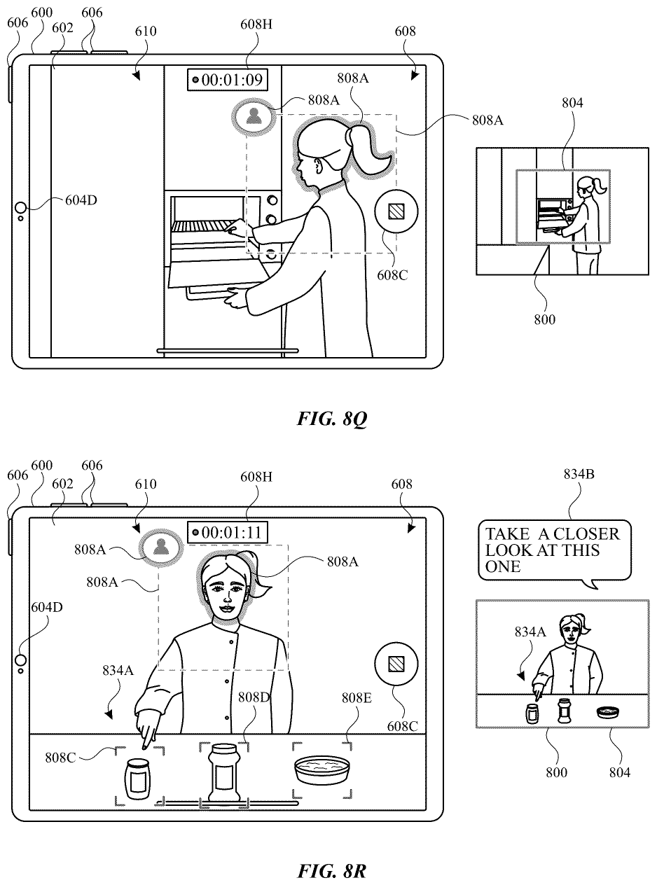

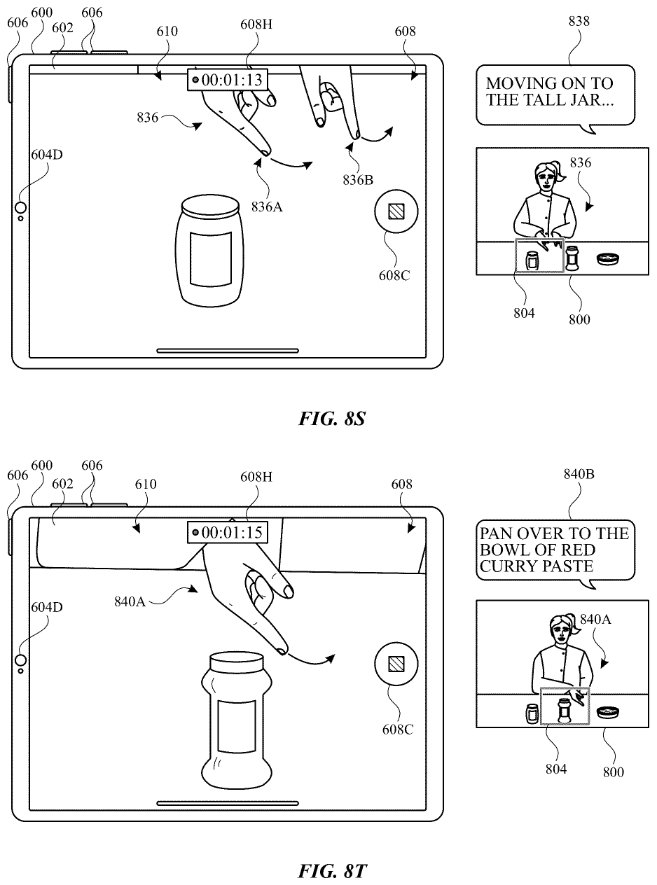

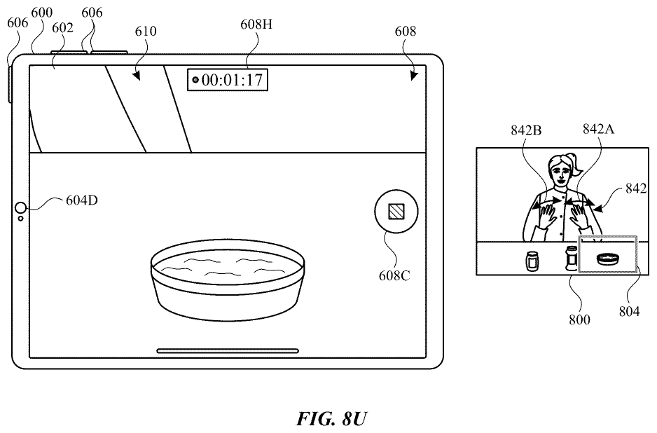

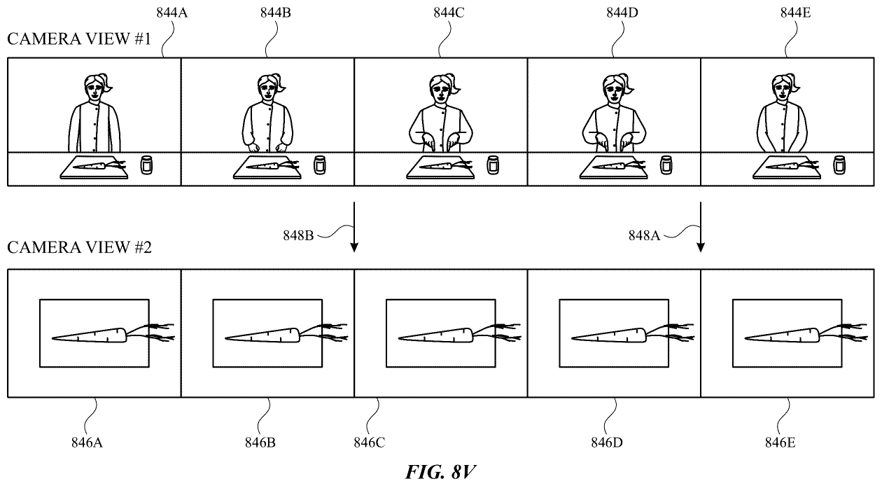

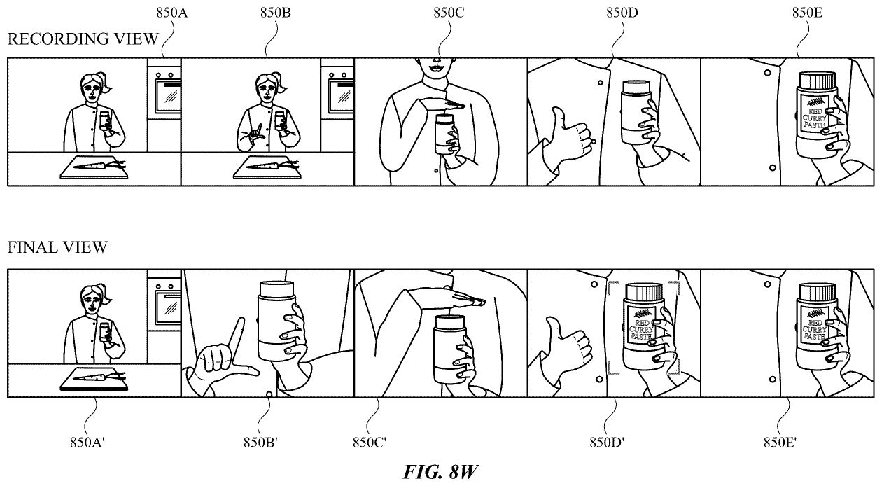

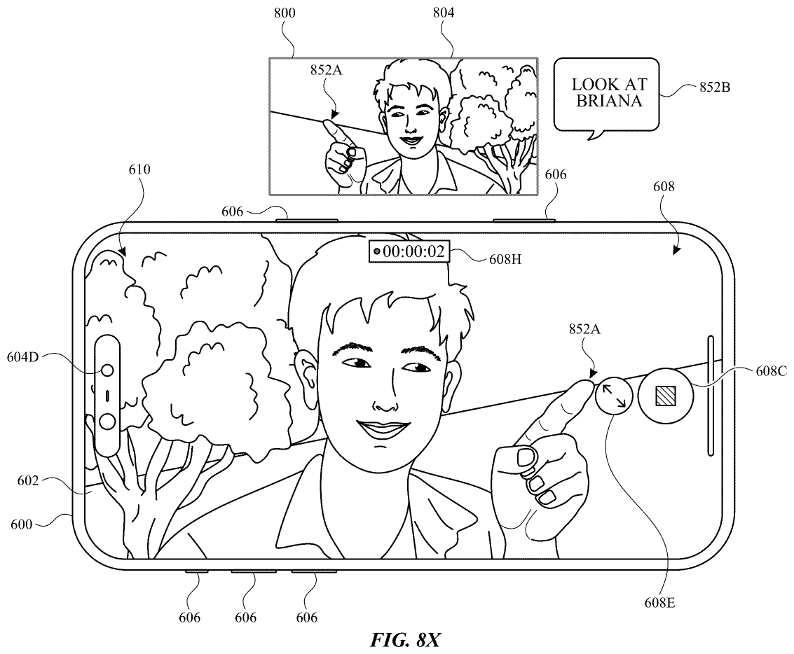

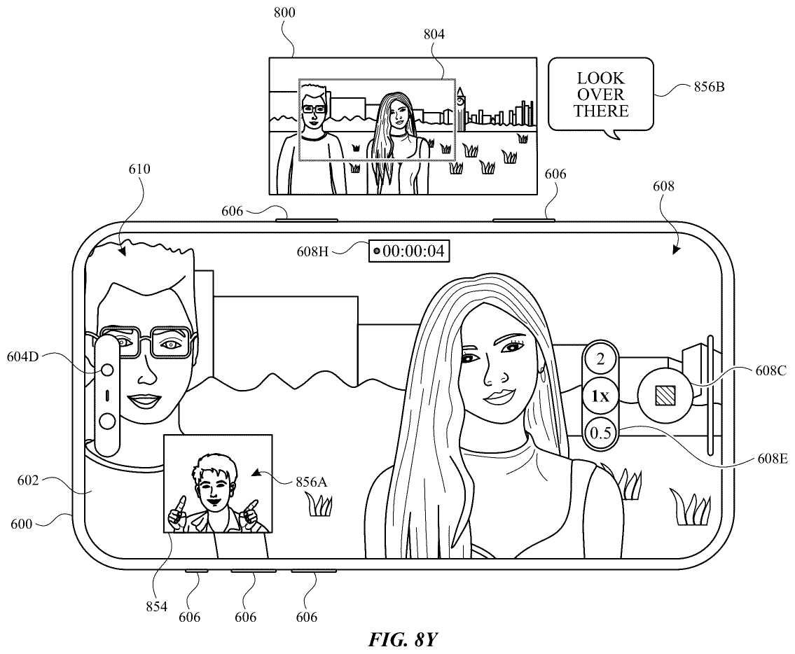

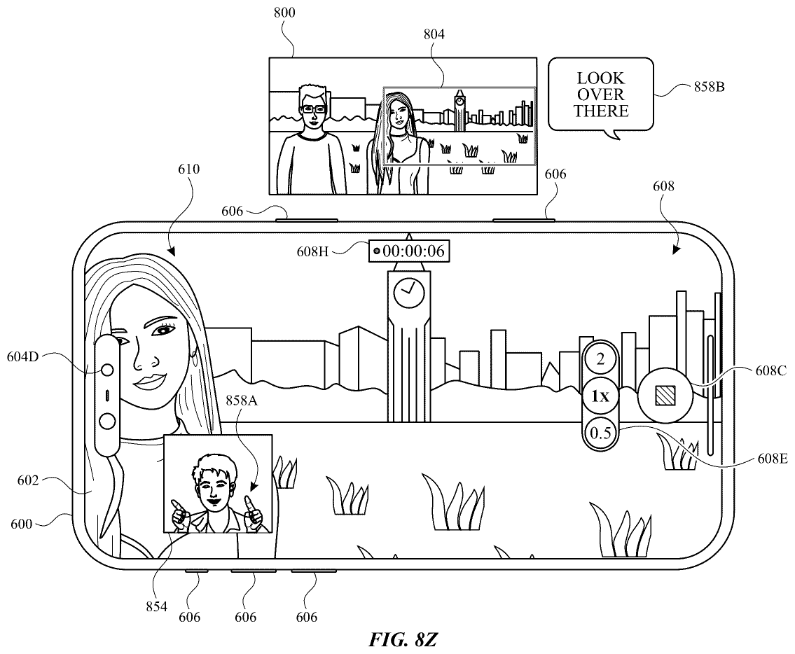

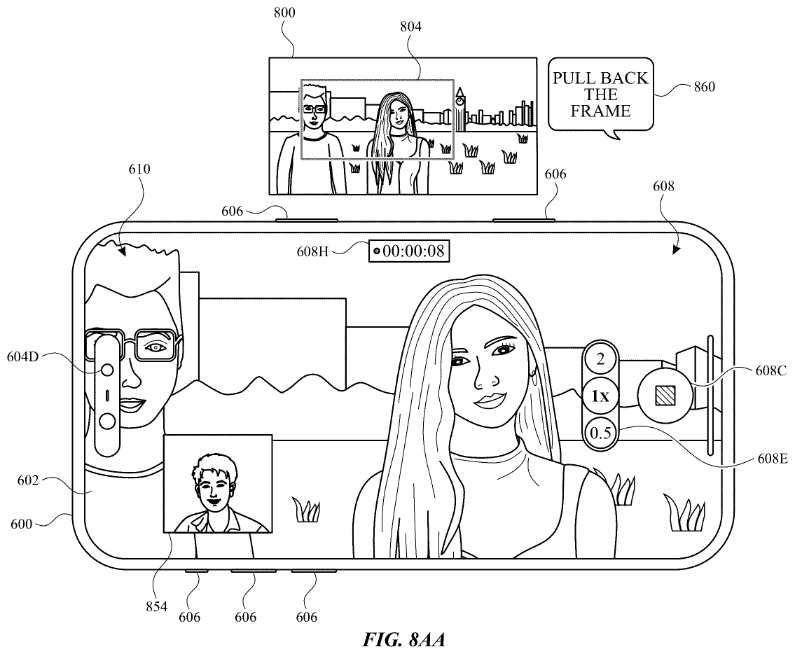

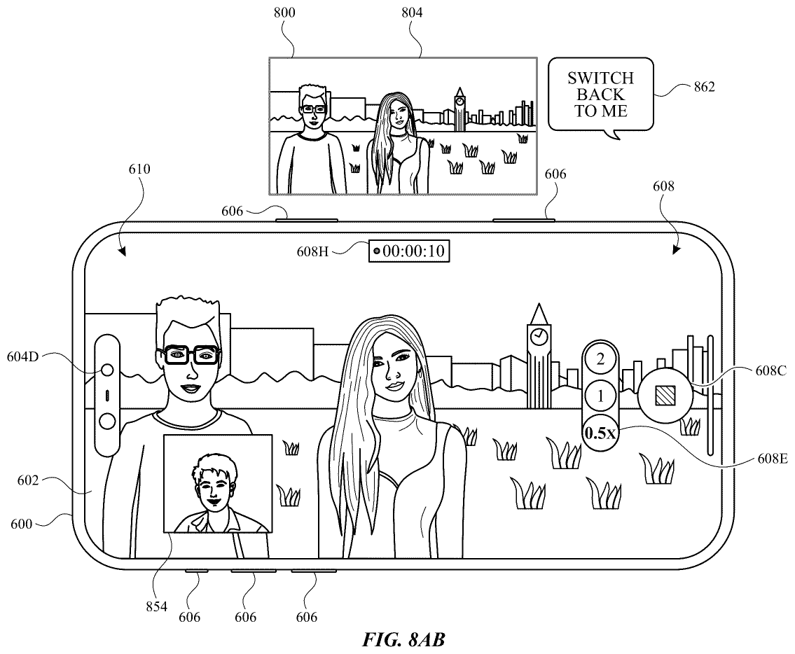

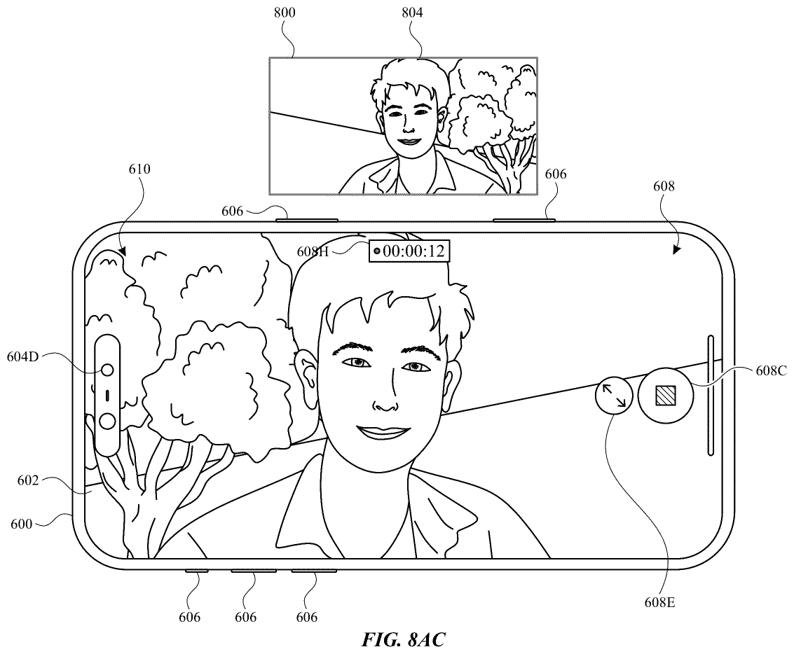

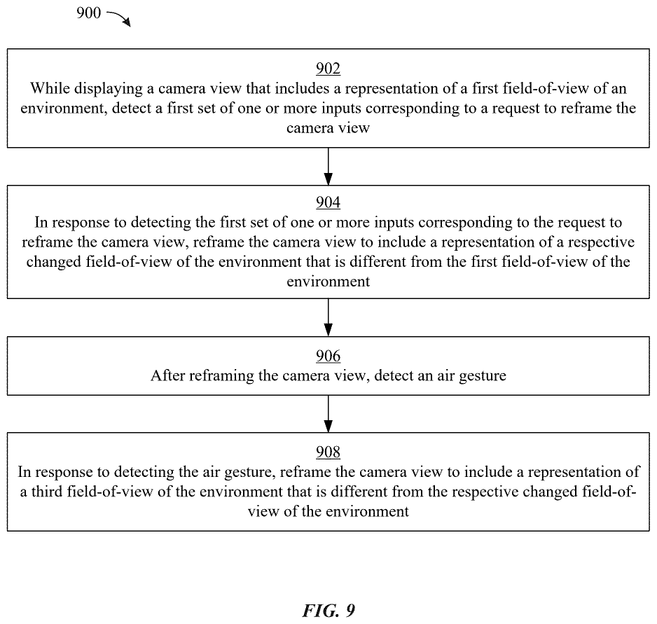

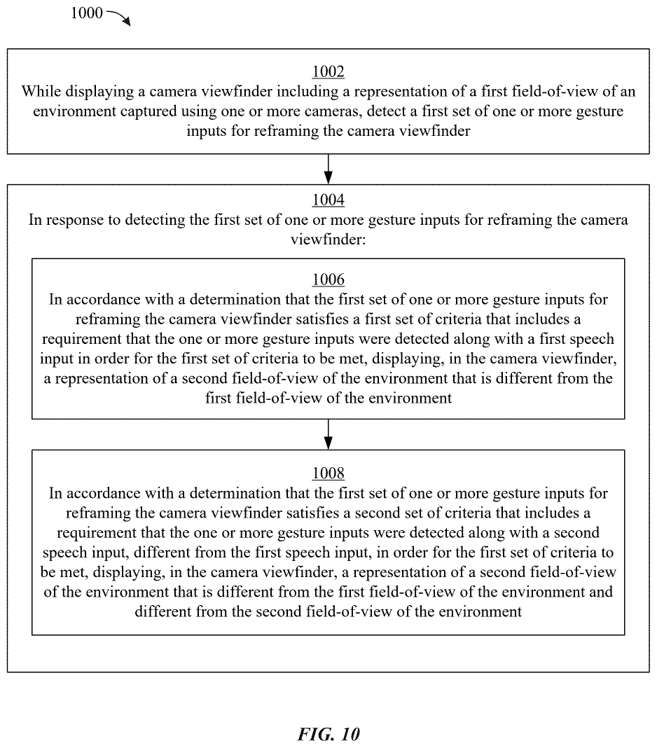

Below, FIGS. 1A-1B, 2, 3A-3G, 4A-4B, and 5A-5C provide a description of exemplary devices for performing the techniques for managing event notifications. FIGS. 6A-6L illustrate exemplary user interfaces for generating media with content-aware modifications. FIG. 7 is a flow diagram illustrating methods of generating media with content-aware modifications in accordance with some embodiments. The user interfaces in FIGS. 6A-6L are used to illustrate the processes described below, including the processes in FIG. 7. FIGS. 8A-8AC illustrate exemplary user interfaces for controlling camera framing when generating media. FIG. 9 is a flow diagram illustrating methods of changing and reverting changes to framing of a camera view in accordance with some embodiments. FIG. 10 is a flow diagram illustrating methods of changing framing of a camera view based on speech and gesture inputs in accordance with some embodiments. The user interfaces in FIGS. 8A-8AC are used to illustrate the processes described below, including the processes in FIG. 9 and FIG. 10.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, assisting the user with composing media capture events, and/or reducing the risk that transient media capture opportunities are missed or mis-captured. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used herein, the phrase “one or more of A and/or B” is construed to include all combinations of A and B, including, but not limited to: A individually without B; B individually without A; as well as a combination of A and B. The phrase “one or more of A, B, and/or C” is construed to include all combinations of A, B, and C, including, but not limited to: A individually without B and C; B individually without A and C; C individually without A and B; as well as any combinations of A, B, and/or C (e.g., A and B without C; A and C without B; B and C without A; and/or A, B, and C). Additionally, as used herein, the phrase “selected from the group consisting of A, B, C, and a combination thereof” and the phrase “at least one of A, B, and C” shall be construed to have the same meaning as the phrase “one or more of A, B, and/or C” as defined above. As used herein, the phrase “at least one of A, B, or C” and “one or more of A, B, or C” shall be construed to have the same meaning as the phrase “one or more of A, B, and/or C” as defined above. As used herein, the phrase “a combination including all of A, B, and C” is construed to include a combination of all the elements listed (e.g., a combination of A, B, and C).

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage media), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

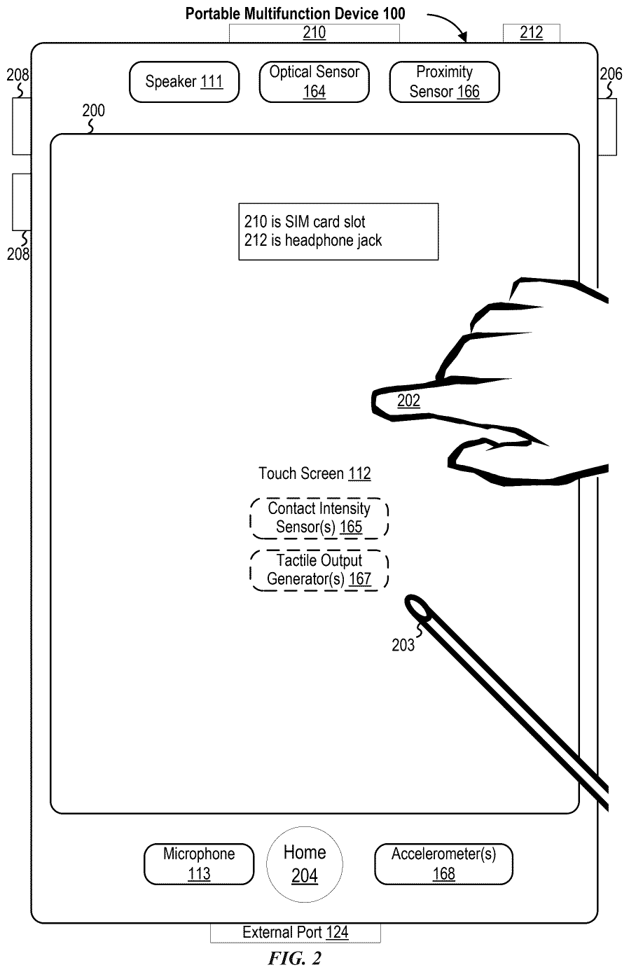

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. Patent Application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. Patent Application Nos. Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

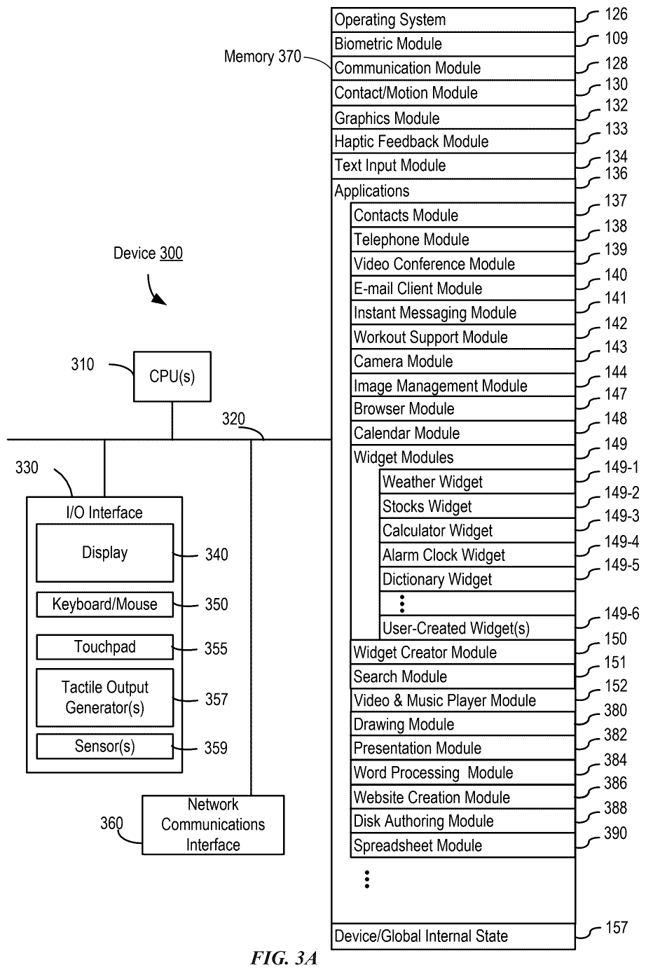

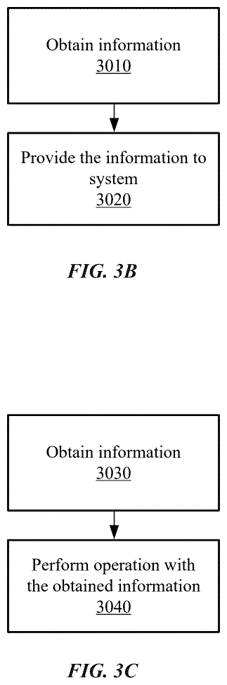

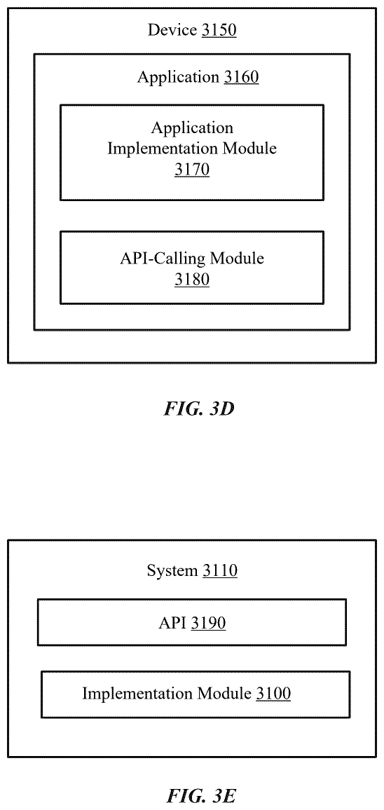

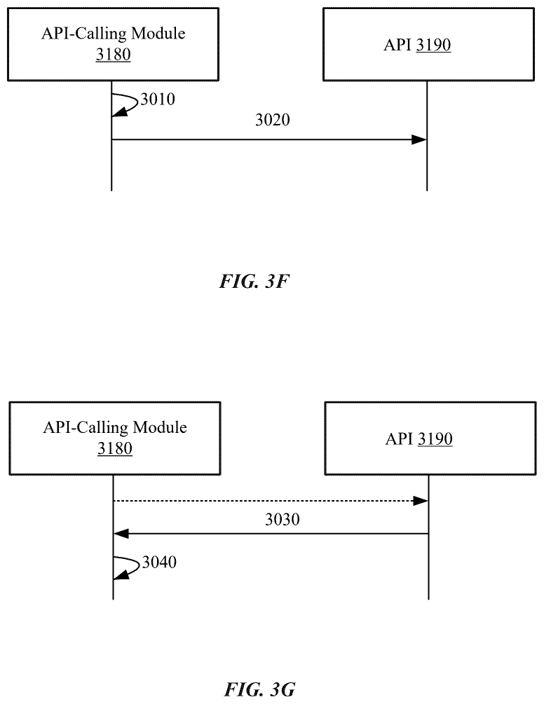

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE®, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch” multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search Module 151;
Video and music player module 152, which merges video player module and music player module;
Notes module 153;
Map module 154; And/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript® file. In some embodiments, a widget includes an XML (Extensible Markup Language) file and a JavaScript® file (e.g., Yahoo! ® Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700, 900, and/or 1000 (FIGS. 7, 9, and/or 10) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

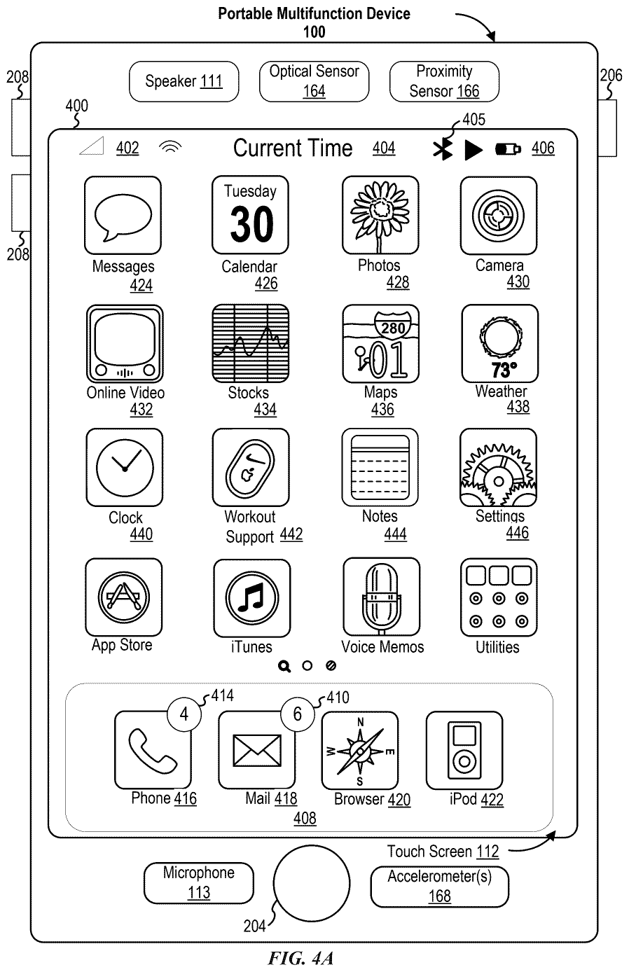

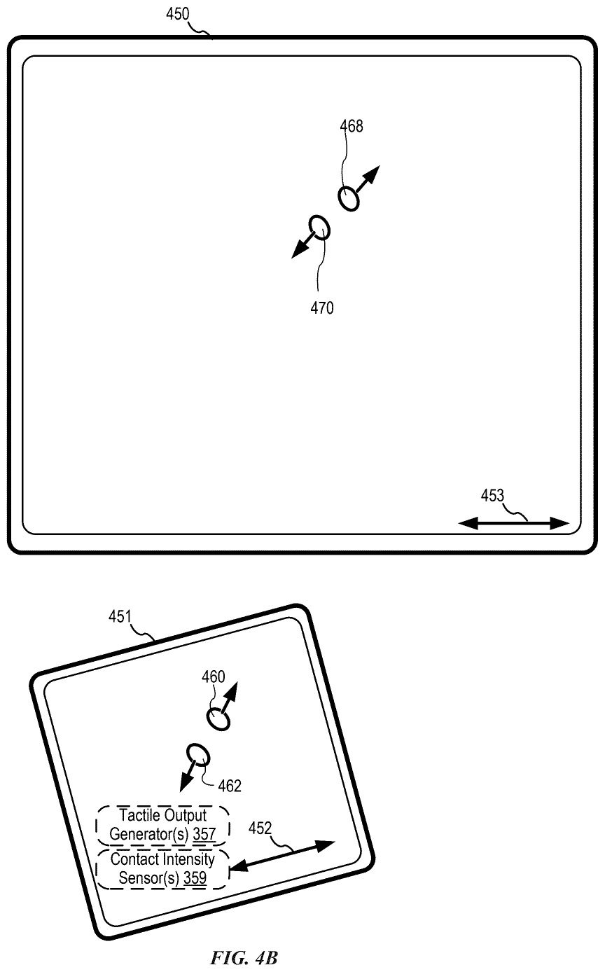

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch-sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contact 460 and contact 462, and movements thereof) detected by the device on the touch-sensitive surface (e.g., touch-sensitive surface 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

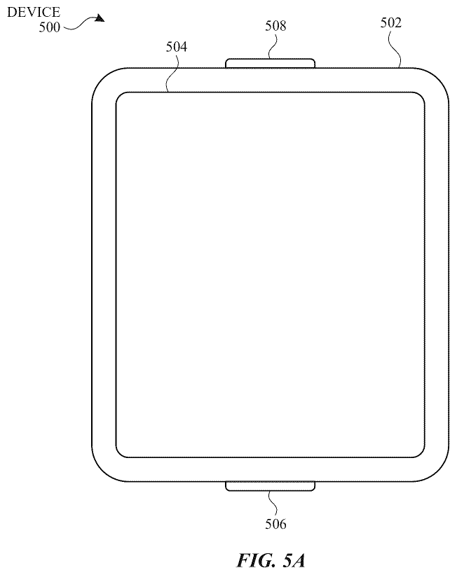

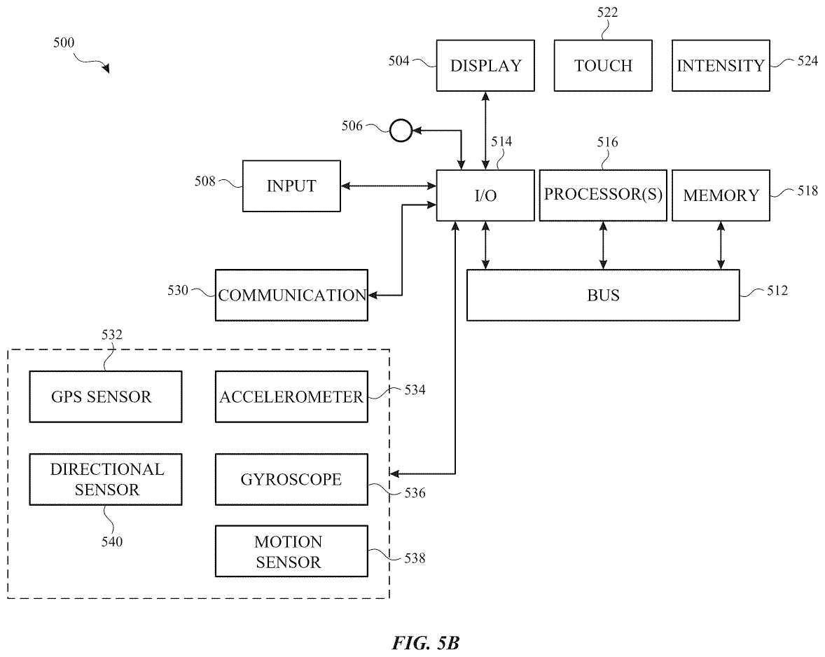

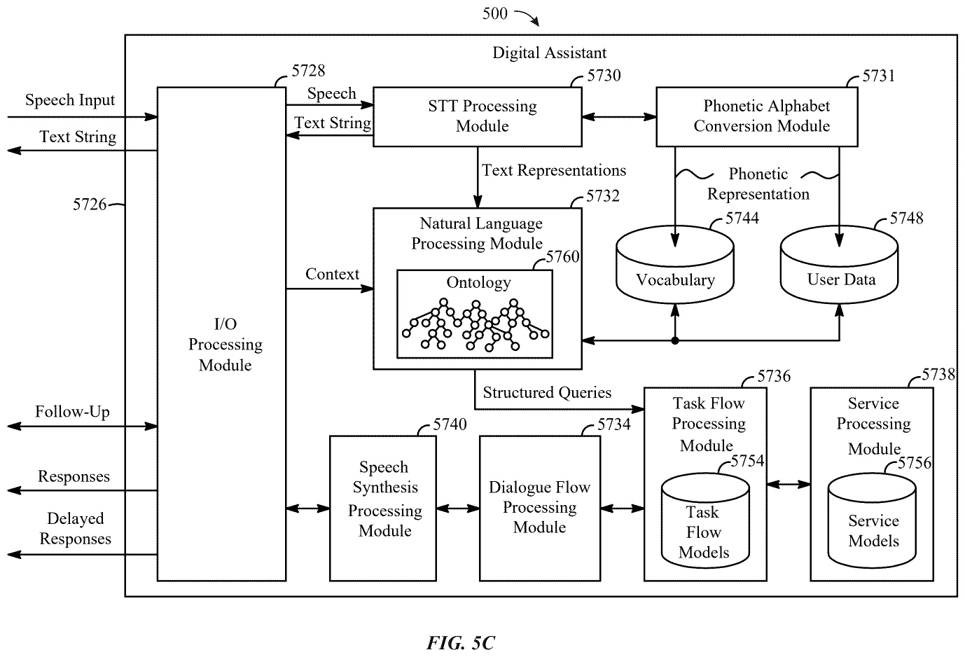

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage media, for storing computer-executable instructions, which, when executed by one or more computer processors 516, for example, can cause the computer processors to perform the techniques described below, including processes 700, 900, and/or 1000 (FIGS. 7, 9, and/or 10). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray® technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5C). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As described herein, in some embodiments, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseudo-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

FIG. 5C illustrates digital assistant module 5726 for performing at least some of the following: converting speech input into text; identifying a user's intent expressed in a natural language input received from the user; actively eliciting and obtaining information needed to fully infer the user's intent (e.g., by disambiguating words, games, intentions, etc.); determining the task flow for fulfilling the inferred intent; and executing the task flow to fulfill the inferred intent.

In some examples, as shown in FIG. 5C, I/O processing module 5728 interacts with the user through I/O devices or with a user device to obtain user input (e.g., a speech input) and to provide responses (e.g., as speech outputs) to the user input. I/O processing module 5728 optionally obtains contextual information associated with the user input from the user device, along with or shortly after the receipt of the user input. The contextual information includes user-specific data, vocabulary, and/or preferences relevant to the user input. In some examples, the contextual information also includes software and hardware states of the user device at the time the user request is received, and/or information related to the surrounding environment of the user at the time that the user request was received. STT (speech to text) processing module 5730 includes one or more ASR (automatic speech recognition) systems 5758. The one or more ASR systems 5758 can process the speech input that is received through I/O processing module 5728 to produce a recognition result. Each ASR system 5758 includes one or more speech recognition models (e.g., acoustic models and/or language models) and implements one or more speech recognition engines. Examples of speech recognition models include Hidden Markov Models, Gaussian-Mixture Models, Deep Neural Network Models, n-gram language models, and other statistical models. Examples of speech recognition engines include the dynamic time warping based engines and weighted finite-state transducers (WFST) based engines. The one or more speech recognition models and the one or more speech recognition engines are used to process the extracted representative features of the front-end speech pre-processor to produce intermediate recognitions results (e.g., phonemes, phonemic strings, and sub-words), and ultimately, text recognition results (e.g., words, word strings, or sequence of tokens).

Natural language processing module 5732 (“natural language processor”) of the digital assistant takes the candidate text representation(s) (“word sequence(s)” or “token sequence(s)”) generated by STT processing module 5730, and associates each of the candidate text representations with one or more “actionable intents” recognized by the digital assistant. An “actionable intent” (or “user intent”) represents a task that can be performed by the digital assistant via an associated task flow implemented in task flow models 5754. The associated task flow is a series of programmed actions and steps that the digital assistant takes in order to perform the task. For example, with respect to the examples illustrated in FIGS. 6A-10 and described below, the one or more actionable intents represent tasks such as initiating a media capture, performing a zoom operation, and/or panning a camera view.

In some examples, in addition to the sequence of words or tokens obtained from STT processing module 5730, natural language processing module 5732 also receives contextual information associated with the user request, e.g., from I/O processing module 5728. The natural language processing module 5732 optionally uses the contextual information to clarify, supplement, and/or further define the information contained in the candidate text representations received from STT processing module 5730. The contextual information includes, for example, user preferences, hardware, and/or software states of the user device, sensor information collected before, during, or shortly after the user request, prior interactions (e.g., dialogue) between the digital assistant and the user, and the like. As described herein, contextual information is, in some examples, dynamic, and changes with time, location, content of the dialogue, and other factors. For example, with respect to the examples illustrated in FIGS. 6A-10 and described below, the contextual information associated with the user request includes information about air gestures received along with the speech input and/or information about content detected in a camera view before, during, and/or after receiving the speech input.

In some examples, the natural language processing is based on, e.g., ontology 5760. Ontology 5760 is a hierarchical structure containing many nodes, each node representing either an “actionable intent” or a “property” relevant to one or more of the “actionable intents” or other “properties.” As noted above, an “actionable intent” represents a task that the digital assistant is capable of performing, i.e., it is “actionable” or can be acted on. A “property” represents a parameter associated with an actionable intent or a sub-aspect of another property. A linkage between an actionable intent node and a property node in ontology 5760 defines how a parameter represented by the property node pertains to the task represented by the actionable intent node.

Natural language processing module 5732 receives the candidate text representations (e.g., text string(s) or token sequence(s)) from STT processing module 5730, and for each candidate representation, determines what nodes are implicated by the words in the candidate text representation. In some examples, if a word or phrase in the candidate text representation is found to be associated with one or more nodes in ontology 5760 (via vocabulary index 5744), the word or phrase “triggers” or “activates” those nodes. Based on the quantity and/or relative importance of the activated nodes, natural language processing module 5732 selects one of the actionable intents as the task that the user intended the digital assistant to perform. In some examples, the domain that has the most “triggered” nodes is selected. In some examples, the domain having the highest confidence value (e.g., based on the relative importance of its various triggered nodes) is selected. In some examples, the domain is selected based on a combination of the number and the importance of the triggered nodes. In some examples, additional factors are considered in selecting the node as well, such as whether the digital assistant has previously correctly interpreted a similar request from a user.

User data 5748 includes user-specific information, such as user-specific vocabulary, user preferences, user address, user's default and secondary languages, user's contact list, and other short-term or long-term information for each user. In some examples, natural language processing module 5732 uses the user-specific information to supplement the information contained in the user input to further define the user intent. For example, for a user request “invite my friends to my birthday party,” natural language processing module 5732 is able to access user data 5748 to determine who the “friends” are and when and where the “birthday party” would be held, rather than requiring the user to provide such information explicitly in his/her request.

It should be recognized that in some examples, natural language processing module 5732 is implemented using one or more machine learning mechanisms (e.g., neural networks). In particular, the one or more machine learning mechanisms are configured to receive a candidate text representation and contextual information associated with the candidate text representation. For example, based on the candidate text representation and the associated contextual information, the one or more machine learning mechanisms are configured to determine intent confidence scores over a set of candidate actionable intents. Natural language processing module 732 can select one or more candidate actionable intents from the set of candidate actionable intents based on the determined intent confidence scores. In some examples, a foundation model, such as a large language model (LLM), processes input text to determine a summary and/or further follow-up text, which is further processed (e.g., by digital assistant module 5726) to provide an output or execute a task. For example, the LLM generates text that includes a function and a parameter for the function, and digital assistant module 5726 performs a function call to execute the function with the provided parameter. In some examples, an ontology (e.g., ontology 5760) is also used to select the one or more candidate actionable intents from the set of candidate actionable intents.

In some examples, natural language processing module 5732, dialogue flow processing module 5734 (e.g., with speech synthesis processing module 5740), and task flow processing module 5736 are used collectively and iteratively to infer and define the user's intent, obtain information to further clarify and refine the user intent, and finally generate a response (e.g., an output to the user and/or the completion of a task) to fulfill the user's intent. For example, service processing module 5738 acts on behalf of task flow processing module 5736 to make a phone call, set a calendar entry, invoke a map search, invoke or interact with other user applications installed on the user device, and invoke or interact with third-party services (e.g., a restaurant reservation portal, a social networking website, a banking portal, etc.). In some examples, the protocols and application programming interfaces (API) required by each service are specified by a respective service model among service models 5756. For example, with respect to the examples illustrated in FIGS. 6A-10 and described below, based on the determined intent, digital assistant module 5726 invokes or interacts with a camera application to perform camera operations in response to voice inputs.

Attention is now directed towards embodiments of user interfaces (“UI”) and associated processes that are implemented on an electronic device, such as portable multifunction device 100, device 300, or device 500.

FIGS. 6A-6L illustrate exemplary user interfaces for generating media with content-aware modifications, in accordance with some embodiments. The user interfaces in these figures are used to illustrate the processes described below, including the processes in FIG. 7.

FIGS. 6A-6B illustrate computer system 600 viewed from the back (e.g., FIG. 6A) and from the front (e.g., FIG. 6B), respectively. Computer system 600 includes display 602, cameras 604A-604D, and hardware buttons 606. In some embodiments, computer system 600 includes one or more input devices, such as a touch-sensitive surface (e.g., of display 602), additional hardware input devices (e.g., buttons, switches, keys, and/or dials), microphones, gesture input devices, air gesture input devices, and/or gaze input (e.g., eye tracking) devices. In some embodiments, computer system 600 includes one or more sensors, such as optical sensors, depth sensors, capacitive sensors, intensity sensors, motion sensors, vibration sensors, audio sensors, light sensors, temperature sensors, and/or biometric sensors. In some embodiments, the methods described herein using computer system 600 are implemented using (e.g., in conjunction with computer system 600) one or more user devices (e.g., mobile phones (e.g., e.g., as illustrated in FIGS. 6A-6L and 8X-8AC), tablet computers (e.g., as illustrated in FIGS. 8A-8W), laptop computers, and/or wearable electronic devices (e.g., smart watches)), remote devices (e.g., servers and/or network-connected devices), and/or peripheral devices (e.g., external storage drives, microphones, speakers, and/or hardware input devices). In some embodiments, computer system 600 includes one or more features of devices 100, 300, or 500 (e.g., the cameras can include optical sensor 164).

As illustrated in FIG. 6A, first camera 604A, second camera 604B, and third camera 604C are located on the backside of computer system 600. Accordingly, first camera 604A, second camera 604B, and third camera 604C are also referred to herein as “environment-facing” and/or “rear” cameras, as they point away from a user when the user is facing display 602 on the front of computer system 600. As illustrated in FIG. 6B, fourth camera 604D is located on the front of computer system 600. Accordingly, fourth camera 604D is also referred to herein as a “user-facing,” “front,” and/or “selfie” camera, as fourth camera 604D points towards a user when the user is facing display 602. In some embodiments, cameras 604A-604D have one or more different types of lenses (e.g., wide-angle, ultra wide-angle, telephoto, and/or macro lenses), different lens geometries (e.g., physical or equivalent focal lengths, such as 5 mm, 13 mm, 22 mm, 24 mm, 28 mm, 50 mm, 77 mm, 100 mm, and/or 300 mm, or f-stops of f/1.2, f/1.78, f/2.2, f/2.8, f/3.4, and/or f/8.4), different sensor resolutions (e.g., 8 MP, 12 MP, 24 MP, 48 MP, and/or 72 MP), different sensor pixel sizes (e.g., 100 nm, 0.5 μm, 1.0 μm, 2.44 μm, 5 μm), and/or other varying camera hardware features (e.g., dual or quad pixels, dual pixel autofocus capabilities, and/or optical image stabilization capabilities). In some embodiments, computer system 600 includes and/or is in communication with different numbers of cameras, different arrangements of cameras, and/or different types of cameras than illustrated in FIGS. 6A-6B. For example, computer system 600 is in communication with one or more external cameras (e.g., cameras housed separately from the device including display 602).

As illustrated in FIG. 6B, computer system 600 displays camera user interface 608 in a photo capture mode, including camera controls 608A-608I for navigating, using, assisting with, and/or changing settings of the camera user interface via the touch-sensitive surface of display 602. Capture mode affordance 608A is a menu (e.g., a sliding toolbar) for selecting between capture modes including a standard photo capture mode (e.g., a mode for capturing photo media that are not designated for display with synthetic depth-of-field effects), a portrait capture mode (e.g., a mode for capturing photo media that are designated for display with synthetic depth-of-field effects, lighting effects, and/or other post-processing effects), a panoramic photo capture mode (e.g., a mode for capturing photos from different positions and/or angles that are stitched together to create a single, larger form-factor image), a standard video capture mode (e.g., a mode for capturing video media that are not designated for display with synthetic depth-of-field effects), and/or a cinematic video capture mode (e.g., a mode for capturing video media that are designated for display with synthetic depth-of-field effects, lighting effects, and/or other post-processing effects). Camera selection affordance 608B is a software button for switching between capture using one or more front (e.g., environment-facing) cameras (e.g., first camera 604A, second camera 604B, and/or third camera 604C) and using a front (e.g., user-facing) camera (e.g., fourth camera 604D). Shutter affordance 608C is a software button that can be selected to initiate the capture of media. Captured media icon 608D is a selectable thumbnail icon that previews captured media and can be selected to view captured media (e.g., in a media viewing or media library user interface). Zoom affordance 608E is a control for changing the capture magnification and/or switching between cameras/lenses with different magnification. Camera flash affordance 608F is a software button for selecting a camera flash mode (e.g., on, off, or automatic). Exposure affordance 608G is a software button for controlling an exposure level and/or setting (e.g., enabling or disabling a low-light capture mode). Multi-frame photo affordance 608K is a software button for toggling between capturing single-frame/still photo capture and capturing photo media with a limited duration (e.g., 1, 3, and/or 5 seconds), for example, including content from before and/or after a capture input is detected that can be displayed in sequence (e.g., in response to a user input such as a selection input or a movement input) for a “live” effect. Format affordance 608I is a software button for controlling format settings for media capture, such as resolution, file size, file type, and/or compression settings.

Camera user interface 608 additionally includes camera preview 610, which includes a representation of a field-of-view of the environment captured by one or more of the cameras of computer system 600 that is framed (e.g., cropped) as it would currently be framed in media captured via camera user interface 608 (e.g., camera preview 610 is a live or near-live viewfinder). At FIG. 6B, camera user interface 608 is configured in a “selfie” photo mode, and accordingly, camera preview 610 includes a representation of a field-of-view of the environment captured using fourth camera 604D. As illustrated in FIG. 6B, fourth camera 604D captures a user of computer system 600 in a “selfie pose,” where, because the user is holding computer system 600 to point fourth camera 604D towards herself, the user's arms are captured extending towards fourth camera 604D and out of the frame of camera preview 610, cutting off the user's wrists and hands in the capture field-of-view (e.g., “selfie arms”).

At FIG. 6B, computer system 600 detects a request to capture media, such as touch input 612A directed to shutter affordance 608C, button press input 612B directed to one of the buttons 606, and/or another capture input (e.g., a capture air gesture, such as described with respect to FIG. 8A. In response to the request to capture media (e.g., 612A and/or 612B), at FIG. 6C, computer system 600 captures photo media item 614.

Because photo media item 614 is captured with the user's arms in the selfie pose as illustrated in FIG. 6B, computer system 600 initiates a process for repositioning the user's arms in photo media item 614 into a pose other than the selfie pose, such as positioned at the user's side or crossed in front of the user's chest. For example, computer system 600 detects the presence of the selfie arms by analyzing photo media item 614 and/or the camera data captured via fourth camera 604D (e.g., before, during, and/or after detecting the request to capture media) using image and/or video processing techniques, such as algorithmic image processing, machine vision, and/or machine learning techniques. In some embodiments, computer system 600 detects the presence of the selfie arms using other sensor data (e.g., based on depth sensor, motion sensor, and/or touch sensor data indicating the positioning of the user's arms) and/or contextual information (e.g., based on camera user interface 608 being configured in the selfie mode and/or using user-facing fourth camera 604D for capture).

The process for repositioning the user's arms in photo media item 614 includes generating one or more modified representations of the field-of-view of the environment captured by fourth camera 604D (e.g., modified representations 614A, 614B, and/or 614C, described in further detail below). In some embodiments, computer system 600 uses an ML process and/or a generative ML process to generate a representation of the user's arms in a different position, to generate a representation of a portion of the environment that was blocked by the selfie arms (e.g., generative infill), and/or to perform other modifications to photo media item 614 to incorporate the newly-generated representations. For example, computer system 600 provides photo media item 614 (e.g., the field-of-view of the environment as captured by fourth camera 604D), a description of the repositioned pose, and/or other information, such as other sensor data associated with the capture of photo media item 614 (e.g., light sensor data and/or depth sensor data) or other media items included in the user's media library (e.g., other photos and videos of the user), to one or more ML models as a prompt for generating the modified representation(s) of the field-of-view of the environment including the user's repositioned arms and additional background content to fill in the portions of the environment that were obscured (e.g., blocked) by the selfie arms.

As illustrated in FIG. 6C, in response to capturing photo media item 614, computer system 600 temporarily displays photo media item 614 in camera preview 610 and updates captured media icon 608D to include a thumbnail of photo media item 614, indicating that the media capture was performed and providing a preview of the capture to the user. In some embodiments, after temporarily displaying photo media item 614 in camera preview 610 for a period of time, computer system transitions back to displaying a live preview of the field-of-view of the currently selected camera (e.g., returns to showing camera preview 610 as shown in FIG. 6B). In some embodiments, the process for repositioning the user's arms in photo media item 614 includes performing an initial repositioning process, displaying photo media item 614 in camera preview 610 and captured media icon 608D with modified representation 614A, showing the user's arms at her sides as illustrated in FIG. 6C. In some embodiments, computer system 600 performs an initial repositioning process on the contents of camera preview 610 (e.g., the live or near-live viewfinder contents) when selfie arms are detected in the displayed representation of the environment, displaying camera preview 610 with near-live repositioning.

In response to detecting input 616 (e.g., a tap input directed to captured media icon 608D), computer system 600 displays photo media item 614 in media viewing user interface 618, as illustrated in FIG. 6D. Media viewing user interface 618 includes editing affordance 618A, a software button for launching editing user interface 622 for editing photo media item 614, sharing affordance 618B, a software button for launching a user interface to perform different actions using photo media item 614 (e.g., exporting photo media item 614 to another application, sending photo media item 614 to another person (e.g., via messaging, email, and/or filesharing), and/or using photo media item 614 as a device wallpaper), delete affordance 618C, a software button for removing photo media item 614 from the user's media library, and media library affordance 618D, a scrollable carousel of thumbnails of media items from the user's media library that can be selected to view the respective media items in media viewing user interface 618.

As illustrated in FIG. 6D, photo media item 614 is displayed in media viewing user interface 618 with modified representation 614B, which shows the users arms positioned at her sides. In some embodiments where computer system 600 performs an initial repositioning process (e.g., to generate modified representation 614A to display in camera preview 610 as illustrated in FIG. 6C), computer system 600 performs a different repositioning process to generate modified representation 614B, for instance, using a faster and/or lower-power process to generate modified representation 614A (e.g., an initial modification), then using a higher-quality process to generate modified representation 614B (e.g., a refined modification). For example, as illustrated in FIGS. 6C-6D, modified representation 614A shows the user's arms in long sleeves, while modified representation 614B shows the user's arms in short sleeves, better matching the actual shirt worn by the user. In some embodiments, the higher-quality process generates the refined modification (e.g., 614B) at a higher resolution, based on additional contextual information (e.g., light sensor data, depth sensor data, and/or other media items from the user's media library), and/or using more specific prompting than used for the initial modification (e.g., 614-1).

The process for repositioning the user's arms in photo media item 614 includes displaying photo media item 614 with repositioning control 620. Because photo media item 614 was captured with the user's arm in the selfie pose, at FIG. 6D, repositioning control 620 includes pose affordances 620A-620C corresponding to different arm poses: pose affordance 620A corresponds to the original (e.g., as-captured) arm pose (e.g., the selfie pose), pose affordance 620B corresponds to a pose with arms repositioned to the user's sides, and pose affordance 620C corresponds to a pose with arms repositioned to cross in front of the user. In some embodiments, in response to inputs directed to pose affordance 620A and/or pose affordance 620C (e.g., the unselected poses), computer system 600 changes the modifications to photo media item 614 as described with respect to FIGS. 6E-6G (e.g., in response to inputs directed to pose affordances 620A and 620C in media editing user interface 624). As illustrated in FIG. 6D, computer system 600 displays repositioning control 620 based on detecting the selfie pose in photo media item 614 as originally captured (e.g., in response to inputs 612A and/or 612B). Accordingly, computer system 600 continues to provide repositioning control 620 for photo media item 614 even when photo media item 614 is displayed without the selfie pose (e.g., after automatically repositioning the user's arms and/or repositioning the user's arms as described with respect to FIGS. 6E-6G).

As illustrated in FIG. 6D, pose affordance 620B is displayed with a selected appearance (e.g., an increased visual prominence relative to the other two pose affordances) indicating that photo media item 614 is being displayed with modified representation 614B, which repositions the user's arms to the user's sides. In some embodiments, rather than automatically displaying photo media item 614 with modified representation 614B in media viewing user interface 618, computer system 600 displays photo media item 614 without a modified representation of the user's arms (e.g., as described with respect to FIG. 6F), but still automatically displays photo media item 614 with repositioning control 620 (e.g., displaying pose affordance 620A with the selected appearance), indicating that one or more modified representations are available.

At FIG. 6D, computer system 600 detects a request to edit photo media item 614, such as input 622A directed to editing affordance 618A and/or input 622B directed to repositioning control 620. In response to detecting the request to edit photo media item 614, computer system 600 displays photo media item 614 in media editing user interface 624 along with repositioning control 620, as illustrated in FIG. 6E. Media editing user interface 624 includes finish affordance 624A, which can be selected to finalize edits made to photo media item 614 and return to media viewing user interface 618; cancel affordance 624B, which can be selected to revert edits made to photo media item 614 in media editing user interface 624 and return to media viewing user interface 618; and adjustment user interface 624C, which includes controls for adjusting various settings and characteristics of photo media item 614, such as multi-frame photo options, brightness, contrast, saturation, image enhancement application, filter application, cropping, and/or aspect ratio.

At FIG. 6E, computer system 600 detects input 626 (e.g., a touch input) directed to pose affordance 620A. As illustrated in FIG. 6F, in response to detecting input 626, computer system 600 displays photo media item 614 without a modified representation (e.g., 614A, 614B, and/or 614C) of the user's arms in a repositioned pose, such that the user appears in the selfie pose. Accordingly, in embodiments where computer system 600 automatically repositions the user's arms to a non-selfie arm pose, pose affordance 620A allows the user to revert modifications made in the repositioning process.

At FIG. 6F, computer system 600 detects input 628 (e.g., a touch input) directed to pose affordance 620C. As illustrated in FIG. 6G, in response to detecting input 628, computer system 600 displays photo media item 614 with modified representation 614C, which shows the user's arms crossed over her chest. In some embodiments, computer system 600 generates modified representation 614C (e.g., using the higher-quality repositioning process used to generate modified representation 614B) in response to detecting the selfie arms in photo media item 614 and/or based on a determination that the crossed-arm pose should be provided as an additional option for repositioning the selfie arms (e.g., as further described with respect to FIG. 6H). In some embodiments, rather than automatically repositioning the user's arms to be at her sides (e.g., displaying photo media item 614 with modified representation 614B) as described with respect to FIGS. 6C-6D, computer system 600 instead automatically repositions the user's arms to the crossed-arm pose.

At FIG. 6H, computer system 600 displays photo media item 630 (e.g., a photo captured via camera user interface 608 and/or included in a media library of computer system 600). Photo media item 630 is a photo capture of three people, where the middle subject's left arm appears in a selfie pose (e.g., extending towards the camera and out of the frame of photo media item 630).

Based on detecting the middle subject's arm in the selfie pose, computer system 600 initiates the process for repositioning the subject's arm, including displaying repositioning control 620 for photo media item 630. As illustrated in FIG. 6H, repositioning control 620 includes pose affordance 620A corresponding to the original arm pose (e.g., with the selected appearance, as photo media item 630 is currently displayed without a modified representation of the subject's arms) and pose affordance 620B corresponding to a repositioned pose with the subject's arms at his sides. In some embodiments, computer system 600 selects which pose options to include in repositioning control 620 based on analyzing the media item. For example, because photo media item 630 is a group shot (e.g., more than one subject is detected) and/or more tightly cropped with respect to the middle subject's body compared to the subject of photo media item 614, computer system 600 does not provide pose affordance 620C for the crossed-arm pose.

At FIG. 6H, computer system 600 detects input 632 (e.g., a touch input) directed to pose affordance 620B. In response to detecting input 632, at FIG. 6I, computer system 600 displays photo media item 630 with modified representation 630A, which repositions the left arm of the middle subject (e.g., the arm in the selfie pose) to be down at his side. As illustrated in FIG. 6I, in addition to the repositioned representation of the middle subject's left arm, modified representation 630A includes a representation of a portion of the right-side subject's torso, which was obscured (e.g., blocked) by the selfie arm in the original version of photo media item 630. Computer system 600 generates both the repositioned representation of the middle subject's left arm and the representation of the portion of the right-side subject's torso based on the original visual characteristics of photo media item 630. For example, the repositioned arm in modified representation 630A appears in a sleeve with the same color and stripes running down the arm as seen in the original version of photo media item 630 and/or on the middle subject's other (e.g., not repositioned) arm, and the right-side subject's torso infill extends the pattern visible on her shirt where it was not blocked by the selfie arm in the original version of photo media item 630. As discussed with respect to photo media item 614, in some embodiments, computer system 600 uses additional information (e.g., other than the original version of photo media item 630) to generate modified representation 630A, such as another photo in the media library that shows the right-side user's shirt pattern more clearly.

At FIG. 6J, computer system 600 displays camera user interface 608 including camera preview 610, which includes a representation of a field-of-view of the environment captured using a wide-angle camera (e.g., fourth camera 604D) at a low (e.g., relatively zoomed-out) zoom level. Camera preview 610 includes a group of people (e.g., subjects), one of whom is visibly holding an extended camera mount (e.g., a “selfie stick”). As illustrated in FIG. 6J, at the low zoom level, camera preview 610 includes a representation of a border region of the camera sensors in which the field-of-view of the environment is distorted (e.g., represented in FIG. 6J by crosshatching and dashed lines at the corners of camera preview 610). For example, at the border region of the camera sensors, the camera sensors capture portions of the camera hardware (e.g., the camera housing) that obscure the environment and/or the curvature of the camera lens warps, blurs, and/or otherwise distorts the border region of the capture of the environment.

At FIG. 6K, while displaying camera preview 610 with the representation of a field-of-view of the environment at the low zoom level, computer system 600 initiates a process for modifying the representation of the border region of the camera sensors to remove the distortion. As illustrated in FIG. 6K, computer system 600 displays camera preview 610 with modified representation 634A, which replaces the distorted (e.g., obscured, warped, and/or blurred) representation of the environment at the corners of camera preview 610 with a solid and/or gradated color infill (e.g., represented in FIG. 6K by the changed crosshatching at the corners of camera preview 610). For example, computer system 600 selects one or more colors of modified representation 634-1 by sampling the color from portions of camera preview 610 near the replaced portion, for instance, generating the top corners of modified representation 634A with a color infill extending the color of the sky detected near the top of camera preview 610 and displaying the bottom corners of modified representation 634A with a color infill based on the color of the subjects'clothes detected near the bottom of camera preview 610. In some embodiments, while displaying camera preview 610 with the representation of a field-of-view of the environment at the low zoom level, computer system 600 updates modified representation 634A based on changes to the field-of-view of the environment, for instance, updating the color(s) of modified representation 634A in response to detecting that the color(s) of camera preview 610 near modified representation 634A have changed.

At FIG. 6K, computer system 600 detects a request to capture media, such as input 636 directed to shutter affordance 608C. In response to the request to capture media, computer system 600 captures photo media item 634. As described with respect to FIGS. 6B-6I, because photo media item 634 is captured including the subject visibly holding the extended camera mount, computer system 600 initiates a process for repositioning the subject's hand and removing the representation of the camera mount.

At FIG. 6L, computer system 600 displays photo media item 634 in media viewing user interface with modified representations 634B and 634C. Modified representation 634B is generated as part of the process for modifying the representation of the border region of the camera sensors to remove the distortion, and replaces the distorted representation of the environment captured at the border region of the camera sensors with more detailed infill than in modified representation 634A. In some embodiments, computer system 600 uses an ML process and/or a generative ML process to generate content that realistically extends the representations of the portions of the environment captured by the non-border region of the camera sensors (e.g., the non-or less-distorted portions of the capture). For example, as illustrated in FIG. 6L, modified representation 634B includes generative representations of the sky and clouds that extend the upper corners of photo media item 634 and generative representations of the subjects'legs and/or the ground that extend the lower corners of photo media item 634.

Modified representation 634C is generated as part of the process for repositioning the subject's hand, and replaces the representation of the subject's hand with a generated representation of the subject's hand in a different pose (e.g., a thumbs up pose) and the representation of the extended camera mount with a generated representation of the portion of the environment obscured by the camera mount in the original version of photo media item 634 (e.g., a representation extending the left-hand subject's shirt and pants). As illustrated in FIG. 6L, although other arms are detected in photo media item 634, such as the arm of the left-most subject in a thumbs-up pose, the arm of the right-most subject propped on his leg, and the arm of the middle-left subject that is not holding the camera mount, computer system 600 selects to reposition only the arm of the middle-left subject that is holding the camera mount in modified representation 634C.

As illustrated in FIG. 6L, computer system 600 displays photo media item 634 with modification control 638. Similarly to repositioning control 620, modification control 638 includes cancel affordance 638A, which corresponds to the original (e.g., as-captured) representation of the environment, and modify affordance 638B, which corresponds to the representation of the environment including modified representations 634B and 634C. Accordingly, modification control 638 allows the user to revert (e.g., by selecting cancel affordance 638A) and/or (re)apply (e.g., by selecting modify affordance 638B) the automatic modifications repositioning the subject(s) and/or removing the distortions in photo media item 634.

Although the foregoing examples are described with respect to capturing media in a photo capture mode, the user interfaces and techniques are not limited to the generation of still (e.g., single-frame) photos. For example, for a limited-duration photo media item (e.g., a photo media item including multiple frames captured before, during, and/or after a capture input that, when viewed in succession, create a “live” photo effect) or a video media item, the processes for modifying the media item include generating modifications for one or more frames (e.g., any frames that include representations of a selfie arm, selfie stick, and/or sensor border region). For example, the generated modifications include generative video content.

FIG. 7 is a flow diagram illustrating a method for generating media with content-aware modifications using a computer system in accordance with some embodiments. Method 700 is performed at a computer system (e.g., 100, 300, 500, 600) (e.g., including one or more mobile phones, personal computers, laptops, tablets, headsets, wearable devices, and/or other electronic devices) that is in communication with one or more display generation components (e.g., 602) (e.g., a display controller; a touch-sensitive display system; a display (e.g., integrated and/or connected), a 3D display, a transparent display, a projector, and/or a heads-up display) and one or more input devices including one or more cameras (e.g., 604A, 604B, 604C, and/or 604D) (e.g., one or more rear (user-facing) cameras, forward (environment-facing) cameras, and/or externally-connected cameras, and/or a plurality of cameras with different lenses (e.g., different fixed focal lengths), such as a standard camera, a telephoto camera, a wide-angle camera, and/or a macro camera). In some embodiments, the one or more input devices include one or more touch-sensitive surfaces, hardware input devices (e.g., hardware buttons, switches, keys, and/or dials), microphones, gesture input devices, air gesture input devices, and/or gaze input devices. In some embodiments, the computer system is optionally in communication with one or more sensors, such as optical sensors, depth sensors, capacitive sensors, intensity sensors, motion sensors, vibration sensors, audio sensors, light sensors, temperature sensors, and/or biometric sensors. Some operations in method 700 are, optionally, combined, the orders of some operations are, optionally, changed, and some operations are, optionally, omitted.

As described below, method 700 provides an intuitive way of generating media with content-aware modifications. The method reduces the cognitive burden on a user when generating media with content-aware modifications, thereby creating a more efficient human-machine interface. For battery-operated computing devices, enabling a user to generate media with content-aware modifications faster and more efficiently conserves power and increases the time between battery charges.

The computer system detects (702), via the one or more input devices, a sequence of one or more inputs (e.g., 612A, 612B, and/or 636) (e.g., a selection input such as a tap, air tap, or button press directed to a virtual or hardware capture affordance) corresponding to a request to capture media corresponding to an environment (e.g., as illustrated in FIGS. 6B and/or 6K). In some embodiments, the sequence of one or more inputs are detected while displaying a camera preview (e.g., a live or near-live camera viewfinder) representing a field-of-view of the environment. In response to detecting (702) the sequence of one or more inputs corresponding to the request to capture media corresponding to the environment, the computer system captures (704), via the one or more cameras, a representation of a field-of-view of the environment (e.g., 614, 630, and/or 634) (e.g., a media item (e.g., photo and/or video media)).

After capturing (704) the representation of the field-of-view of the environment (e.g., in response to capturing or in response to the input that caused the representation of the field-of-view of the environment to be captured), in accordance with a determination (e.g., using image and/or video processing techniques, such as algorithmic image processing, machine vision, and/or other machine learning techniques) that the representation of the field-of-view of the environment includes a first representation of a first type of object (e.g., a particular type of physical object and/or visual artifact) in a first position (e.g., a first type of position and/or pose) in the representation of the field-of-view of the environment (e.g., a particular pose, orientation, and/or visual configuration with respect to other contents of the representation and/or the overall composition of the representation), the computer system initiates (706) (e.g., automatically initiating) a process for displaying the representation of the field-of-view of the environment with a second representation of the first type of object in a second position (e.g., 614A, 614B, 614C, 630A, and/or 634C) in the representation of the field-of-view of the environment that is different from the first position in the representation of the field-of-view of the environment (e.g., as illustrated in FIGS. 6C-6I and/or 6K-6L) (e.g., a computer-modified and/or computer-generated representation of the first type of object; in some embodiments, the second representation is not captured using the one or more cameras) (e.g., without displaying the first representation of the first type of object in the first position). In some embodiments, after initiating the process, the computer system displays, via the one or more display generation components, the representation of the field-of-view of the environment including the second representation. For example, the computer system displays the representation of the field-of-view of the environment including the second representation in live or near-live camera view that is displayed via the one or more display generation components as part of a media capture user interface (e.g., a camera viewfinder), and/or the computer system displays the representation of the field-of-view of the environment including the second representation in response to a request to view the captured media (e.g., the computer system reframes the captured media). In some embodiments, the process removes at least a portion of the first representation from the representation of the field-of-view of the environment. In some embodiments, the second representation of the first type of object in the second position wholly or partially replaces the first representation. In some embodiments, the process generates additional visual content (e.g., infill) that wholly or partially replaces the first representation. For example, the additional visual content includes a representation of content other than the first type of object that supplements the second representation of the first type of object. In some embodiments, the process includes editing and/or modifying an image or video and can including rendering new content and/or removing existing content from the image or video. Conditionally initiating a process for displaying a repositioned representation of a first type of object in a captured representation of a field-of-view of an environment if the captured representation includes a representation of the first type of object in a certain position (e.g., a position indicating that the represented object was being used to hold the camera) reduces the number of inputs and time needed to perform an operation (e.g., capturing and/or editing a media item), making the user-system interface more efficient, which, additionally, reduces power usage and improves battery life of the system by enabling the user to use the system more quickly and efficiently. Doing so also assists the user with composing media capture events and reduces the risk that transient media capture opportunities are missed or include unintended or undesirable content (e.g., a “selfie arm” and/or other capture artifact or distortion in the frame), which enhances the operability and ergonomics of the system and makes the user-system interface more efficient by helping the user to provide proper inputs and reducing user mistakes when operating/interacting with the system. For example, automatically initiating a repositioning process (e.g., repositioning and/or surfacing options to reposition) for certain types of content captured in certain positions (e.g., a selfie arm) allows users to quickly and easily create media items with desirable compositions, even when capturing the media items in non-ideal capture conditions. Doing so also provides improved visual feedback regarding the first type of object being determined to be in the field-of-view of the environment.

In some embodiments, the process for displaying the representation of the field-of-view of the environment with the second representation of the first type of object in the second position in the representation of the field-of-view of the environment includes detecting, via the one or more input devices, an input (e.g., 616) (in some embodiments, one or more inputs) requesting to view the representation of the field-of-view of the environment (e.g., the captured media item) (e.g., as illustrated in FIG. 6C). In some embodiments, in response to detecting the input requesting to view the representation of the field-of-view of the environment (in some embodiments, only in response to detecting the input requesting to view the representation and not in response to detecting any additional inputs), the computer system displays (e.g., within a media library user interface and/or application), via the one or more display generation components, the representation of the field-of-view of the environment (e.g., 614, 630, and/or 634) with the second representation of the first type of object in the second position (e.g., 614B, 614C, 630A, and/or 634C) in the representation of the field-of-view of the environment (e.g., as illustrated in FIGS. 6D and/or 6L). For example, the computer system automatically repositions the first type of object in the displayed representation of the field-of-view of the environment (e.g., the captured media item) in accordance with the determination that the representation of the field-of-view of the environment includes the first representation of the first type of object. Automatically displaying a repositioned representation of a first type of object in a captured representation of a field-of-view of an environment in response to a request to view the captured representation if the captured representation includes a representation of the first type of object in a certain position reduces the number of inputs and time needed to perform an operation, making the user-system interface more efficient, which, additionally, reduces power usage and improves battery life of the system by enabling the user to use the system more quickly and efficiently. Doing so also assists the user with composing media capture events and reduces the risk that transient media capture opportunities are missed or include unintended or undesirable content. For example, by automatically repositioning a representation of an arm (e.g., the first type of object) captured in a selfie position (e.g., extending out of the frame towards the camera) in a displayed media item, the computer system reduces the time and number of inputs needed to improve the composition of the media item and allows users to capture media confidently (e.g., without endeavoring to avoid or minimize the selfie arm).

In some embodiments, the process for displaying the representation of the field-of-view of the environment with the second representation of the first type of object in the second position in the representation of the field-of-view of the environment includes, while displaying the representation of the field-of-view of the environment (e.g., 614, 630, and/or 634) with a respective representation of the first type of object (e.g., the first representation of the first type of object in the first position, the second representation of the first type of object in the second position, or another representation of the first type of object in another position), displaying, via the one or more display generation components, a respective selectable user interface object (e.g., 620 and/or 638) (in some embodiments, one or more selectable user interface objects) (e.g., as illustrated in FIGS. 6D-6I and/or 6L). For example, the respective selectable user interface object includes one or more software buttons, menu items, sliders, toggles, and/or other interactive elements. For example, the respective selectable user interface object is a control for changing the position of the first type of object within the captured media item. In some embodiments, the respective selectable user interface object (e.g., the option to modify the representation of the first type of object) is displayed while displaying the representation of the field-of-view of the environment with the respective representation of the first type of object in a camera user interface (e.g., as a live or near-live capture preview), a media viewing user interface, and/or a media editing user interface (e.g., as a captured media item).

In some embodiments, while displaying the representation of the field-of-view of the environment and the respective selectable user interface object, the computer system detects, via the one or more input devices, a respective input (e.g., 622B, 626, 628, and/or 632) (e.g., a touch, air gesture, and/or button press input) directed to the respective selectable user interface object (e.g., as illustrated in FIGS. 6D-6F and/or 6H). In some embodiments, in response to detecting the respective input directed to the respective selectable user interface object (in some embodiments, only in response to detecting the respective input and not in response to detecting any additional inputs), the computer system displays, via the one or more display generation components, the representation of the field-of-view of the environment with a changed representation of the first type of object that is different from the respective representation of the first type of object (e.g., as illustrated in FIGS. 6E-6G and/or 6I). In some embodiments, the changed representation is the first representation of the first type of object in the first position in the representation of the field-of-view of the environment; in some embodiments, the respective representation is the second representation of the second type of object in the second position in the representation of the field-of-view of the environment; in some embodiments, the changed representation is a another representation of the first type of object in a another position in the representation of the field-of-view of the environment that is different from the first position and different from the second position. For example, the computer system initially displays the representation of the field-of-view of the environment with the first representation of the first type of object in the first (e.g., original) position and provides the selectable user interface object to switch to the second representation of the first type of object in the second (e.g., modified) position (e.g., providing the option to modify the appearance of the object in the captured media). For example, the computer system automatically displays the representation of the field-of-view of the environment with the second representation of the first type of object in the second (e.g., modified) position and provides the selectable user interface object to switch back to the first representation of the first type of object in the first (e.g., original) position. Automatically displaying a control for repositioning a representation of a first type of object in a captured representation if the captured representation includes a representation of the first type of object in a certain position reduces the number of inputs and time needed to perform an operation and provides improved visual feedback to a user without cluttering the user interface, making the user-system interface more efficient, which, additionally, reduces power usage and improves battery life of the system by enabling the user to use the system more quickly and efficiently. For example, automatically displaying the control for media captured with a visible selfie arm (e.g., or other unintended or undesirable capture artifact) informs the user of options for modifying the appearance of the arm and assists the user with efficiently achieving a desired composition for the media item.

In some embodiments, the second representation of the first type of object in the second position (e.g., 614A, 614B, 614C, 630A, and/or 634C) in the representation of the field-of-view of the environment includes generative content (e.g., generative images, generative graphics, and/or generative video created using an ML process). In some embodiments, the representation of the field-of-view of the environment including the first representation of the first type of object in the first position is used as part of the prompt for creating the generative content. Initiating a process for displaying a repositioned representation of a first type of object in a captured representation of a field-of-view of an environment if the captured representation includes a representation of the first type of object in a certain position (e.g., a position indicating that the represented object was being used to hold the camera) reduces the number of inputs and time needed to perform an operation (e.g., capturing and/or editing a media item), making the user-system interface more efficient, which, additionally, reduces power usage and improves battery life of the system by enabling the user to use the system more quickly and efficiently. Doing so also assists the user with composing media capture events and reduces the risk that transient media capture opportunities are missed or include unintended or undesirable content (e.g., a “selfie arm” and/or other capture artifact or distortion in the frame), which enhances the operability and ergonomics of the system and makes the user-system interface more efficient by helping the user to provide proper inputs and reducing user mistakes when operating/interacting with the system. For example, the computer system assists the user with efficiently achieving a desired composition for a media item even if the media item is captured in non-ideal conditions.

In some embodiments, the first type of object is a type of object used (e.g., commonly and/or actually used) to hold (e.g., to operatively connect to, e.g., grip, support, position, and/or touch) a device housing (e.g., that includes) at least one of the one or more cameras (e.g., as described with respect to FIGS. 6B, 6H, and/or 6J) (e.g., an arm, wrist, appendage, digit, camera mount, selfie stick, tripod, gimbal, and/or other object used to support and/or position the camera(s)). In some embodiments, the first position of the first type of object is a position within the representation of the field-of-view indicating that the object is being used to hold the device housing at least one of the one or more cameras. For example, in the first representation of the first type of object in the first position, the object extends outside of the field-of-view of the camera and towards the position of the device/camera within the environment. Conditionally initiating a process for displaying a repositioned representation of a first type of object in a captured representation of a field-of-view of an environment if the captured representation includes a representation of a type of object used to hold the camera reduces the number of inputs and time needed to perform an operation, assists the user with composing media capture events and reduces the risk that transient media capture opportunities are missed or include unintended or undesirable content.

In some embodiments, the type of object used to hold the device housing at least one of the one or more cameras is an arm of a user (e.g., as illustrated in FIGS. 6B, 6H, and/or 6J). For example, the first representation of the first type of object includes a representation of portions of the user's arm, wrist, and/or hand. In some embodiments, the first position of the first type of object is a “selfie arm” pose, for example, where the user's arm, wrist, and/or hand are seen extending outside of the frame of the representation towards the position of the device/camera. Conditionally initiating a process for displaying a repositioned representation of a first type of object in a captured representation of a field-of-view of an environment if the captured representation includes a representation of an arm used to hold the camera (e.g., a selfie arm) reduces the number of inputs and time needed to perform an operation, assists the user with composing media capture events and reduces the risk that transient media capture opportunities are missed or include unintended or undesirable content.

In some embodiments, in accordance with a determination that one or more respective criteria are satisfied (in some embodiments, and after capturing the representation of the field-of-view of the environment), the computer system displays, via the one or more display generation components, a suggestion user interface element (e.g., 620 and/or 638) corresponding to the process for displaying the representation of the field-of-view of the environment with the second representation of the first type of object in the second position in the representation of the field-of-view of the environment. In some embodiments, the suggestion user interface element includes an indication that the process is available to be performed, is being performed, and/or has been performed. In some embodiments, the suggestion user interface element includes a selectable user interface object for causing the process to be initiated and/or performed. In some embodiments, the one or more respective criteria include at least one of a first criterion that is satisfied when a first camera (e.g., 604D) of the one or more cameras (in some embodiments, a user-facing camera) is selected to use for capturing respective media corresponding to the environment and a second criterion that is satisfied when the representation of the field-of-view of the environment includes a first representation of the first type of object in the first position in the representation of the field-of-view of the environment. In some embodiments, the first criterion is satisfied when the first camera was used to capture the representation of the field-of-view of the environment (e.g., the suggestion user interface element is displayed for media captured using a “selfie” camera). In some embodiments, the first criterion is satisfied when the first camera is selected to use for capturing media corresponding to the environment (e.g., the suggestion user interface element is displayed within a camera user interface currently configured to capture media using a “selfie” camera). For example, the suggestion user interface element is displayed as part of the process for displaying the representation of the field-of-view of the environment with the second representation of the first type of object in the second position and/or while capturing media using a “selfie” camera. In some embodiments, the computer system displays the suggestion user interface element in accordance with a determination that both the first criterion and the second criterion are satisfied (e.g., both the first criterion and the second criterion are required criteria). Conditionally displaying a user interface element corresponding to a process for displaying a repositioned representation of a first type of object in a representation of a field-of-view of an environment based on the camera(s) being used and/or the position of the first type of object in the representation reduces the number of inputs and time needed to perform an operation and provides improved visual feedback to a user without cluttering the user interface. For example, the user interface element indicates to the user that the process is available and/or provides controls for performing the process when the capture conditions (e.g., the current media capture conditions and/or the conditions present when the representation was captured) indicate that the process is likely to be relevant.

In some embodiments, initiating the process for displaying the representation of the field-of-view of the environment with the second representation of the first type of object in the second position in the representation of the field-of-view of the environment includes, while displaying the representation of the field-of-view of the environment, displaying, via the one or more display generation components, a set of user interface objects (e.g., 620A, 620B, and/or 620C) (e.g., affordances) including at least a first user interface object (e.g., 620B) corresponding to the second position (e.g., an option affordance for selecting the second position) and a second user interface object (e.g., 620C) corresponding to a third position in the representation of the field-of-view of the environment that is different from the first position and the second position (e.g., as illustrated in FIGS. 6D-6G) (e.g., an option affordance for selecting the third position). For example, the first user interface object corresponds to one pose (e.g., repositioning a user's arm at the user's side) and the second user interface object corresponds to a different pose (e.g., repositioning the user's arm to cross in front of the user). In some embodiments, the set of user interface objects includes a user interface object corresponding to the first position (e.g., an option affordance for selecting the originally-captured position). In some embodiments, the set of user interface objects includes additional user interface objects corresponding to additional positioning (e.g., pose) options for the first type of object. Displaying multiple options (e.g., position and/or pose options) for repositioning a representation of a first type of object in a captured representation of a field-of-view of an environment if the captured representation includes a representation of the first type of object in a certain position reduces the number of inputs and time needed to perform an operation, assists the user with composing media capture events, and reduces the risk that transient media capture opportunities are missed or include unintended or undesirable content. For example, the provided options allow users to quickly and easily view the first type of object in multiple different positions within the captured media item, assisting the user with achieving a desired composition.

In some embodiments, while displaying the set of user interface objects (e.g., and displaying the representation of the field-of-view of the environment), the computer system detects, via the one or more input devices, an input (e.g., 622B, 626, and/or 628) (e.g., a selection input such as a touch, gesture, air gesture, and/or button press) directed to the set of user interface objects. In some embodiments, in response to detecting the input directed to the set of user interface objects (in some embodiments, in response to detecting the input directed to the set of user interface objects and not in response to detecting any additional inputs) and in accordance with a determination that the input is directed to the first user interface object corresponding to the second position, displaying, via the one or more display generation components, the representation of the field-of-view of the environment with the second representation of the first type of object in the second position (e.g., 614B) in the representation of the field-of-view of the environment (e.g., as illustrated in FIG. 6E) (e.g., repositioning the first type of object to appear in one pose that is different from the first representation of the first type of object). In some embodiments, in response to detecting the input directed to the set of user interface objects and in accordance with a determination that the input is directed to the second user interface object corresponding to the third position, displaying, via the one or more display generation components, the representation of the field-of-view of the environment with a third representation of the first type of object in the third position (e.g., 614C) in the representation of the field-of-view of the environment (e.g., as illustrated in FIG. 6G) (e.g., repositioning the first type of object to appear in another pose that is different from the first representation of the first type of object). For example, for a selfie arm detected within the representation of the field-of-view of the environment, selecting the first user interface object causes the representation to be displayed with the arm at the user's side, and selecting the second user interface object causes the representation to be displayed with the arm crossed in front of the user (e.g., with the user's arms crossed). In some embodiments, in accordance with a determination that the input is directed to the user interface object corresponding to the first position, the computer system displays the representation of the field-of-view of the environment with the first representation of the first type of object in the first position (e.g., the media item is displayed with the object represented as originally captured).

In some embodiments, a visual characteristic (in some embodiments, at least one visual characteristic) of the second representation of the first type of object in the second position (e.g., 614A, 614B, 614C, 630A, and/or 634C) is based on a corresponding visual characteristic of the first representation of the first type of object in the first position (e.g., the representation of the object as originally captured). For example, the second representation of the object is generated to resemble the object as it appears in the first representation, but in a different position (e.g., pose). In some embodiments, the visual characteristic is a color, shape, size, texture, and/or pattern of the detected object and/or the portion of the environment represented within the first representation. For example, for a selfie arm, the second representation of the arm (e.g., the repositioned arm) appears to have the same skin tone, clothing (e.g., sleeve) type, and/or lighting as the first representation of the arm. Initiating a process for displaying a repositioned representation of a first type of object in a captured representation of a field-of-view of an environment where the appearance of the repositioned representation of the object is based on the appearance of the captured representation of the object reduces the number of inputs and time needed to perform an operation (e.g., capturing and/or editing a media item), assists the user with composing media capture events, and reduces the risk that transient media capture opportunities are missed or include unintended or undesirable content. For example, the computer system assists the user with achieving a realistic appearance when changing the composition of a media item.

In some embodiments, after capturing the representation of the field-of-view of the environment, in accordance with a determination that the representation of the field-of-view of the environment includes both the first representation of the first type of object in the first position and a respective representation of the first type of object in a respective position (e.g., more than one instance of the first type of object is represented in the field-of-view of the environment), the computer system foregoes initiating (e.g., automatically initiating) a process for displaying the representation of the field-of-view of the environment with a modified representation of the first type of object that is in the respective position (e.g., as described with respect to FIG. 6L) (e.g., one instance of the first type of object is repositioned in the representation of the field-of-view of the environment, while one or more other instances of the first type of object are not repositioned). For example, if multiple arms (e.g., the arms of one or more people represented in the media capture) are detected in the representation of the field-of-view of the environment, the computer system initiates the process for displaying the representation of the field-of-view of the environment with one arm (e.g., an arm in a selfie pose) repositioned and the other arm(s) displayed as originally positioned in the capture. In some embodiments, if multiple instances of the first type of object are detected in the representation of the field-of-view of the environment, the computer system initiates (e.g., or automatically initiates) the process to reposition one instance in the representation of the field-of-view of the environment without initiating a process to reposition other instances in the representation of the field-of view. Conditionally initiating a process for displaying a repositioned representation of one captured instance of a first type of object in a representation of a field-of-view of an environment if the captured representation includes a representation of the first type of object in a certain position while foregoing initiating the process for displaying a repositioned representation of another captured instance of the first type of object reduces the number of inputs and time needed to perform an operation (e.g., capturing and/or editing a media item), assists the user with composing media capture events, and reduces the risk that transient media capture opportunities are missed or include unintended or undesirable content. For example, limiting the repositioning to one instance of the first type of object (e.g., the first representation of the first type of object in the first position) reduces the complexity and time spent editing captured media items.

In some embodiments, the first position is a position in the representation of the field-of-view of the environment that indicates that the first type of object in the first position is holding (e.g., is operatively connected to, e.g., gripping, supporting, positioning, and/or touching) a device housing at least one of the one or more cameras, and the respective position is a position in the representation of the field-of-view of the environment that indicates that the first type of object in the respective position is not holding the device housing at least one of the one or more cameras (e.g., the computer system initiates the process for repositioning the representation of the first type of object that appears to be holding the device/camera and foregoes initiating a process for repositioning the representation of the first type of object that does not appear to be holding the device). For example, in the first representation of the first type of object in the first position, the object extends outside of the field-of-view of the camera and towards the position of the device/camera within the environment, indicating that the detected object is holding the device (e.g., a selfie arm position). For example, in the respective representation of the first type of object in the respective position, the object is fully within the frame and/or extends outside of the frame in a manner or direction that does not indicate that it is being used to hold the device. Initiating a process for displaying a repositioned representation of one captured instance of a first type of object in a representation of a field-of-view of an environment that appears to be holding the camera used for capture and foregoing initiating the process for displaying a repositioned representation of another captured instance of the first type of object that does not appear to be holding the camera reduces the number of inputs and time needed to perform an operation (e.g., capturing and/or editing a media item), assists the user with composing media capture events, and reduces the risk that transient media capture opportunities are missed or include unintended or undesirable content. For example, limiting the repositioning to one instance of the first type of object (e.g., the first representation of the first type of object in the first position) reduces the complexity and time spent editing captured media items by targeting the representation of the first type of object that is likely to be unintentional or undesirable in the media item.

In some embodiments, while displaying a respective representation of a respective field-of-view of the environment (e.g., 610, 614, 630, and/or 634) (e.g., a camera preview and/or a captured media item; in some embodiments, the respective representation of the field-of-view of the environment is the representation of the field-of-view of the environment captured in response to detecting the sequence of one or more inputs) at a respective zoom level, the computer system detects, via the one or more input devices, a request to reduce a zoom level of the respective representation of the field-of-view of the environment, wherein displaying the respective representation of the respective field-of-view of the environment at the respective zoom level includes displaying a representation of a first portion of a respective object captured using the one or more cameras. In some embodiments, in response to detecting the request to reduce the zoom level of the respective representation of the respective field-of-view of the environment, the computer system initiates a process for displaying, via the one or more display generation components, the respective representation of the field-of-view of the environment with a representation of a second portion of the respective object (e.g., 634A and/or 634B) that is different from the first portion of the respective object, wherein the representation of the second portion of the respective object is not captured using the one or more cameras. For example, if the respective object is partially cut off and/or distorted within the camera preview and/or the captured media, the computer system generates a representation of the cut off and/or distorted portion of the respective object to extend the respective object to the edges of the frame upon zooming out. In some embodiments, the process includes displaying the respective representation of the field-of-view of the environment with both the representation of the first portion of the respective object and the representation of the second portion of the respective object. In some embodiments, the process includes modifying and/or replacing at least a portion of the representation of the first portion of the respective object in addition to displaying the generated representation of the second portion (e.g., to create a smooth visual transition between the captured portion and the generated portion). In some embodiments, after initiating the process, the computer system displays, via the one or more display generation components, the representation of the field-of-view of the environment with the representation of the second portion of the respective object (e.g., the extended respective object). For example, the computer system displays the representation of the field-of-view of the environment with the representation of the second portion of the respective object in live or near-live camera view that is displayed via the one or more display generation components as part of a media capture user interface (e.g., a camera viewfinder), and/or the computer system displays the representation of the field-of-view of the environment with the representation of the second portion of the respective object in response to a request to view the captured media (e.g., the computer system extends the respective object in a finalized version of the capture).

In some embodiments, after capturing the representation of the field-of-view of the environment (e.g., in response to capturing or in response to the input that caused the representation of the field-of-view of the environment to be captured), in accordance with a determination that a respective representation of a respective field-of-view the environment (e.g., a camera preview and/or a captured media item; in some embodiments, the respective representation of the field-of-view of the environment is the representation of the field-of-view of the environment captured in response to detecting the sequence of one or more inputs) includes first content representing a first portion of the respective field-of-view of the environment that is distorted (e.g., appears warped, blurred, and/or obscured, e.g., relative to the appearance of the environment to the user's eye) by a physical feature of the one or more cameras (e.g., as illustrated in FIG. 6J) (e.g., the lens geometry, sensor array, camera housing, and/or the interrelation between the three), the computer system initiates a process for displaying, via the one or more display generation components, the respective representation of the respective field-of-view of the environment with second content representing the first portion of the respective field-of-view of the environment (e.g., 634A and/or 634B) (e.g., replacing the first content in the respective representation). In some embodiments, the second content includes a modified version of the first content that digitally removes and/or corrects the distortion (e.g., aberration) introduced by the camera hardware. In some embodiments, the second content includes generative image and/or video content (e.g., generative infill), which is generated based on the respective representation of the respective field-of-view of the environment (e.g., within and/or outside the first portion). In some embodiments, after initiating the process, the computer system displays, via the one or more display generation components, the representation of the field-of-view of the environment with the second content representing the first portion of the respective field-of-view of the environment (e.g., the extended field-of-view). For example, the computer system displays the representation of the field-of-view of the environment with the second content representing the first portion of the respective field-of-view of the environment in live or near-live camera view that is displayed via the one or more display generation components as part of a media capture user interface (e.g., a camera viewfinder), and/or the computer system displays the representation of the field-of-view of the environment with the second content representing the first portion of the respective field-of-view of the environment in response to a request to view the captured media (e.g., the computer system extends the field-of-view in a finalized version of the capture). Conditionally initiating a process for replacing a portion of a representation of a field-of-view of an environment captured using one or more cameras if the portion includes a distortion (e.g., aberration) introduced to the representation of a field-of-view of an environment caused by the camera hardware reduces the number of inputs and time needed to perform an operation, assists the user with composing media capture events and reduces the risk that transient media capture opportunities are missed or include unintended or undesirable content. For example, the computer system assists the user with efficiently achieving a desired composition for a media item even if the camera hardware introduces non-ideal conditions for the desired composition.

In some embodiments, the first content representing the first portion of the respective field-of-view of the environment includes content captured using a boundary (e.g., corner and/or edge) region of a sensor array of the one or more cameras (e.g., as illustrated in FIG. 6J). Conditionally initiating a process for replacing a portion of a representation of a field-of-view of an environment captured using one or more cameras if the portion includes content captured at the corners and/or edges of the camera hardware (e.g., sensor array) reduces the number of inputs and time needed to perform an operation, assists the user with composing media capture events and reduces the risk that transient media capture opportunities are missed or include unintended or undesirable content. For example, the computer system assists the user with efficiently achieving a desired composition for a media item even if the desired composition includes a portion of the captured representation that is warped or blurred by the edges of the lens and/or obscured by the camera housing.

In some embodiments, initiating the process for displaying the respective representation of the field-of-view of the environment with second content representing the first portion of the respective field-of-view of the environment includes, in accordance with a determination that the respective representation of the field-of-view of the environment is displayed in a user interface for capturing media (e.g., 608) (e.g., the respective representation is displayed in a live or near-live viewfinder of a camera application; e.g., prior to capturing the respective representation of the field-of-view of the environment as a media item), replacing the first content representing the first portion of the respective field-of-view of the environment with one or more color fields (e.g., 634A) selected based on one or more colors detected in the respective representation of the field-of-view of the environment (e.g., as illustrated in FIG. 6K) (e.g., in the live capture preview, the computer system fills in the first portion of the respective field-of-view of the environment with solid and/or varied colors sampled from the respective representation). In some embodiments, the one or more color fields are selected based on colors detected near and/or within the first portion of the respective field-of-view of the environment. In some embodiments, initiating the process for displaying the respective representation of the field-of-view of the environment with second content representing the first portion of the respective field-of-view of the environment includes, in accordance with a determination that the respective representation of the field-of-view of the environment is displayed in a user interface other than the user interface for capturing media (e.g., 618 and/or 624) (e.g., a media library, media viewing user interface, media editing user interface, messaging user interface, and/or social media user interface; e.g., after capturing the respective representation of the field-of-view of the environment as a media item), replacing the first content representing the first portion of the respective field-of-view of the environment with generative content (e.g., 634B) (e.g., infill) representing the first portion of the respective field-of-view of the environment (e.g., as illustrated in FIG. 6L) (e.g., in the captured media, the computer system generates content correcting the distortion, extending the non-distorted portions into the distorted region, and/or adding new content to fill in the distorted region). Replacing a portion of a representation of a field-of-view of an environment with sampled color infill while capturing media (e.g., while the representation is displayed in a live or near-live viewfinder for a camera user interface) and replacing the portion of the representation of the field-of-view of the environment with generative infill after the representation of the field-of-view of the environment is captured (e.g., when viewing a finalized version of the representation) provides improved visual feedback to the user and reduces the time and number of inputs needed to perform an operation. For example, the sampled color infill indicates that the replacement process is available and quickly provides the user with a preview of the replaced portion, while the generative infill provides a higher-quality replacement for the finalized media item.

In some embodiments, in accordance with a determination that a respective representation of a respective field-of-view the environment (e.g., a camera preview and/or a captured media item; in some embodiments, the respective representation of the field-of-view of the environment is the representation of the field-of-view of the environment captured in response to detecting the sequence of one or more inputs) includes a representation of a first type of content and in accordance with a determination that the respective representation of the field-of-view of the environment is displayed in a user interface for capturing media (e.g., 608) (e.g., the respective representation is displayed in a live or near-live viewfinder of a camera application; e.g., prior to capturing the respective representation of the field-of-view of the environment as a media item), the computer system replaces the representation of the first type of content with first generative content (e.g., 614A) (e.g., as illustrated in FIG. 6C) (e.g., in the live capture preview, the computer system replaces the representation of the first type of content with a first version of generative infill content). In some embodiments, the computer system generates the first generative content using a first generative process. In some embodiments, the first type of content includes the first representation of the first type of object in the first position in the representation of the field-of-view of the environment (e.g., an arm, wrist, appendage, digit, camera mount, selfie stick, tripod, gimbal, and/or other object used to support and/or position the camera(s)). In some embodiments, the first type of content includes the first content representing the first portion of the respective field-of-view of the environment that is distorted by a physical feature of the one or more cameras (e.g., the lens geometry, sensor array, camera housing, and/or the interrelation between the three). In some embodiments, in accordance with a determination that a respective representation of a respective field-of-view the environment includes a representation of a first type of content and in accordance with a determination that the respective representation of the field-of-view of the environment is displayed in a user interface other than the user interface for capturing media (e.g., 618 and/or 624) (e.g., a media library, media viewing user interface, media editing user interface, messaging user interface, and/or social media user interface; e.g., after capturing the respective representation of the field-of-view of the environment as a media item), the computer system replaces the representation of the first type of content with second generative content (e.g., 614B and/or 614C) that is different from the first generative content (e.g., as illustrated in FIGS. 6D-6E and/or 6G) (e.g., in the captured media, the computer system replaces the representation of the first type of content with a second version of generative infill content). For example, the first generative content is generated faster than the second generative content, but the second generative content is higher-quality (e.g., more detailed and/or more realistic) than the first generative content. In some embodiments, the computer system generates the second generative content using a second generative process that is different from the first generative process. Replacing a portion of a representation of a field-of-view of an environment with a first version of infill while capturing media (e.g., while the representation is displayed in a live or near-live viewfinder for a camera user interface) and replacing the portion of the representation of the field-of-view of the environment with a second version of infill after the representation of the field-of-view of the environment is captured provides improved visual feedback to the user and reduces the time and number of inputs needed to perform an operation. For example, the initial infill indicates that the replacement process is available and quickly provides the user with a preview of the result.

Note that details of the processes described above with respect to method 700 (e.g., FIG. 7) are also applicable in an analogous manner to the methods described below with respect to FIGS. 9 and 10. For example, methods 900 and 1000 optionally include one or more of the characteristics of the various methods described above with reference to method 700. For example, when capturing media that is modified as described with respect to method 700, the inputs and processes described with respect to methods 900 and 1000 are used to control the framing of the media capture. For brevity, these details are not repeated below.

FIGS. 8A-8AC illustrate exemplary user interfaces for controlling camera framing when generating media, in accordance with some embodiments. The user interfaces in these figures are used to illustrate the processes described below, including the processes in FIGS. 9 and 10.

As illustrated in FIG. 8A, computer system 600 displays camera user interface 608 in a video capture mode, including camera preview 610, capture mode affordance 608A, camera selection affordance 608B, shutter affordance 608C, captured media icon 608D, and video timer 608H, a user interface element including a timer for indicating the duration of an ongoing video media capture. At FIG. 8A, computer system 600 is not capturing video media, so shutter affordance 608C is displayed with a first appearance (e.g., with a solid red circle indicating that shutter affordance 608C can be selected to initiate video capture) and video timer 608H is displayed with the time “00:00:00.”

At FIG. 8A, the one or more cameras of computer system 600 (e.g., cameras 604A-604D and/or one or more external cameras in communication with computer system 600) capture field(s)-of-view 800 of the environment, and computer system 600 displays a representation of portion 804 of field-of-view 800 in camera preview 610. Accordingly, as illustrated in the side panels of FIGS. 8A-8AC, portion 804 illustrates the current framing of camera preview 610 with respect to the portion of the environment captured using the one or more cameras. In some embodiments, field-of-view 800 of the one or more cameras includes a larger portion and/or additional portions of the environment than illustrated in the side panels of FIGS. 8A-8AC. At FIG. 8A, the framing of camera preview 610 is a wide (e.g., zoomed-out) shot, where portion 804 of field-of-view 800 is positioned and sized to include the head and upper body of a user of computer system 600 standing behind a visible kitchen counter.

At FIG. 8A, computer system 600 detects, within field-of-view 800, air gesture 802, which corresponds to a request to initiate a media capture. For example, computer system 600 analyzes the camera data captured by the one or more cameras using one or more image processing, machine vision, and/or machine learning techniques to identify the air gesture performed by the user. As illustrated in FIG. 8A, computer system determines that air gesture 802 includes the user holding up a hand with three fingers extended. Accordingly, computer system 600 initiates capturing video media with a three-second delay, corresponding to the detected number of extended fingers. In some embodiments, in response to other air gestures, computer system 600 initiates media capture without a delay (e.g., in response to detecting a pinch air gesture in a portion of the environment represented in camera preview 610 near shutter affordance 608C) and/or with different delay durations (e.g., in response to detecting gestures extending different numbers of figures corresponding to, e.g., one, two, four, or five second delays).

As illustrated in FIG. 8B, prior to capturing video content to be included in a video media item, computer system 600 displays delay indicator 608L, a three-second countdown timer. After the three-second countdown elapses, computer system 600 begins capturing, using the one or more cameras, video content to be included in a video media item. The captured video content includes camera data corresponding to at least portion 804 of field-of-view 800 (e.g., the portion of the environment represented in camera preview 610 while capturing the video content). In some embodiments, computer system 600 also captures camera data corresponding to portions of field-of-view 800 that are not included in portion 804 (e.g., portions outside of the frame of camera preview 610 while capturing the video content and/or portions of different field(s)-of-view of the environment than represented in camera preview 610 while capturing the video content). Accordingly, as further described with respect to FIGS. 8V-8W, when displaying and/or playing back media item captured as described with respect to FIGS. 8C-8U, in some embodiments, the framing of the captured media item is the same as the framing of camera preview 610 during capture (e.g., the captured media item is framed to include portion 804 of field-of-view 800 as defined during the capture), and in some embodiments, the framing of the captured media item differs from the framing of camera preview 610 during capture (e.g., the captured media item is framed to include a larger, smaller, or different portion of the environment than portion 804 of field-of-view 800 as defined during the capture). The captured video content also includes audio content captured using one or more microphones (e.g., and/or other audio sensors) that are in communication with computer system 600 while capturing the camera data using the one or more cameras.

As illustrated in FIG. 8C, once computer system 600 begins capturing the video content for the video media item, computer system 600 updates the appearance of shutter affordance 608C and video timer 608H to indicate that video capture has been initiated. For example, computer system 600 displays shutter affordance 608C with a second appearance (e.g., with a smaller red square indicating that shutter affordance 608C can be selected to stop the ongoing video capture), displays video timer 608H with a recording icon (e.g., a pulsing, blinking, or solid red dot), and updates the time displayed in video timer 608H to the current duration of the initiated video capture.

Additionally, while capturing the video content for the video media item, computer system 600 displays one or more subject indicators (e.g., 808A and/or 808B) based on candidate subjects detected in portion 804 of field-of-view 800. For example, computer system 600 analyzes the camera data represented in camera preview 610 using one or more image processing, machine vision, and/or machine learning techniques to identify the user and the jar the user is holding as potential features of interest in the environment. Subject indicator 808A includes framing elements displayed around the representation of the user's face and a badge with a person icon displayed near the representation of the user's face in camera preview 610, and subject indicator 808B includes framing elements displayed around the representation of the jar and a badge with a food icon displayed near the representation of the user's face in camera preview 610.

As illustrated in FIGS. 8C-8D, while capturing the video content for the video media item, computer system 600 detects one or more inputs (e.g., 806A, 806B, 810A, and/or 810B) corresponding to a request to reframe camera preview 610 to zoom in on the jar held by the user. As illustrated in FIG. 8C, air gesture 806A, detected in portion 804 of field-of-view 800, is an air gesture input that includes the user pointing with one hand at the jar held by the other hand. Computer system 600 determines that air gesture 806A corresponds to a request to reframe camera preview 610 to zoom in on the jar based on the identified air gesture and/or based on speech input 806B (e.g., “Today, we're cooking with this curry paste”), which is detected in the captured audio data shortly before, during, and/or shortly after detecting the air gesture. For example, computer system 600 identifies air gestures that includes extending one or two fingers of one hand towards an identified candidate subject (e.g., a subject indicated using one or more subject indicators, such as 808A and/or 808B) being held by a second hand as requests to zoom in on the held object. As another example, computer system 600 uses one or more speech recognition and/or natural-language processing techniques to determine that speech input 806B references the jar detected in field-of-view 800, indicating that air gesture 806A corresponds to a request to zoom in on the jar. For example, if air gesture 806A were detected without speech input 806B, computer system 600 would not reframe camera preview 610 to zoom in on the jar held by the user.

As illustrated in FIG. 8D, air gesture 810A, detected in portion 804 of field-of-view 800, is an air gesture that includes the user performing a framing gesture with one hand near the jar held by the other hand. The framing gesture includes extending the thumb and at least one finger of the hand to create a corner, which, when performed near an identified candidate subject, computer system 600 identifies as a request to zoom in on the held object (e.g., such that a corner of portion 804 approximately aligns with the detected location of the corner created by the air gesture, as illustrated in FIG. 8E). Speech input 810B is a spoken input, detected in the captured audio data, that includes a specific reframing request (e.g., “Zoom in on the jar of red curry paste”). For example, computer system 600 uses one or more natural-language processing techniques to determine that speech input 810B specifies the reframing operation to be performed (e.g., zooming in) and the subject to be included (e.g., the jar of red curry paste, which computer system 600 identifies in field-of-view 800 based on the type of object and/or the color specified by the speech input, as further discussed with respect to FIGS. 8R-8T).

At FIG. 8E, in response to detecting the one or more inputs (e.g., 806A, 806B, 810A, and/or 810B) corresponding to the request to reframe camera preview 610 to zoom in on the jar held by the user, computer system 600 reframes camera preview 610 to include a representation of a smaller portion of the environment than before, such that the jar held by the user fills a larger portion of the shot. For example, computer system 600 reframes camera preview 610 to include portion 804 of field-of-view 800 as illustrated in FIG. 8E by performing a digital zoom (e.g., cropping the portion of field-of-view 800 outside of portion 804 and digitally upscaling the representation of portion 804 to fill the frame of camera preview 610) and/or performing an optical zoom (e.g., capturing portion 804 of field-of-view 800 using a camera with a higher-magnification lens and/or higher-resolution sensors).

At FIG. 8E, the framing of camera preview 610 is a static framing, where, absent detecting another input (e.g., 812 and/or 814, described below) requesting to change the framing, computer system 600 does not change the size or positioning of portion 804 with respect to field-of-view 800 (e.g., the shot does not pan, zoom in, or zoom out). Accordingly, as illustrated in FIG. 8F, in response to the user moving the jar out of portion 804, computer system 600 does not change the framing of camera preview 610 (e.g., even though the initial request for reframing included a request to zoom in on the jar).

Alternatively, at FIG. 8E, computer system 600 detects, in portion 804 of field-of-view 800, air gesture 812, a pinch air gesture directed to the badge of subject indicator 808B. For example, as illustrated in FIG. 8E, computer system 600 detects that input 812 is directed to the badge of subject indicator 808B based on a determination that the representation of the user's hand performing input 812 displayed in camera preview 610 is near the location of the badge of subject indicator 808B on display 602 (e.g., the user appears to be pinching the badge in camera preview 610). In response to detecting air gesture 812, computer system 600 changes the framing of camera preview 610 to a dynamic framing based on the jar.

Accordingly, as illustrated in FIG. 8G, in response to the user moving the jar, computer system 600 reframes camera preview 610 to keep the jar within portion 804 of field-of-view 800, panning the shot down and to the right to follow the jar's location. For example, computer system 600 changes the cropping of portion 804 based on the detected location of the jar within field-of-view 800, changes the camera(s) used to capture portion 804, and/or causes the camera(s) to physically pan (e.g., move and/or rotate) down and to the right (e.g., using a computer-adjustable camera mount and/or camera housing). In response to detecting air gesture 812, computer system 600 updates the appearance of subject indicator 808B as illustrated in FIG. 8G to indicate that the framing of camera preview 610 is set to dynamically follow the jar. For example, computer system 600 changes the appearance of the framing elements displayed around the jar in camera preview 610, changes the appearance of the badge with the food icon (e.g., changing the color, visual emphasis, size, and/or location of the badge with respect to the jar (e.g., moving the badge to remain in the corner of the framing elements)), and/or emphasizes the appearance of the jar in camera preview 610, for instance, displaying a border element, such as highlighting, an edge glow, and/or a keyline, around the representation of the jar and/or displaying the representation of the jar with a fill effect.

As illustrated in FIGS. 8F-8G, after reframing camera preview 610 to zoom in on the jar held by the user (e.g., statically, as illustrated in FIGS. 8E-8F, or dynamically, as illustrated in FIGS. 8E and 8G), computer system 600 detects, within field-of-view 800 of the one or more cameras, air gesture 814, which corresponds to a request to cancel (e.g., revert) one or more previous reframing operations. Air gesture 814 includes the user waving an upheld hand back and forth. At FIGS. 8F-8G, portion 804 of field-of-view 800 does not include air gesture 814, so air gesture 814 is not shown in camera preview 610. In some embodiments, computer system 600 determines that air gesture 814 corresponds to a request to cancel the previous reframing based on a determination that the user performs air gesture 814 with one hand while still holding the jar in the other.

In response to detecting air gesture 814, at FIG. 8H, computer system 600 cancels the reframing of camera preview 610 performed in response to inputs 806A, 806B, 810A, 810B, and/or 812 (e.g., including automatic changes made while dynamically reframing camera preview 610 in response to air gesture 812), reverting the framing camera preview 610 to the positioning and sizing of portion 804 with respect to the environment illustrated in FIGS. 8A-8C. For example, in response to detecting air gesture 814, computer system 600 reverts the position and sizing of portion 804 with respect to field-of-view 800 to a default framing for capturing video media using camera user interface 608 and/or to the original framing of camera preview 610 when capturing the video content for the video media item is initiated (e.g., the framing at FIG. 8C). Computer system 600 reverts camera preview 610 as illustrated in FIG. 8H (e.g., to the original and/or default framing) regardless of how camera preview 610 is framed when air gesture 814 is detected (e.g., whether air gesture 814 is detected while displaying camera preview 610 with static framing, as described with respect to FIG. 8F, or dynamic framing, as described with respect to FIG. 8G).

At FIG. 8H, computer system 600 detects, within field-of-view 800 of the one or more cameras, air gesture 816, which includes the user pointing with both hands (e.g., extending at least one finger on each hand in the same (e.g., or similar) direction with respect to the environment). Based on a determination that the two-handed pointing of air gesture 816 is directed to a cutting board sitting flat on the kitchen counter in front of the user (e.g., a surface that is within a threshold range of perpendicular to the current plane of portion 804), computer system 600 determines that air gesture 816 corresponds to a request to reframe camera view 610 based on the surface of the cutting board and/or kitchen counter.

Accordingly, at FIG. 8I, in response to detecting air gesture 816, computer system 600 reframes camera preview 610 to include a top-down (e.g., rectified) view of the surface of the kitchen counter. In some embodiments, field-of-view 800 of the one or more cameras includes a field-of-view (e.g., 800A) of one or more cameras (e.g., external cameras in communication with computer system 600) positioned above the kitchen counter, pointing down at the surface, and computer system 600 reframes camera preview 610 to include portion 804 of field-of-view 800A, a top-down shot of the cutting board sitting flat on the kitchen counter. In some embodiments, field-of-view 800 includes a field-of-view captured using an ultra-wide-angle lens. For example, the one or more cameras include a camera with a fisheye and/or rectilinear lens with a 180° field-of-view in one or more directions, such that, even when pointed substantially parallel to the surface of the cutting board/kitchen counter, the captured field-of-view includes camera data corresponding to the surface of the cutting board/kitchen counter. In some embodiments, computer system 600 displays camera preview 610 with a digitally-rectified representation of portion 804 of the ultra-wide-angle field-of-view, such that camera preview 610 appears to include a physically top-down shot (e.g., instead of a shot captured from the actual position and angle of the ultra-wide-angle lens).

At FIG. 8I, computer system 600 detects the user performing a single clap (e.g., striking the palms and/or fingers of the hands together once). In particular, computer system 600 detects clap air gesture 818A in portion 804 of field-of-view 800 of the one or more cameras and detects clap audio input 818B (e.g., the sound of the hands striking together) in the captured audio data. As clap air gesture 818A is performed within portion 804 of field-of-view 800, camera preview 610 includes a representation of the user's hands performing clap air gesture 818A, seen in FIG. 8I in the lower left corner of camera preview 610.

At FIG. 8J, in response to detecting the user performing the single clap (e.g., clap air gesture 818A and/or clap audio input 818B), computer system 600 pauses capturing the video content (e.g., camera data and audio data) for the video media item. For example, computer system 600 does not include camera data and/or audio data captured while the video capture is paused in the video media item. As illustrated in FIG. 8J, while capturing the video content for the video media item is paused, computer system 600 changes the appearance of shutter affordance 608C (e.g., displaying shutter affordance 608C with the solid red circle displayed prior to initiating the video capture, indicating that shutter affordance 608C can be selected to resume capture) and video timer 608H (e.g., changing the color of video timer 608H and replacing the recording icon with a pause icon). Additionally, computer system 600 ceases updating the time displayed in video timer 608H, indicating that the duration of the video media item is not increasing as the capture is paused.

As illustrated in FIG. 8J, in response to detecting the user performing the single clap, while capturing the video content for the video media item is paused, computer system 600 displays one or more alignment indicators (e.g., 820A and/or 820B), which indicate where clap air gesture 818A was seen in camera preview 610 (e.g., the positioning of clap air gesture 818A in portion 804 of field-of-view 800). Alignment indicator 820A includes a pair of parallel lines that overlays the portion of camera preview 610 where computer system 600 detected the meeting of the user's two hands in clap air gesture 818A. Alignment indicator 820B includes a representation of two hands clapping that overlays the portion of camera preview 610 that included the representation of the user's hands performing clap air gesture 818A (e.g., when clap audio input 818B was detected). For example, alignment indicator 820B includes a semi-transparent cut-out of the representation of the user's hands displayed in camera preview 610 at FIG. 8I, an outline of the representation of the user's hands displayed in camera preview 610 at FIG. 8I, and/or an illustration and/or graphic representing the user's hands performing clap air gesture 818A.

At FIG. 8K, while capturing the video content for the video media item is paused, computer system 600 detects the user performing another single clap, including clap air gesture 822A and clap audio input 822B. As illustrated in FIG. 8K, clap air gesture 822A is performed at a position within portion 804 of field-of-view 800-1 such that, in camera preview 610, the representation of the user's hands performing clap air gesture 822A shows the hands meeting along the parallel lines of alignment indicator 820A and/or appearing at approximately the same size and position as the hands represented by alignment indicator 820B. In some embodiments, in a finished video media item created from the captured video content, computer system 600 automatically trims the video content captured before pausing and/or the video content captured after un-pausing to include one single clap in the video media item, creating the effect of instantly transforming the whole carrot seen on the cutting board in FIG. 8I into the chopped carrot seen on the cutting board in FIG. 8K (e.g., without showing the chopping process seen in FIG. 8J while the capture is paused). For example, computer system 600 includes the audio and/or video of only the first clap (e.g., 818A and/or 818B), the audio and/or video of only the second clap (e.g., 822A and/or 822B), or composited audio and/or video from both claps (e.g., including video of the hands approaching from clap air gesture 818A and the hands pulling apart from clap air gesture 822A).

At FIG. 8L, computer system 600 detects, in field-of-view 800 of the one or more cameras, air gesture 824, a two-handed air gesture including framing gesture 824A (e.g., extending the thumb and at least one finger to create a corner) performed with the user's right hand and framing gesture 824B performed with the user's left hand. As illustrated in FIG. 8L, air gesture 824 (e.g., 824A and 824B) is detected outside of portion 804 of field-of-view 800. Together, the corners created by the user's fingers when performing framing gesture 824A and framing gesture 824B indicate an approximate size and position of a requested framing for camera preview 610. For example, framing gesture 824A is performed to the right of the edge of the cutting board, and framing gesture 824B is performed to the left of a baking dish sitting on the kitchen counter next to the cutting board.

At FIG. 8M, in response to detecting air gesture 824, computer system 600 reframes camera preview 610 based on the relative positions of framing gesture 824A and framing gesture 824B. As illustrated in FIG. 8M, as the horizontal distance (e.g., projected horizontal distance) between the corners formed by framing gesture 824A and framing gesture 824B exceeds the width of portion 804 of field-of-view 800 when air gesture 824 is detected, computer system 600 zooms out in camera preview 610, increasing the width of portion 804 to approximately the horizontal distance. Additionally, as air gesture 824 is centered to the left of the center of portion 804 of field-of-view 800 when air gesture 824 is detected, computer system 600 pans camera preview 610 to the left, such that the corners of portion 804 approximately align with the corners formed by framing gesture 824A and framing gesture 824B. Accordingly, at FIG. 8M, camera preview 610 includes a shot of the kitchen counter spanning from left of the baking dish to right of the cutting board (e.g., the requested framing indicated by the two-handed framing gesture).

At FIG. 8N, computer system 600 detects, in field-of-view 800 of the one or more cameras, air gesture 826, a two-handed air gesture including framing gesture 826A performed with the user's right hand and framing gesture 826B performed with the user's left hand on either side of the baking dish. As illustrated in FIG. 8N, framing gesture 826A is detected in portion 804 of field-of-view 800, and framing gesture 826B is detected outside of portion 804 of field-of-view 800. At FIG. 8O, computer system 600 reframes camera preview 610 in response to air gesture 826 based on the framing indicated by the relative positions of framing gesture 826A and framing gesture 826B (e.g., as described with respect to air gesture 824 in FIGS. 8L-8M). In particular, as the horizontal distance between the corners formed by framing gesture 824A and framing gesture 824B less than the width of portion 804, computer system 600 zooms in in camera preview 610, and as air gesture 826 is centered to the left of the frame of camera preview 610 when detected, computer system 600 pans further to the left. Accordingly, at FIG. 8O, camera preview 610 includes a tighter shot of baking dish on the kitchen counter.

At FIG. 8O, computer system 600 detects, within field-of-view 800 of the one or more cameras, air gesture 828, which corresponds to a request to cancel the previous reframing operations. Air gesture 828 is a two-handed gesture including wave gesture 828A performed with the left hand and wave gesture 828B performed with the right hand. In some embodiments, computer system 600 determines that air gesture 828 corresponds to a request to cancel the previous reframing based on a determination that the user performs air gesture 828 with both hands while neither hand is holding a detected object (e.g., as described with respect to FIGS. 8F-8G). In response to detecting air gesture 828, at FIG. 8P, computer system 600 cancels the reframing of camera preview 610 performed in response to the requests of air gestures 816, 824, and/or 826, reverting camera preview 610 to the default/original framing illustrated in FIGS. 8A-8C and 8H, including displaying subject indicator 808A based on the detection of the user within the frame.

At FIG. 8P, computer system 600 detects one or more inputs, such as air gesture 830 and/or speech input 832 (e.g., “Ok, follow me to the oven”), corresponding to a request to dynamically reframe camera preview 610 based on the position of the user. Similarly to air gestures 824 and 826, air gesture 830 is a two-handed framing gesture, including framing gesture 830A performed with the user's right hand and framing gesture 830B performed with the user's left hand. In some embodiments, computer system 600 identifies air gesture 830 as a request to dynamically reframe camera preview 610 based on the position of the user based on determining that air gesture 830 is directed to the candidate subject indicated by subject indicator 808A (e.g., framing gesture 830A and framing gesture 830B frame the user's face as indicated by the framing elements of subject indicator 808A) and/or based on speech input 832 (e.g., identifying dynamic framing as the requested reframing operation based on the word “follow” and/or identifying the user as the reframing subject based on the word “me”).

In response to detecting the one or more inputs (e.g., 830 and/or 832), computer system 600 changes the framing of camera preview 610 to a dynamic framing based on the user. Accordingly, at FIG. 8Q, when the user walks from behind the kitchen counter over to the oven, computer system 600 reframes camera preview 610 to keep the user within portion 804 of field-of-view 800, panning the shot to the right to follow the user (e.g., changing the cropping of portion 804 from field-of-view 800, changing the camera(s) used to capture portion 804, and/or causing the camera(s) to physically pan field-of-view 800 to the right). Then, at FIG. 8R, when the user walks back to the kitchen counter, computer system 600 reframes camera preview 610 again, panning the shot back to the left to follow the user. In response to detecting the one or more inputs (e.g., 830 and/or 832), computer system 600 additionally updates the appearance of subject indicator 808A as illustrated in FIGS. 8Q-8R to indicate that the framing of camera preview 610 is set to dynamically follow the user (e.g., as described with respect to updating the appearance of subject indicator 808B in FIG. 8G).

As illustrated in FIG. 8R, computer system 600 identifies the three objects sitting on the kitchen counter in front of the user in portion 804 of field-of-view 800 as candidate subjects and, accordingly, displays the representations of the three objects in camera preview 610 with subject indicators 808C-808E. At FIG. 8R, computer system 600 detects air gesture 834A, a one-handed point directed to the object sitting furthest to the left on the kitchen counter (e.g., the candidate subject indicated by subject indicator 808C), and speech input 834B (e.g., “Take a closer look at this one”). In contrast to the one-finger point of air gesture 806A, air gesture 834 is not directed to a candidate object held by the user's other hand; however, based on speech input 834B (e.g., the words “take a closer look” and/or “this one”), computer system 600 determines that air gesture 806A corresponds to a request to reframe camera preview 610 to zoom in on the object sitting furthest to the left on the kitchen counter and, accordingly, reframes camera preview 610 as illustrated in FIG. 8S.

At FIG. 8S, computer system 600 detects air gesture 836, a two-handed point gesture including sweeping the extended fingers of point gesture 836A (e.g., a point performed with one hand) and point gesture 836B (e.g., a point performed with the other hand) together towards the right of the frame (e.g., portion 804 of field-of-view 800). In response to detecting air gesture 836, computer system 600 reframes camera preview 610 as illustrated in FIG. 8T, panning the shot right, over to the object sitting in the middle on the kitchen counter (e.g., the candidate subject indicated by subject indicator 808D in FIG. 8R). In some embodiments, computer system 600 reframes camera preview 610 based on the sweeping movement of point gesture 836A and point gesture 836B. For example, computer system 600 reframes the shot to follow the movement of the extended fingers, panning camera preview 610 in a direction, by an amount, and/or at a speed corresponding to the direction, distance, and/or speed of the sweeping motion.

In some embodiments, computer system 600 reframes camera preview 610 to include the object sitting in the middle on the kitchen counter based at least in part on speech input 838 (e.g., “Moving on to the tall jar . . . ”) detected along with air gesture 836. In some embodiments, computer system 600 identifies a subject for reframing camera preview 610 from the candidate subjects detected in FIG. 8R based on a speech input that includes one or more words indicating one or more visual characteristics of an object, person, and/or landmark in the environment, such as words or phrases describing object types, shapes, sizes, and/or colors in objective, subjective, and/or relative terms. For example, based on the visual characteristics of the candidate subjects and the words “tall jar,” indicating the object type and size/shape (e.g., relative to the other objects) of the middle object, computer system 600 reframes the shot to center on the middle object (e.g., the tallest jar-type object detected in field-of-view 800). As additional examples, computer system 600 reframes the shot as illustrated in FIG. 8T based on words such as “the one with the pastel label” (e.g., describing a color palette of a portion of the jar), “the straight-sided jar” (e.g., describing characteristics of the jar's form), “the middle one” (e.g., describing a relative location of the jar), or “the Quality Brand option” (e.g., describing a name, logo, and/or mark associated with the product).

At FIG. 8T, computer system 600 detects air gesture 840A, a one-handed point gesture sweeping an extended finger of one hand towards the right of the frame (e.g., portion 804 of field-of-view 800), and/or speech input 840B (e.g., “Pan over to the bowl of red curry paste”). In response to detecting air gesture 836, computer system 600 reframes camera preview 610 as illustrated in FIG. 8U, panning the shot right, over to the object sitting furthest to the right on the kitchen counter (e.g., the candidate subject indicated by subject indicator 808E in FIG. 8R). In some embodiments, computer system 600 reframes camera preview 610 based on speech input 840B. For example, computer system 600 identifies the requested reframing operation (e.g., panning) based on the words “Pan over” and identifies the object sitting furthest to the right on the kitchen counter based on the words “bowl of red curry paste” and the detected visual characteristics of the candidate subject (e.g., a bowl-type object containing a paste that is red in color) in field-of-view 800. In some embodiments, computer system 600 reframes camera preview 610 based on both air gesture 840A and speech input 840B. For example, based on a determination that speech input 840B includes the request to “pan over,” computer system 600 pans camera preview 610 to follow the movement (e.g., the direction, distance traveled, and/or speed) of the extended finger of air gesture 840A.

At FIG. 8U, computer system 600 detects air gesture 842, a two-handed wave gesture detected outside of portion 804 of field-of-view 800. As described with respect to FIGS. 8F, 8G and/or 8O, air gesture 842 corresponds to a request to cancel the previous reframing operations (e.g., the reframing performed in response to inputs 830, 832, 834A, 834B, 836, 838, 840A, and/or 840B, including automatic changes made while dynamically reframing camera preview 610 in response to air gesture 830 and/or speech input 832), reverting camera preview 610 to the original and/or default framing (e.g., the position and size of portion 804 with respect to field-of-view 800 illustrated in FIGS. 8A-8D, 8H, and 8P).

After capturing the video content for the video media item as described with respect to FIGS. 8C-8U, computer system 600 finishes (e.g., compiles and/or saves) the video media item from the captured camera data and audio data. For example, computer system 600 finishes the video media item in response to detecting one or more inputs requesting to end the video media capture, such as a touch input or air gesture directed to shutter affordance 608C. In some embodiments, when computer system 600 displays and/or plays back the finished video media item (e.g., in response to detecting an input requesting to view the finished video media item), the framing of the finished video media item corresponds to the framing of camera preview 610 while capturing the video content (e.g., the finished video media item includes the representation of portion 804 of field-of-view 800). However, in some embodiments, computer system 600 adjusts the framing of the finished video media item to differ from the framing of camera preview 610 while capturing the video content, such that, when computer system 600 displays and/or plays back the finished video media item, the finished video media item includes a representation of a portion of the environment that differs from portion 804. For example, FIGS. 8V-8W illustrate examples of adjusting the timing of changes to the framing of the video media item compared to the timing of the reframing operations performed while capturing the video. As additional examples, a representation of a portion of the environment in the finished video media item includes portions of field-of-view 800 and/or field-of-view 800A that were cropped out of portion 804 in camera preview 610 during the capture (e.g., parts of the finished video media item are displayed with a lower zoom level than used in camera preview 610), a representation of a portion of the environment in the finished video media item crops out portions of portion 804 that were displayed in camera preview 610 during capture (e.g., parts of the finished video media item are displayed with a higher zoom level than used in camera preview 610), and/or a representation of a portion of the environment in the finished video media item includes camera data captured using one or more cameras other than the camera(s) used to capture portion 804 to display in camera preview 610 during capture.

FIG. 8V illustrates adjusting a change to the video framing to occur earlier in the finished video media item than the change was shown in camera preview 610 during the capture of the video content. While capturing video content for the video media item at FIGS. 8H-8I, computer system 600 captures frames 844A-844E of Camera View #1 (e.g., the top panel of FIG. 8V) and frames 846A-846E of Camera View #2 (e.g., the bottom panel of FIG. 8V). Frames 844A-844E correspond to the same points in the video timeline as frames 846A-846E, respectively. For example, as described with respect to FIG. 8I, Camera View #1 and Camera View #2 are captured simultaneously using different cameras (e.g., one or more cameras facing the user and one or more cameras providing a top-down view), or computer system 600 generates Camera View #1 and Camera View #2 using camera data from one or more of the same cameras (e.g., Camera View #2 is a digitally-rectified representation of the surface of the cutting board/kitchen counter generated from an ultra-wide-angle field-of-view).

As described with respect to FIGS. 8H-8I, while capturing the video content for the video media item, computer system 600 changes the framing of camera preview 610 in response to detecting air gesture 816, the two-handed point at the cutting board surface seen in frames 844C and 844D. Accordingly, while capturing the video content for the video media item, camera preview 610 transitions from the framing represented in Camera View #1 to the framing represented in Camera View #2 at the point in the video timeline represented in FIG. 8V by transition arrow 848A. For example, while capturing video content for the video media item, camera preview 610 displays the frame sequence 844A-844B-844C-844D-846E. In contrast, in the finished video media item, computer system 600 adjusts the transition from the framing represented in Camera View #1 to the framing represented in Camera View #2 to the point in the video timeline represented in FIG. 8V by transition arrow 848B, such that the finished media item includes the frame sequence 844A-844B-846C-846D-846E.

FIG. 8W illustrates adjusting a change to the video framing to occur faster in the finished video media item than was shown in camera preview 610 during the capture of the video content. While capturing video content for the video media item at FIGS. 8D-8E, camera preview 610 displays frames 850A-850E as illustrated in the Recording View (e.g., the top panel of FIG. 8W), and in the finished media item, computer system 600 adjusts the framing as illustrated in corresponding frames 850A′-850E′ of the Final View (e.g., the bottom panel of FIG. 8W). For example, computer system 600 generates frames 850B′-850D′ by cropping and/or digitally enlarging portions of frames 850B-850D, and/or using camera data captured by one or more higher zoom level cameras while capturing frames 850B-850D.

As described with respect to FIGS. 8D-8E, in response to detecting air gesture 806A, which is visible in frame 850B, computer system 600 changes the framing of camera preview 610 to gradually zoom in on the jar held by the user as illustrated in frames 850C-850E. In contrast, in the finished media item, the zoom in on the jar held by the user completes by frame 850B′. For example, computer system 600 increments the zoom level from frame 850A′ to frame 850B′ faster in the Final View than in frames 850C-850E of the Recording View, or the computer system switches directly from the zoom level of frame 850A′ to the zoom level of frame 850B′ (e.g., a jump zoom).

In some embodiments, computer system 600 adjusts the framing of the finished video media item automatically. For example, computer system 600 automatically adjusts the timing of the reframing as described with respect to FIGS. 8V-8W to reduce latency introduced to the transition shown in camera preview 610 during the capture by the time spent detecting and/or determining how to respond to the reframing request. As another example, computer system 600 automatically adjusts the transition from Camera View #1 to Camera View #2 as described with respect to FIG. 8V in order to remove air gesture 816, which is visible in frames 844C-844D, from the finished video media item. In some embodiments, computer system 600 adjusts the framing of the finished video media item in response to one or more user inputs. For example, by capturing portions of field-of-view 800 other than portion 804 while capturing the video content for the video media item, computer system 600 allows users to frame the finished video media item on different portions of the environment than were represented in camera preview 610 during the capture.

FIGS. 8X-8AC illustrate additional examples of reframing camera view 610 based on spoken user inputs and/or air gestures detected along with spoken user inputs. In some embodiments, computer system 600 determines that an air gesture is detected along with a spoken user input when computer system 600 captures the audio data corresponding to the spoken user input shortly before, during, and/or shortly after capturing the camera data corresponding to the air gesture. For example, air gestures and spoken user inputs received near in time to each other are interpreted together to identify requests to reframe camera view 610.

At FIG. 8X, while capturing video content for a video media item, computer system 600 detects air gesture 852A along with speech input 852B (e.g., “Look at Briana”). As illustrated in FIG. 8X, computer system 600 is configured to capture video content for the video media item in a “selfie” mode, and camera preview 610 includes a representation of a field-of-view of the environment captured using fourth camera 604D (e.g., the user-facing camera) that includes a user of computer system 600 (e.g., portion 804 of field-of-view 800 is a portion of the field-of-view of fourth camera 604D). Air gesture 852A includes the user performing a one-handed point, extending one finger forward (e.g., in front of the user) and to the user's right. In some embodiments, as illustrated in FIG. 8X, in the “selfie” mode, the representation of portion 804 displayed in camera preview 610 is mirrored.

Computer system 600 determines to reframe camera preview 610 as illustrated in FIG. 8Y based on both air gesture 852A and speech input 852B. For example, computer system 600 analyzes (e.g., using image and/or video processing techniques, such as algorithmic image processing, machine vision, and/or machine learning techniques) camera data (e.g., and/or other optical sensor data, such as depth information) corresponding to air gesture 852A to determine the direction of the point with respect to the environment. For example, computer system 600 analyzes (e.g., using one or more speech recognition and/or natural-language processing techniques) audio data corresponding to speech input 852B to determine that speech input 852B corresponds to a reframing request (e.g., based on the words “Look at”) and/or one or more parameters of the reframing request (e.g., determining that the reframing request requests to include a person (e.g., a person-type object) and/or a specific person (e.g., a person named Briana) in the frame).

Accordingly, in response to air gesture 852A and speech input 852B, computer system 600 reframes camera preview 610 as illustrated in FIG. 8Y, where portion 804 of field-of-view 800 is a portion of a field-of-view of one or more of cameras 604A-604C (e.g., the environment-facing cameras) that includes a woman near the center of the frame and a man near the left edge of the frame. For example, computer system 600 switches to capturing video content using the environment-facing cameras based on air gesture 852A pointing in front of the user (e.g., behind fourth camera 604D) and/or based on a determination that the field-of-view of fourth camera 604D does not include a candidate subject corresponding to “Briana” (e.g., a person other than the user). In some embodiments, computer system 600 reframes camera preview 610 to include the woman near the center of the frame based on a determination that speech input 852B corresponds to a request to reframe on a person-type object (e.g., based on the name “Briana”) and based air gesture 852A pointing to the user's right (e.g., indicating a request to reframe to include the person to the user's right).

In some embodiments, computer system 600 reframes camera preview 610 to include the woman near the center of the frame based on identifying the woman as “Briana.” For example, computer system 600 determines that the name “Briana” included in speech input 852B corresponds to a contact of the user of computer system 600 named Briana, such as a contact saved in a contacts application of computer system 600 and/or tagged in media in a media library of computer system 600. Accordingly, based on image information associated with the contact Briana (e.g., a contact photo and/or tagged media items), computer system 600 determines that the visual characteristics of the woman in the field-of-view of the environment-facing cameras (e.g., her facial structure, eye color, and/or clothing style) identify her as the contact Briana. In some embodiments, computer system 600 reframes camera preview 610 as illustrated in FIG. 8Y based on an air gesture (e.g., 852A) and a speech input describing the woman, such as a speech input that indicates visual characteristics of the subject for reframing (e.g., as described with respect to FIGS. 8S-8U). For example, based on a speech input such as “Look at the long-haired woman” (e.g., describing the relative form of the woman's hair), “Pan over to the person in the blue shirt” (e.g., describing a color worn by the woman), or “Show the one wearing earrings” (e.g., describing a type of accessory worn by the woman), computer system 600 identifies the woman in field-of-view 800 and reframes camera preview 610 to include the woman near the center of the frame.

In some embodiments, in response to detecting air gesture 852A without speech input 852B, computer system 600 would not perform a reframing operation (e.g., speech input 852B is required to confirm that air gesture 852A corresponds to a reframing request) and/or would perform a different reframing operation than illustrated in FIG. 8Y (e.g., speech input 852B is used to refine a reframing request corresponding to air gesture 852A).

At FIG. 8Y, computer system 600 detects air gesture 856A along with speech input 856B (e.g., “Look over there”). Air gesture 856A includes the user performing a two-handed point, extending one finger of each hand forward (e.g., in front of the user) and to the user's right. As illustrated in FIG. 8Y, in some embodiments, after switching camera preview 610 to include a representation of a field-of-view of the environment-facing cameras, computer system 600 displays selfie camera preview 854, which includes a representation (e.g., a mirrored selfie representation, as described with respect to FIG. 8X) of at least a portion of the field-of-view of fourth camera 604D (e.g., the portion including the user of computer system 600), providing a live or near-live viewfinder for fourth camera 604D that allows the user to monitor air gestures when camera user interface 608 is not in the selfie configuration.

In response to air gesture 856A and speech input 856B, computer system 600 reframes camera preview 610 as illustrated in FIG. 8Z, panning to the user's right, to where portion 804 of field-of-view 800 includes the woman near the left of the frame and tower near the center of the frame. For example, computer system 600 determines that air gesture 856A corresponds to a request to reframe camera preview 610 based on speech input 856B (e.g., the word “Look”), and determines to perform the reframing operation of panning to the user's right based on the direction of air gesture 856A with respect to the environment. In some embodiments, computer system 600 reframes camera preview 610 as illustrated in FIG. 8Z based on an air gesture (e.g., 856A) and a speech input indicating one or more characteristics of the tower, such as a speech input that indicates the name, shape, color, and/or type of the landmark (e.g., as described with respect to FIGS. 8S-8U). For example, based on a speech input such as “Look at the clock tower,” “Pan over to the white brick structure,” or “Look at the University Tower,” computer system 600 identifies the tower in field-of-view 800 and reframes camera preview 610 to include the tower near the center of the frame.

At FIG. 8Z, computer system 600 detects air gesture 858A along with speech input 858B (e.g., “Look over there”). Air gesture 858A includes the user performing a two-handed point, extending one finger of each hand forward (e.g., in front of the user) and to the user's left. In response to air gesture 858A and speech input 858B, computer system 600 reframes camera preview 610 as illustrated in FIG. 8AA, panning back to the left right, to where portion 804 of field-of-view 800 includes the woman near the center of the frame and man near the left of the frame. Accordingly, although air gesture 858A and speech input 858B are the same type of air gesture (e.g., a two-handed point) and speech input 858B and speech input 856B include the same words (e.g., “Look over there”), computer system 600 performs different reframing operations based on the different directions detected from air gesture 858A and speech input 858B.

At FIG. 8AA, computer system 600 detects speech input 860, “Pull back the frame.” Computer system 600 determines, using one or more speech recognition and/or natural-language processing techniques, that speech input 860 corresponds to a reframe camera preview 610, and, in particular, to zoom out. For example, although speech input 860 does not include the specific words “zoom out,” computer system 600 determines that “Pull back the frame” is a natural-language request to change the framing as though moving backwards from the scene. Accordingly, at FIG. 8AB, computer system 600 zooms out in camera preview 610 to include a representation of a larger portion of the environment than before, such that the woman and man fill a smaller portion of the shot. As illustrated in FIG. 8AA-8AB, computer system 600 updates zoom affordance 608E based on the performed reframing operation, changing from emphasizing a control element corresponding to a 1× zoom level in FIG. 8AA to emphasizing a control element corresponding to a 0.5× zoom level in FIG. 8AB.

At FIG. 8AB, computer system 600 detects speech input 862, “Switch back to me.” Computer system 600 determines, using one or more speech recognition and/or natural-language processing techniques, that speech input 862 corresponds to a request to reframe camera preview 610, and, in particular, to switch back to capturing video content for the video media item using fourth camera 604D (e.g., the user-facing camera). For example, computer system 600 determines that the word “me” refers to the user of computer system 600, who is included in the field-of-view of fourth camera 604D. Accordingly, at FIG. 8AC, computer system 600 reverts camera preview 610 to the “selfie” view. In some embodiments, after performing the reframing operations described with respect to FIGS. 8Y-8AB, computer system 600 reverts camera preview 610 to the “selfie” view as illustrated in FIG. 8AC in response to detecting the user performing a cancel air gesture (e.g., waving one or both hands as described above with respect to FIGS. 8F-8G, 8O, and/or 8U).

FIG. 9 is a flow diagram illustrating a method for changing and reverting changes to framing of a camera view using a computer system in accordance with some embodiments. Method 900 is performed at a computer system (e.g., 100, 300, 500, 600) (e.g., including one or more mobile phones, personal computers, laptops, tablets, headsets, wearable devices, and/or other electronic devices) that is in communication with one or more display generation components (e.g., 602) (e.g., a display controller; a touch-sensitive display system; a display (e.g., integrated and/or connected), a 3D display, a transparent display, a projector, and/or a heads-up display) and one or more input devices including one or more cameras (e.g., 604A, 604B, 604C, and/or 604D) (e.g., one or more rear (user-facing) cameras, forward (environment-facing) cameras, and/or externally-connected cameras, and/or a plurality of cameras with different lenses (e.g., different fixed focal lengths), such as a standard camera, a telephoto camera, a wide-angle camera, and/or a macro camera). In some embodiments, the one or more input devices include one or more touch-sensitive surfaces, hardware input devices (e.g., hardware buttons, switches, keys, and/or dials), microphones, gesture input devices, air gesture input devices, and/or gaze input devices. In some embodiments, the computer system is optionally in communication with one or more sensors, such as optical sensors, depth sensors, capacitive sensors, intensity sensors, motion sensors, vibration sensors, audio sensors, light sensors, temperature sensors, and/or biometric sensors. Some operations in method 900 are, optionally, combined, the orders of some operations are, optionally, changed, and some operations are, optionally, omitted.

As described below, method 900 provides an intuitive way of changing and reverting changes to framing of a camera view. The method reduces the cognitive burden on a user when changing and reverting changes to framing of a camera view, thereby creating a more efficient human-machine interface. For battery-operated computing devices, enabling a user to change and revert changes to framing of a camera view faster and more efficiently conserves power and increases the time between battery charges.

While displaying, via the one or more display generation components, a camera view (e.g., 610) (e.g., a camera preview (e.g., a live or near-live camera viewfinder) and/or a media item (e.g., photo and/or video media) that includes a representation of a first field-of-view of an environment (e.g., captured using the one or more cameras), the computer system detects (902), via the one or more input devices (e.g., via the one or more cameras and/or the one or more other input devices; in some embodiments, within the representation of the field-of-view of the environment), a first set of one or more inputs (e.g., 806A, 806B, 810A, 810B, 812, 816, 824, 826, 830, 832, 834A, 834B, 836, 838, 840A, 840B, 852A, 852B, 856A, 856B, 858A, 858B, 860, and/or 862) (e.g., air gesture inputs, touch inputs, spoken inputs, and/or hardware inputs) corresponding to a request to reframe the camera view (e.g., as illustrated in FIGS. 8C-8E, 8H, 8L, 8N, 8P, 8R-8T, and/or 8X-8AB). For example, the first set of one or more inputs is detected while displaying the camera view with an initial framing configuration. In some embodiments, the first set of one or more inputs is detected while performing a media capture operation (e.g., while capturing the camera view as a media item), such as a video and/or photo media capture operation.

In response to detecting (902) the first set of one or more inputs corresponding to a request to reframe the camera view, the computer system reframes (904) (e.g., changing the portion of the environment represented in) the camera view (e.g., in the camera preview and/or in the captured media item) to include a representation of a respective changed field-of-view of the environment that is different from (e.g., at least partially different from) the first field-of-view of the environment (e.g., as illustrated in FIGS. 8E, 8I, 8M, 8O, 8Q, 8S-8U, and/or 8Y-8AC (e.g., reframing the camera view in a media capture user interface) and/or as illustrated in FIGS. 8V-8W (e.g., reframing the camera view in a finished media item)). For example, reframing the camera view includes panning, changing the zoom level, cropping, changing the capture angle, and/or changing the camera and/or camera data used in order to display, via the one or more display generation components, a different view of the environment in the camera preview and/or in a corresponding captured media item. In some embodiments, the computer system displays, via the one or more display generation components, the camera view including the representation of the second field-of-view of the environment. In some embodiments, the computer system reframes the camera view to include (e.g., the computer system displays) the representation of the respective changed field-of-view of the environment while performing the media capture operation. For example, the camera view provides a preview of the framing of the environment represented in the captured media item.

After reframing (904) the camera view (in some embodiments, while displaying, via the one or more display generation components, the camera view; in some embodiments, while the camera view includes the representation of the respective changed field-of-view of the environment), the computer system detects (906), via the one or more cameras (e.g., within the second field-of-view of the environment (e.g., the current camera view) and/or within a different field-of-view of the environment), an air gesture (e.g., 814, 828, and/or 842, as illustrated in FIGS. 8F-8G, 8O, and/or 8U) (e.g., a cancel gesture). In some embodiments, the air gesture is detected via the one or more cameras while performing the media capture operation.

In response to detecting (906) the air gesture, the computer system reframes the camera view (e.g., in the camera preview and/or in the captured media item) to include a representation of a third field-of-view of the environment (e.g., a standard and/or default field-of-view) that is different from (e.g., at least partially different from) the respective changed field-of-view of the environment (e.g., as illustrated in FIGS. 8H and/or 8P) (in some embodiments, the third field-of-view is the same as the first field-of-view of the environment (e.g., the reframing is reversed); in some embodiments, the third field-of-view is different from the first field-of-view of the environment (e.g., the reframing is partially reversed and/or reverted to a previous state)). In some embodiments, the third field-of-view includes at least a portion of the first field-of-view and/or excludes at least a portion of the respective changed field-of-view. In some embodiments, the computer system displays, via the one or more display generation components, the camera view including the representation of the third field-of-view of the environment. In some embodiments, the computer system reframes the camera view to include the representation of the third field-of-view of the environment while performing the media capture operation. In some embodiments, while displaying the camera view, the computer system captures (e.g., in response to a request to perform a capture operation) a media item (e.g., a photo and/or video media item), wherein the media item includes camera data corresponding to at least the field(s)-of-view of the environment included (e.g., displayed) in the camera view while performing the capture and optionally includes camera data corresponding to other field(s)-of-view of the environment. Providing user interfaces for reframing a camera view in response to a user input and reverting the reframing of the camera view (e.g., to a default state) in response to an air gesture detected by the camera(s) reduces the number of inputs needed to perform reframing operations and provides additional control options without cluttering the user interface with additional displayed controls, making the user-system interface more efficient, which, additionally, reduces power usage and improves battery life of the system by enabling the user to use the system more quickly and efficiently. Doing so also assists the user with composing media capture events and reduces the risk that transient media capture opportunities are missed or mis-captured (e.g., due to unintended capture framing), which enhances the operability and ergonomics of the system and makes the user-system interface more efficient by helping the user to provide proper inputs and reducing user mistakes when operating/interacting with the system. For example, after reframing a camera view, a user can quickly cause the framing to revert to a previous state with an air gesture, without needing to provide additional manual reframing inputs, inputs at the device (e.g., touch and/or button inputs) during an ongoing media (e.g., video) capture, and/or inputs to manually edit the media to the desired framing. As another example, using an air gesture to cause the framing to revert to the previous state reduces the need for additional displayed reframing controls that distract the user and/or obscure the displayed camera view (e.g., during an ongoing capture).

In some embodiments, reframing the camera view to include the representation of the respective changed field-of-view of the environment includes, in accordance with a determination that the request to reframe the camera view corresponds to a request for a first type of reframing (e.g., zooming, panning, static reframing, dynamic reframing, changing capture angle, changing camera selection, reframing in a particular direction, and/or reframing to a particular extent), reframing the camera view to include a representation of a first changed field-of-view of the environment (e.g., changing the framing of the camera view in a first manner in response to a request for the first type of reframing). In some embodiments, the request to reframe the camera view corresponds to a request for the first type of framing when the first set of one or more inputs includes a first type of input. In some embodiments, reframing the camera view to include the representation of the respective changed field-of-view of the environment includes, in accordance with a determination that the first set of one or more inputs corresponding to the request to reframe the camera view includes one or more inputs corresponding to a second type of reframing that is different from the first type of reframing (e.g., zooming, panning, static reframing, dynamic reframing, changing capture angle, changing camera selection, reframing in a different direction, and/or reframing to a different extent), reframing the camera view to include a representation of a second changed field-of-view of the environment that is different from the first changed field-of-view of the environment (e.g., changing the framing of the camera view in a second manner in response to a request for the second type of reframing). In some embodiments, the request to reframe the camera view corresponds to a request for the second type of framing when the first set of one or more inputs includes a second type of input. In some embodiments, the computer system reframes the camera view to include the representation of the third field-of-view of the environment in response to the air gesture whether the camera view was reframed to the first changed field-of-view, the second changed field-of-view, and/or another changed field-of-view (e.g., the cancel gesture will revert the framing to the same state regardless of how the camera view was reframed). Providing user interfaces for reframing a camera view in various ways and reverting the reframing of the camera view to a standard state (e.g., the third field-of-view) in response to the air gesture, regardless of the way in which the camera view was reframed, reduces the number of inputs needed to perform reframing operations, assists the user with composing media capture events, and reduces the risk that transient media capture opportunities are missed or mis-captured. For example, the user interface provides users with flexible reframing options for composing the camera view without requiring the user to provide additional manual reframing inputs to return to the standard state from the different reframed states.

In some embodiments, after reframing the camera view to include the representation of the respective changed field-of-view of the environment (e.g., as illustrated in FIGS. 8E, 8I, 8M, 8S, and/or 8T) (e.g., while displaying the camera view; in some embodiments, while the camera view includes the representation of the respective changed field-of-view of the environment and/or another field-of-view of the environment), the computer system detects, via the one or more input devices (e.g., via the one or more cameras and/or the one or more input devices; in some embodiments, within the representation of the field-of-view of the environment), a second set of one or more inputs (e.g., 812, 824, 826, 836, 838, 840A, and/or 840B) (e.g., air gesture inputs, touch inputs, spoken inputs, and/or hardware inputs) corresponding to a second request to reframe the camera view. In some embodiments, the first set of one or more inputs is detected while performing the media capture operation. In some embodiments, in response to detecting the second set of one or more inputs corresponding to the second request to reframe the camera view, the computer system reframes the camera view to include a representation of a second respective changed field-of-view of the environment that is different from the third field-of-view of the environment (e.g., as illustrated in FIGS. 8G, 8M, 8O, 8T, and/or 8U), wherein the air gesture (e.g., 814, 828, and/or 842) is detected while displaying the camera view including the second respective changed field-of-view of the environment (e.g., the camera view is reframed multiple times before reverting back to the third field-of-view of the environment in response to the air gesture). In some embodiments, reframing the camera view to include the representation of the second respective changed field-of-view of the environment is performed while capturing the media item. Providing user interfaces for reframing a camera view multiple times prior to reverting the reframing of the camera view to a standard state (e.g., the third field-of-view) in response to the air gesture reduces the number of inputs needed to perform reframing operations, assists the user with composing media capture events, and reduces the risk that transient media capture opportunities are missed or mis-captured. For example, the user interface provides users with flexible reframing options for composing the camera view without requiring the user to provide additional manual reframing inputs to return to the standard state after reframing multiple times.

In some embodiments, the air gesture (e.g., 814, 828, and/or 842) is detected, via the one or more cameras (e.g., within a field-of-view of an environment of at least one camera), in a respective region of the environment while displaying, via the one or more display generation components, the camera view including a representation of a respective field-of-view of the one or more cameras (e.g., the respective changed field-of-view of the environment and/or another field-of-view of the environment that is different from the third field-of-view of the environment) that does not include a representation of the respective region of the environment (e.g., as illustrated in FIGS. 8F-8G, 8O, and/or 8U) (e.g., the air gesture is detected out of the frame of the camera view). In some embodiments, the first region of the environment is included in the respective field-of-view of the one or more cameras but is cropped from the representation of the respective field-of-view of the one or more cameras displayed in the camera view. In some embodiments, the first region of the environment is included in a different field-of-view of the one or more cameras (e.g., a field-of-view of a first camera) than the respective field-of-view of the one or more cameras (e.g., a field-of-view of one or more cameras other than the first camera). Reverting the reframing of the camera view in response to an air gesture detected outside of a field-of-view of the environment represented in the camera view provides additional control options without cluttering the user interface with additional displayed controls, assists the user with composing media capture events, and reduces the risk that transient media capture opportunities are missed or mis-captured. For example, users can efficiently return to the standard state using an air gesture performed at a location that avoids obscuring the camera view and/or is convenient/comfortable (even when the reframing has excluded the location).

In some embodiments, the air gesture includes a waving motion of one or more hands of a user (e.g., as illustrated in FIGS. 8F-8G, 8O, and/or 8U). In some embodiments, a wave motion includes motion of within a threshold speed range and/or within a threshold predetermined magnitude range (e.g., distance moved and/or amount of rotation). In some embodiments, a waving motion includes motion of the one or more hands while the one or more hands are in a predetermined pose (e.g., with fingers extended). In some embodiments, a wave motion includes a predetermined motion sequence (e.g., changing the direction of motion (e.g., waving the hands back and forth) at least once, at least twice, or another number of times). For example, a waving motion (e.g., gesture) includes moving and/or rotating a hand back and forth with the palm facing substantially forward (e.g., towards the camera). In some embodiments, the air gesture includes a waving motion of two hands of a user (e.g., as illustrated in FIGS. 8O and/or 8U) (e.g., waving both hands at the same time). For example, a waving motion (e.g., gesture) includes moving and/or rotating both hands back and forth with the palms facing substantially forward (e.g., towards the camera).

In some embodiments, detecting the first set of one or more inputs corresponding to the request to reframe the camera view includes detecting, via the one or more cameras, a respective air gesture (e.g., 806A, 810A, 812, 816, 824, 826, 830, 834A, 836, 840A, 852A, 856A, and/or 858A) (e.g., different from the air gesture detected after reframing the camera view). In some embodiments, the air gesture detected after reframing the camera view is a first type of air gesture and the respective air gesture is a second type of air gesture different from the first type (in some embodiments, the first type of air gesture does not correspond to a request to reframe and is only used to revert reframing). In some embodiments, reframing the camera view to include the representation of the respective changed field-of-view of the environment is based on the respective air gesture (e.g., the reframing is based on a type, motion, direction, location, and/or magnitude of the respective air gesture). Providing user interfaces for reframing a camera view in response to air gesture inputs reduces the number of inputs needed to perform reframing operations, provides additional control options without cluttering the user interface with additional displayed controls, assists the user with composing media capture events, and reduces the risk that transient media capture opportunities are missed or mis-captured. For example, air gestures allow users to quickly and intuitively reframe the camera view without needing to provide additional inputs physically interacting with the camera computer system (e.g., touch and/or button inputs) and/or to manually edit captured media to achieve the desired framing. As another example, using an air gesture to reframe the camera view reduces the need for additional displayed reframing controls that distract the user and/or obscure the displayed camera view.

In some embodiments, the respective air gesture (e.g., corresponding to the request to reframe the camera view) is detected, via the one or more cameras (e.g., within a field-of-view of an environment of at least one camera), in a respective region (e.g., 804) of the environment, wherein the representation of the first field-of-view of the environment includes a representation of the respective region of the environment (e.g., as illustrated in FIGS. 8C-8E, 8H, 8N, 8P, and/or 8R-8T) (e.g., the respective air gesture is detected within the frame of the current camera view). Reframing of the camera view in response to an air gesture detected within a field-of-view of the environment represented in the camera view provides additional control options without cluttering the user interface with additional displayed controls, assists the user with composing media capture events, and reduces the risk that transient media capture opportunities are missed or mis-captured. For example, the computer system allows users to efficiently reframe a camera view using an air gesture to indicate a region or object within the camera view to focus on, zoom in on, pan to, and/or follow.

In some embodiments, the respective air gesture (e.g., corresponding to the request to reframe the camera view) is detected, via the one or more cameras (e.g., within a field-of-view of an environment of at least one camera), in a respective region of the environment, wherein the representation of the first field-of-view of the environment does not include a representation of the respective region of the environment (e.g., as illustrated in FIGS. 8L and/or 8N) (e.g., the respective air gesture is detected out of the frame of the current camera view). In some embodiments, the respective region of the environment is included in the field-of-view of the one or more cameras but is cropped from the representation of the first field-of-view of the environment displayed in the camera view. In some embodiments, the respective region of the environment is included in a different field-of-view of the one or more cameras (e.g., a field-of-view of a first camera) than the field-of-view of the one or more cameras represented in the first field-of-view of the environment (e.g., a field-of-view of one or more cameras other than the first camera). Reframing of the camera view in response to an air gesture detected outside of a field-of-view of the environment represented in the camera view provides additional control options without cluttering the user interface with additional displayed controls, assists the user with composing media capture events, and reduces the risk that transient media capture opportunities are missed or mis-captured. For example, the computer system allows users to efficiently reframe a camera view using an air gesture performed at a location that avoids obscuring the camera view and/or is convenient/comfortable even when the current framing has excluded the location.

In some embodiments, the respective air gesture (e.g., corresponding to the request to reframe the camera view) includes a pointing gesture (e.g., 806A, 816, 834A, 836, 840A, 852A, 856A, and/or 858A). In some embodiments, a pointing gesture includes a motion of the user's hand(s) into a predetermined pointing pose (e.g., with at least one finger extended relative to the hand and/or other fingers). In some embodiments, a pointing gesture includes a motion of the user's hand(s) relative to the hand pose (e.g., moving the fingers, hand, wrist, or arm to point at a particular location). In some embodiments, reframing the camera view to include the representation of the respective changed field-of-view of the environment in response to the point gesture includes reframing the camera view to include, zoom in on, and/or follow a portion of the environment indicated by a direction and/or location of the point gesture. Reframing a camera view in response to a pointing air gesture provides additional control options without cluttering the user interface with additional displayed controls and assists the user with composing media capture events, for instance, by allowing users to specify the reframing of the camera view using intuitive, easy-to-perform air gestures without needing to navigate additional displayed controls.

In some embodiments, the respective air gesture (e.g., corresponding to the request to reframe the camera view) includes a pointing gesture (e.g., 806A, 816, and/or 834A) that is directed to (e.g., pointing at or towards) a respective object (e.g., a person, a person's face, a physical surface, a landmark, a physical item, and/or an item of information) recognized (e.g., using image processing and/or machine vision techniques) in a field-of-view of the one or more cameras (e.g., as illustrated in FIGS. 8C, 8H, and/or 8R). In some embodiments, reframing the camera view to include the representation of the respective changed field-of-view of the environment in response to the point gesture includes reframing the camera view to include a changed view of the respective object. In some embodiments, reframing the camera view to include the representation of the respective changed field-of-view of the environment in response to the point gesture includes reframing the camera view to include, zoom in on, and/or follow the respective object. Reframing a camera view in response to a pointing air gesture provides additional control options without cluttering the user interface with additional displayed controls and assists the user with composing media capture events, for instance, by allowing users to specify a subject for reframing of the camera view using intuitive, easy-to-perform air gestures without needing to navigate additional displayed controls.

In some embodiments, the respective air gesture includes a framing gesture (e.g., 824, 826, and/or 830) indicating the respective changed field-of-view of the environment with a first hand of a user and a second hand of the user (e.g., as illustrated in FIGS. 8L, 8N, and/or 8P). For example, the user uses the two hands to indicate two or more boundaries (e.g., edges and/or corners) of the respective changed field-of-view. In some embodiments, reframing the camera view to include the representation of the respective changed field-of-view of the environment in response to the framing gesture includes reframing the camera view to include, zoom in on, and/or follow a location, area, and/or object that is at least partially framed by the two hands. Reframing a camera view in response to a two-handed framing air gesture provides additional control options without cluttering the user interface with additional displayed controls and assists the user with composing media capture events, for instance, by allowing users to specify the reframing of the camera view using intuitive, easy-to-perform air gestures without inadvertently causing reframing of the camera view with unintentional one-handed gestures.

In some embodiments, a zoom level of the respective changed field-of-view of the environment is based on a distance between the first hand of the user and a second hand of the user while performing the framing gesture (e.g., as illustrated in FIGS. 8M and/or 8O). In some embodiments, the distance is a distance between two respective reference points of the two hands, e.g., a distance between the pointer fingers of each hand, a distance between the palms of each hand, and/or a distance between the corners between the thumb and pointer fingers of each hand. For example, reframing the camera view to the respective changed field-of-view of the environment includes changing the zoom level of the camera view so that a dimension (e.g., height, width, and/or aspect ratio) of the respective changed field-of-view of the environment corresponds to (e.g., matches and/or is proportional to) the distance between the two hands (e.g., reframing the camera view to “fit” within a frame defined by the two hands while performing the framing gesture). Reframing a camera view in response to a two-handed framing air gesture based on the spacing of the user's hands provides additional control options without cluttering the user interface with additional displayed controls and assists the user with composing media capture events, for instance, by allowing users to specify the dimensions and/or location of the reframed camera view using intuitive, easy-to-perform air gestures without needing to navigate additional displayed controls.

In some embodiments, reframing the camera view to include the representation of the respective changed field-of-view of the environment includes panning the camera view based on a motion (e.g., 826, 836A, 836B, and/or 840A) (e.g., a direction, magnitude, and/or rate of movement) of one or more hands of a user while performing the respective air gesture (e.g., as illustrated in FIGS. 8O and/or 8S-8U). For example, the computer system pans the camera view to follow the movement of the one or more hands and/or to pan in a direction indicated by the movement of the one or more hands. In some embodiments, panning the camera view includes digitally panning the camera view by changing which portion of a field-of-view of the one or more cameras is included in the camera view. For example, the camera view includes a representation of the environment cropped from a representation of a larger portion of the environment captured by the one or more cameras, and panning the camera view includes cropping the captured representation to simulate physically panning a camera across the larger portion of the environment captured by the one or more cameras. In some embodiments, panning the camera view includes physically changing the camera view. For example, the computer system physically moves and/or reorients at least one camera to capture a different portion of the environment using an electronically-controlled camera mount that is in communication with the computer system. In some embodiments, the computer system is in communication with two or more cameras physically located at two or more different positions within the environment, and panning the camera view includes changing the camera(s) used to capture the environment. Reframing a camera view in response to an air gesture based on the movement of the user's hand(s) provides additional control options without cluttering the user interface with additional displayed controls and assists the user with composing media capture events, for instance, by allowing users to specify the direction and/or location of a reframed camera view using intuitive, easy-to-perform air gestures without needing to navigate additional displayed controls.

In some embodiments, panning the camera view based on the motion of the one or more hands of the user while performing the respective air gesture includes panning the camera view in a direction indicated by one or more fingers (e.g., one or more extended and/or pointing fingers) of the one or more hands while performing the respective air gesture (e.g., as illustrated in FIGS. 8S-8U) (e.g., the camera view pans in the direction the fingers are pointing with respect to the environment). In some embodiments, panning the camera view based on the motion of the one or more hands of the user while performing the respective air gesture includes panning the camera view to follow a motion of one or more fingers (in some embodiments, one or more fingers in a particular pose, such as pointed/extended fingers and/or fingers defining a framing gesture) of the one or more hands (e.g., as illustrated in FIGS. 8O and/or 8S-8U) (e.g., the camera view pans to follow a location of the fingers as the fingers move with respect to the environment).

In some embodiments, detecting the first set of one or more inputs corresponding to the request to reframe the camera view includes, in accordance with a determination that a respective set of criteria is satisfied, detecting, via the one or more cameras, a one-handed air gesture performed by a first hand of a user (e.g., 806A, 810A, and/or 812), wherein the one-handed air gesture is directed to (e.g., pointing at, moving towards, framing, and/or otherwise indicating) a respective object held by a second hand of the user that is different from the first hand of the user (e.g., as illustrated in FIGS. 8C-8E). In some embodiments, the respective set of criteria includes a criterion that is satisfied when the computer system detects that the second hand of the user is holding the respective object (e.g., one-handed gestures are available to use for reframing if the computer system detects that one of the user's hands is occupied). In some embodiments, in accordance with a determination that the respective set of criteria is not satisfied, the computer system does not detect the one-handed air gesture as one of the first set of one or more inputs corresponding to the request to reframe the camera view (e.g., the computer system does not reframe the camera view in response to and/or based on the one-handed air gesture). Reframing a camera view in response to a one-handed air gesture performed while the user is holding an object with the other hand provides additional control options without cluttering the user interface with additional displayed controls and assists the user with composing media capture events, for instance, by allowing users to specify the reframing of the camera view using intuitive, easy-to-perform one-handed air gestures without needing to otherwise change the contents of the camera view (e.g., by releasing the held object), but requiring two-handed gestures to reduce unintentional reframing when the other hand is not occupied.

In some embodiments, the respective set of criteria includes a criterion that is satisfied when the first hand of the user is in a respective pose while performing the one-handed air gesture (e.g., as illustrated in FIGS. 8C-8E). In some embodiments, in accordance with a determination that the criterion is not satisfied, the computer system does not detect the one-handed air gesture as one of the first set of one or more inputs corresponding to the request to reframe the camera view (e.g., the computer system does not reframe the camera view in response to and/or based on one-handed air gestures other than gestures in the respective pose). Reframing a camera view in response to a particular one-handed air gesture performed while the user is holding an object with the other hand provides additional control options without cluttering the user interface with additional displayed controls and assists the user with composing media capture events, for instance, by allowing users to specify the reframing of the camera view using the particular one-handed gesture while the user's other hand is occupied, but otherwise requiring two-handed gestures to reduce unintentional reframing based on other hand movements.

In some embodiments, the respective pose includes extending (e.g., towards/in the direction of the respective object) at least one finger of the first hand of the user without extending a plurality of other fingers of the first hand of the user (e.g., 806A as illustrated in FIG. 8C) (e.g., a pointing pose directed to the respective object held by the second hand). For example, one, two, or three fingers are extended away from the palm of the first hand while two or more fingers remained curled and/or bent in towards the palm of the first hand. In some embodiments, the respective pose includes extending a first finger of the first hand in a first direction and extending a second finger of the first hand in a second direction that is different from (in some embodiments, within a threshold degree from (e.g., substantially) perpendicular to) the first direction (e.g., a framing gesture) while the respective object is within a threshold distance of the first hand (e.g., 810A as illustrated in FIG. 8D). For example, the respective pose includes extending the thumb and forefinger to form a substantially right angle, wherein the respective object falls within a region defined by the corner created by the thumb and forefinger.

In some embodiments, the respective air gesture includes a first pointing gesture performed with a first hand of a user and a second pointing gesture performed with a second hand of a user (e.g., 816) (e.g., a two-finger point), and reframing the camera view to include the representation of the respective changed field-of-view of the environment includes, in accordance with a determination that the first pointing gesture and the second pointing gesture are directed to a surface in the environment (e.g., as illustrated in FIG. 8H) (e.g., a surface that is within a first threshold degree of perpendicular to a plane of the first field-of-view of the environment), reframing the camera view to include a representation of a changed field-of-view of the environment that is within a respective threshold degree (e.g., 0.1°, 0.5°, 1°, 5°, 10°, 15°, 25°, or 45°) of perpendicular to a plane of the surface (e.g., as illustrated in FIG. 8I) (e.g., a rectified view of the surface). In some embodiments, in accordance with a determination that either pointing gesture is not directed to a surface in the environment, the camera view is reframed in another manner, such as panning in a direction indicated by the pointing gesture and/or panning to and/or zooming in on an object indicated by the pointing gesture. In some embodiments, the representation of the changed field-of-view of the environment is a digitally rectified (e.g., projected) view of the surface. For example, the computer system digitally reconstructs the changed field-of-view of the environment that is within the respective threshold degree of perpendicular to the plane of the surface from one or more fields-of-view of one or more cameras that are not within the threshold degree of perpendicular to the plane of the surface. In some embodiments, the changed field-of-view of the environment is a physically rectified view of the surface (e.g., a field-of-view of one or more cameras physically positioned to point at the plane of the surface). Reframing a camera view to a rectified view of a surface in response to a two-handed pointing air gesture directed to the surface provides additional control options without cluttering the user interface with additional displayed controls and assists the user with composing media capture events, for instance, by allowing users to switch the camera view to a view of the surface using intuitive, easy-to-perform air gestures without needing to navigate additional displayed controls.

In some embodiments, reframing the camera view to include the respective changed field-of-view of the environment includes, in accordance with a determination that the request to reframe the camera view (e.g., the first set of one or more inputs) corresponds to a request for static reframing (e.g., 806A, 806B, 810A, 810B, 816, 824, 826, 834A, 834B, 836, 838, 840A, 840B, 852A, 852B, 856A, 856B, 858A, 858B, 860, and/or 862) (e.g., a request to reframe the camera view to include a particular region of the environment and/or a particular portion of the field-of-view of the one or more sensors without thereafter making additional changes (e.g., automatic changes) to the framing unless or until an additional reframing request and/or cancel gesture is detected), performing a first reframing operation (e.g., the requested reframing operation) to include the representation of the respective changed field-of-view of the environment in the camera view (e.g., as illustrated in FIG. 8E) and foregoing performing a second reframing operation (e.g., an automatic/dynamic framing operation) in response to the first set of one or more inputs corresponding to the request to reframe the camera view (e.g., as illustrated in FIG. 8F) (e.g., foregoing automatically changing the framing of the camera view based on changes to the environment, such as movements of one or more objects within the environment). For example, the first reframing operation pans and/or changes the zoom level of the camera view to include a particular region of the environment and/or a particular portion of the field-of-view of the one or more sensors based on the request to reframe the camera view. In some embodiments, after performing the first reframing operation (e.g., while displaying the camera view including the representation of the respective changed field-of-view of the environment), the computer system maintains displaying the camera view including the representation of the respective changed field-of-view of the environment until the air gesture (e.g., the cancel gesture) and/or a second set of one or more inputs corresponding to a second request to reframe the camera view is detected. In some embodiments, the request to reframe the camera view corresponds to a request for static reframing if the first set of one or more inputs includes an input corresponding to a selection of the respective changed field-of-view of the environment (e.g., a selection of the particular region of the environment, as opposed to a selection of a particular object recognized within the environment), such as a particular pointing gesture, framing gesture, air gesture, and/or voice input. In some embodiments, the request to reframe the camera view corresponds to a request for static reframing if the first set of inputs does not correspond to a request for dynamic reframing (e.g., static reframing is the default type of reframing). For example, the request to reframe the camera view corresponds to a request for static reframing if the first set of inputs does not include an input corresponding to a selection of the first object, such as a particular point gesture directed to the first object, a particular framing gesture framing the first object, a particular air gesture selecting a dynamic reframing (e.g., follow/lock) option associated with the first object (e.g., a subject indicator badge), and/or a particular voice input corresponding to a request for dynamic reframing (e.g., a speech input indicating an intent to follow and/or lock framing based on a recognized object). Providing user interfaces for statically reframing a camera view in response to a user input provides additional control options without cluttering the user interface with additional displayed controls and assists the user with composing media capture events, for instance, by allowing the user to select a static framing to use for the camera view even as the environment represented in the camera view changes, without needing to navigate additional displayed controls.

In some embodiments, reframing the camera view to include the respective changed field-of-view of the environment includes, in accordance with a determination that the request to reframe the camera view (e.g., the first set of one or more inputs) corresponds to a request for dynamic reframing based on a first object within the environment (e.g., 812, 830, and/or 832 as illustrated in FIGS. 8E and/or 8P) (e.g., a request for object tracking of one or more particular objects recognized within the environment), detecting, via the one or more input devices (e.g., via the one or more cameras and/or the one or more sensors; in some embodiments, within the representation of the field-of-view of the environment), a first movement of the first object with respect to the environment; and In some embodiments, the first movement of the first object with respect to the environment moves the first object outside of a threshold degree of centered within the current camera view (e.g., the representation of a field-of-view of the environment displayed when the first movement is detected). For example, the first object moves to within a threshold distance from one or more edges of the displayed representation of the field-of-view of the environment and/or moves at least a threshold amount out of the frame of the displayed representation. In some embodiments, the request to reframe the camera view corresponds to a request for dynamic reframing if the first set of one or more inputs includes an input corresponding to a selection of the first object, such as a particular point gesture directed to the first object, a particular framing gesture framing the first object, a particular air gesture selecting a dynamic reframing (e.g., follow, track, and/or lock framing) option associated with the first object (e.g., a subject indicator badge), and/or a particular voice input corresponding to a request for dynamic reframing (e.g., a speech input indicating an intent to follow a recognized object within the frame of the camera view). In some embodiments, if the first set of inputs does not correspond to a request for dynamic reframing, the request to reframe the camera view corresponds to a request for static reframing. In some embodiments, in response to detecting the movement of the first object with respect to the environment, reframing (e.g., based on the first movement of the first object) the camera view to include a representation of a changed field-of-view of the environment that includes the first object (e.g., as illustrated in FIGS. 8G and/or 8Q) (e.g., reframing the camera view to follow the first object). For example, in response to a request for dynamic reframing, the computer system automatically reframes the camera view one or more times based on detected movement(s) of the object, for instance, maintaining a representation of at least a threshold amount of the tracked object within the camera view and/or maintaining a representation of the tracked object within a threshold degree of centered within the camera view. In some embodiments, the computer system further detects a second movement of the first object with respect to the environment and, in response to detecting the second movement, reframes the camera view to include a representation of another changed field-of-view of the environment that includes the first object (e.g., based on the second movement of the first object). In some embodiments, the computer system continues to reframe the camera view to include the first object in response to detected movements of the first object until the air gesture (e.g., the cancel gesture) and/or a second set of one or more inputs corresponding to a second request to reframe the camera view is detected. Providing user interfaces for dynamically reframing a camera view based on changes to the environment captured in the camera view reduces the number of inputs needed to perform reframing operations and assists the user with composing media capture events, for instance, by allowing the user to select a framing to use for the camera view that automatically updates based on changes to the environment represented in the camera view, without requiring the user to provide additional inputs to update the framing.

In some embodiments, reframing the camera view to include the respective changed field-of-view of the environment includes, in accordance with the determination that the request to reframe the camera view corresponds to the request for dynamic reframing based on the first object within the environment, displaying, via the one or more display generation components, a tracking indication (e.g., a badge, icon, label, framing element, border element, fill effect, and/or other display element) corresponding to the first object (e.g., 808A and/or 808B as illustrated in FIGS. 8G and/or 8Q) (e.g., visually indicating that the first object is being tracked). In some embodiments, the tracking indicator is displayed before, during, and/or after reframing the camera view to include the representation of the changed field-of-view of the environment that includes the first object (e.g., until the air gesture (e.g., the cancel gesture) and/or a second set of one or more inputs corresponding to a second request to reframe the camera view is detected). Displaying an indication of an object being tracked for dynamic reframing of the camera view provides improved visual feedback to the user and assists the user with composing media capture events, for instance, by indicating the basis for automatic changes to the camera view to the user, allowing the user to review, adjust, and/or cancel the specific dynamic reframing operation to achieve the desired framing.

In some embodiments, displaying the tracking indication corresponding to the first object includes modifying, within the camera view (e.g., within a displayed representation of a current field-of-view of the environment, e.g., before, during, and/or after reframing based on the first movement of the first object), an appearance of a representation of the first object. For example, modifying the appearance of the first object includes applying one or more labels, badges, and/or fill effects (e.g., a shimmer, glow, and/or filter effect) to the first object in the camera view. In some embodiments, displaying the tracking indication corresponding to the first object includes modifying, within the camera view (e.g., within a displayed representation of a current field-of-view of the environment before, during, and/or after reframing based on the first movement of the first object), an appearance of a representation of a respective portion of the environment that does not include the first object. For example, modifying the appearance of the camera view outside of the first object includes displaying one or more border elements around the first object (e.g., an edge glow and/or keyline); one or more framing elements around the first object (e.g., a subject framing indicator displayed around all or part of the first object (e.g., around a user's face)); one or more badges, labels, and/or icons (e.g., displayed near the first object and/or at a predefined location); and/or one or more fill effects.

In some embodiments, the request for reframing the camera view corresponds to the request for dynamic reframing based on the first object within the environment in accordance with a determination that the first set of one or more inputs includes a selection input (e.g., 812) (e.g., a touch and/or air gesture input) directed to a visual indication (e.g., 808A and/or 808B) (e.g., a badge, icon, label, framing element, border element, and/or other display element) associated with the first object (e.g., as illustrated in FIG. 8E). In some embodiments, the selection input directed to the visual indication associated with the first object includes an air gesture, such as an air pinch and/or air tap, detected at a respective location, such as a location within the environment that corresponds to a location of the visual indication within the camera view (e.g., the air gesture is detected within the field-of-view of the environment represented in the camera view) and/or a location associated with selecting a displayed indication (e.g., while displaying an indication of a trackable object, the user can select the object to follow with an air pinch performed near the user's shoulder and/or another predefined selection location). For example, in response to detecting the selection input directed to the visual indication associated with the first object, the computer system automatically reframes the camera view one or more times based on detected movement(s) of the first object, for instance, maintaining a representation of at least a threshold amount of the tracked object within the camera view and/or maintaining a representation of the tracked object within a threshold degree of centered within the camera view.

In some embodiments, while displaying the camera view that includes the representation of the first field-of-view of the environment, the computer system detects, via the one or more input devices (e.g., via the one or more cameras and/or the one or more sensors; in some embodiments, within the representation of the field-of-view of the environment), the first object within the environment and, in response to detecting the first object within the environment, displays (in some embodiments, within the camera view including the representation of the first field-of-view of the environment), via the one or more display generation components, a respective indicator element (e.g., 808A, 808B, 808C, 808D, and/or 808E) (e.g., a badge, icon, label, framing element, border element, fill effect, and/or other display element) associated with the first object (e.g., as illustrated in FIGS. 8C-8E, 8H, 8P, and/or 8R). In some embodiments, the first object is at least partially within the first field-of-view of the environment (e.g., the representation of the first field-of-view of the environment includes a representation of at least a portion of the first object). In some embodiments, the computer system displays the respective indicator element at a location corresponding to a location of a representation of the first object within the camera view. In some embodiments, the respective indicator element is the visual indication associated with the first object (e.g., the respective indicator element can be selected to initiate dynamic reframing based on the first object). In some embodiments, the computer system detects a set of one or more candidate objects (e.g., including at least the first object and a second object) within the environment and displays a respective set of one or more indicator elements associated with the candidate objects (e.g., including at least a first respective indicator element associated with the first object and a second respective indicator element associated with the second object). In some embodiments, reframing the camera view to include the respective changed field-of-view of the environment includes, in accordance with the determination that the request to reframe the camera view corresponds to the request for dynamic reframing based on the first object within the environment (e.g., before, during, and/or after reframing based on the first movement of the first object), modifying an appearance of the respective indicator element associated with the first object (e.g., as illustrated in FIGS. 8G and/or 8Q) (e.g., changing one or more visual characteristics of the respective indicator element to indicate that the first object is being tracked). In some embodiments, modifying the appearance of the respective indicator element associated with the first object includes modifying the appearance of the representation of the first object and/or modifying the appearance of the respective portion of the environment that does not include the first object. In some embodiments, in accordance with a determination that the request to reframe the camera view corresponds to a request for dynamic reframing based on another candidate object (e.g., the second object) within the environment, the computer system modifies the appearance of an indicator element associated with the other candidate object (e.g., without modifying the appearance of the respective indicator element associated with the first object). For example, the computer system displays multiple indicators for multiple candidate objects and modifies the appearance of the indicator corresponding to a particular candidate object while dynamically tracking the particular candidate object. Displaying an indication of an object available to be tracked for dynamic reframing of the camera view and changing the appearance of the indication when the object is being tracked for dynamic reframing provides improved visual feedback to the user, provides additional control options without cluttering the user interface with additional displayed controls, and assists the user with composing media capture events, for instance, by allowing the user to initiate, review, adjust, and/or cancel a specific dynamic reframing operation without needing to navigate additional displayed controls.

In some embodiments, one or more air gestures (e.g., the cancel air gesture and/or one or more air gestures included in the first set of one or more inputs) are detected while capturing, via the one or more cameras, a video media capture (e.g., a video clip). In some embodiments, after capturing the video media capture and in accordance with a determination that a respective portion of the video media capture includes a representation of a first air gesture of the one or more air gestures (e.g., an air gesture is at least partially visible in one or more video frames of the capture), the computer system modifies (in some embodiments, automatically; in some embodiments, in response to a set of one or more user inputs corresponding to a request to modify framing) a video media item that includes the video media capture (e.g., a finalized video media item) to remove the representation of the first air gesture (e.g., as illustrated in FIG. 8V). In some embodiments, the computer system reframes the respective portion the first video media capture to crop out the representation of the air gesture (e.g., panning and/or zooming in the frame to exclude the visible air gesture). In some embodiments, the computer system modifies the first video media item to replace the respective portion of the video media capture (e.g., cutting to a different clip included in the first video media item, such as a different camera view). Automatically removing footage including reframing air gestures, such as the cancel air gesture, from finalized media reduces the number of inputs needed to perform reframing operations and assists the user with composing media capture events, for instance, by allowing users to specify the reframing of the camera view using intuitive, easy-to-perform air gestures without needing to manually edit the air gestures out of captured media, even if the air gestures were detected within the field-of-view of the cameras being captured for the media item.

In some embodiments, reframing the camera view to include a representation of a respective field-of-view of the environment (in some embodiments, reframing the camera view to include the representation the respective changed field-of-view of the environment, another changed field-of-view of the environment, or the third field-of-view of the environment) is performed while capturing, via the one or more cameras, a video media capture (e.g., a video clip) (e.g., as illustrated in FIGS. 8C-8I and/or 8L-8U). In some embodiments, reframing the camera view to include the representation of the respective field-of-view of the environment is performed during a first timeframe of the video media capture (e.g., as described with respect to 848A and/or 850A-850E in FIGS. 8V-8W), and, after capturing the video media capture, the computer system reframes (in some embodiments, automatically; in some embodiments, in response to a set of one or more user inputs corresponding to a request to modify framing) a video media item that includes the video media capture to include a respective representation of the respective field-of-view of the environment during a second timeframe of the video media capture, wherein the second timeframe of the video media capture is different from the first timeframe of the video media capture (e.g., as described with respect to 848B and/or 850A′-850E′ in FIGS. 8V-8W) (e.g., shifting the reframing timewise within the finalized video media item compared to the recording). Automatically modifying, in a finalized media item, the timing of a reframing of the camera view performed while capturing the media item provides improved visual feedback to the user, reduces the number of inputs needed to perform reframing operations, and assists the user with composing media capture events, for instance, by allowing users to monitor the reframing during the capture without needing to manually edit the captured media to refine the reframing (e.g., to remove system-and/or user-created latencies and/or timing inaccuracies in the live or near-live reframing).

In some embodiments, a span of the second timeframe is shorter than a span of the first timeframe (e.g., as illustrated in FIG. 8W) (e.g., reframing the video media item to the third field-of-view of the environment is faster in the final video than during the recording). In some embodiments, the second timeframe begins at an earlier point of the video media capture than the first timeframe (e.g., as illustrated in FIG. 8V) (e.g., reframing the video media item to the third field-of-view of the environment begins sooner in the final video than during the recording).

In some embodiments, reframing the camera view to include a representation of a respective field-of-view of the environment (in some embodiments, reframing the camera view to include the representation the respective changed field-of-view of the environment, another changed field-of-view of the environment, or the third field-of-view of the environment) is performed while capturing, via the one or more cameras, a video media capture (e.g., a video clip). In some embodiments, after capturing the video media capture, the computer system modifies (in some embodiments, automatically; in some embodiments, in response to a set of one or more user inputs corresponding to a request to modify framing) a video media item that includes the video media capture to include a respective representation of a different field-of-view of the environment than the respective field-of-view of the environment (e.g., as described with respect to FIGS. 8V-8W). For example, the zooming and/or panning performed to reframe the camera view while capturing is modified in the finalized video item, such that the video media item includes a portion of the video media capture framed at a different zoom level and/or at a different location than during the recording. Providing user interfaces for framing a camera view in a captured media item differently than the camera view was framed while capturing the media item assists the user with composing media capture events and reduces the risk that transient media capture opportunities are missed or mis-captured (e.g., due to unintended capture framing). For example, by providing options to refine, re-do, and/or remove the reframing performed based on the first set of one or more inputs and the air gesture in the finalized media item (e.g., the live reframing performed during the capture), the computer system allows users to quickly and intuitively reframe the camera view during captures without needing to provide additional inputs to specify the exact, final framing and/or foregoing the opportunity to change the framing once capture is completed.

In some embodiments, while displaying the camera view, the computer system detects, via the one or more input devices (e.g., via the one or more cameras and/or the one or more other input devices; in some embodiments, within the representation of the field-of-view of the environment), a respective air gesture corresponding to a request to initiate capturing media (e.g., 802 as illustrated in FIGS. 8A-8B). In some embodiments, the respective air gesture corresponding to the request to initiate capturing media includes an air gesture directed to a particular user interface element (e.g., a shutter button) and/or an air gesture of a particular type (e.g., a pinch, tap, double tap, and/or gesture holding up a particular number of fingers). For example, a pinch gesture directed to a displayed shutter button corresponds to a request to initiate a media capture (e.g., without a timer delay). As another example, a gesture extending one, two, or three fingers corresponds to a request to initiate a media capture after a one-, two-, or three-second delay timer (e.g., respectively). As another example, a double-tap air gesture corresponds to a request to initiate a media capture after a predetermined delay timer (e.g., a 3-, 5-, or 10-second delay). In some embodiments, in response to detecting the respective air gesture corresponding to the request to initiate capturing media, the computer system captures (e.g., initiating capturing), via the one or more cameras, a respective media capture (e.g., as illustrated in FIGS. 8B-8C). In some embodiments, the respective air gesture is detected prior to detecting the first set of one or more inputs corresponding to the request to initiate capturing media, and reframing from the first field-of-view of the environment to the respective changed field-of-view of the environment is captured in the respective media capture. In some embodiments, the respective air gesture is detected prior to detecting the air gesture (e.g., the cancel gesture), and reframing to the third field-of-view of the environment (e.g., the reversion of changes to the framing) is captured in the respective media capture. For example, while capturing the respective media capture, the computer system captures a field-of-view of the environment the same as or similar to the field-of-view of the environment represented in the camera view (e.g., the camera view provides a preview of the contents of the media capture). Initiating capturing media in response to an air gesture detected by the camera(s) used for capturing the media reduces the number of inputs needed to perform media capture operations, provides additional control options without cluttering the user interface with additional displayed controls, assists the user with composing media capture events, reduces the risk that transient media capture opportunities are missed or mis-captured. For example, using an air gesture to initiate capture provides users with flexibility to compose captures as desired, including captures with the user in the frame, without needing to physically touch the computer system and/or navigate additional displayed media capture options.

In some embodiments, while displaying the camera view, the computer system captures, via the one or more cameras, a video media capture (e.g., a video clip) and, while capturing the video media capture, detects, via the one or more input devices (e.g., via the one or more cameras and/or the one or more sensors; in some embodiments, within the representation of the field-of-view of the environment), a first clap gesture (e.g., 818A and/or 818B) (e.g., a gesture input striking two surfaces together, such as the palms and/or fingers of a user's two hands, to create a short burst of sound). In some embodiments, in response to detecting the first clap gesture, the computer system pauses capturing the video media capture (e.g., temporarily stopping capturing video media via the one or more cameras) while maintaining an option to resume capturing the video media capture (e.g., as illustrated in FIG. 8J) (e.g., an ability to un-pause capturing the video media capture). In some embodiments, while capture of the video media capture is paused (e.g., after pausing capturing the video media capture and while maintaining the option to resume capturing the video media capture), the computer system detects, via the one or more input devices (e.g., via the one or more cameras and/or the one or more other input devices; in some embodiments, within the representation of the field-of-view of the environment), a second clap gesture (e.g., 822A and/or 822B) and, in response to detecting the second clap gesture, resumes capturing the video media capture (e.g., as illustrated in FIG. 8K) (e.g., the video media capture includes both video data captured before detecting the first clap gesture and video data captured after detecting the second clap gesture). In some embodiments, the video media capture does not include video data captured between detecting the first clap gesture and detecting the second clap gesture (e.g., between pausing and resuming the capture). In some embodiments, the video media capture includes a respective portion of video data captured between detecting the first clap gesture and detecting the second clap gesture (e.g., the one or more cameras continue recording between claps), but the respective portion of video data is removed from a finalized video media item including the video media capture. Pausing capturing media in response to a first clap gesture and re-starting capturing the media in response to a second clap gesture reduces the number of inputs needed to perform media capture operations, provides additional control options without cluttering the user interface with additional displayed controls, and assists the user with composing media capture events. For example, using a clap gesture to pause and resume capture provides users with flexibility to compose multi-clip captures without needing to physically touch the computer system, navigate additional displayed media capture options, and/or manually edit multiple captured clips together to achieve the desired media composition.

In some embodiments, the first clap gesture (e.g., 818A) is detected, via the one or more cameras, at a respective location in the environment while displaying, via the one or more display generation components, the camera view including a representation of a respective field-of-view of the one or more cameras (e.g., the respective changed field-of-view of the environment and/or another field-of-view of the environment that is different from the third field-of-view of the environment) that includes the respective location in the environment (e.g., as illustrated in FIG. 8I) (e.g., the first clap gesture is detected within the frame of the camera view). In some embodiments, while capture of the video media capture is paused, the computer system displays, via the one or more display generation components, within the camera view, a guide indicator (e.g., 820A and/or 820B) (e.g., a line, border, icon, and/or image) at a location corresponding to the respective location in the environment (e.g., overlaying a representation of the respective location within the camera view). For example, the computer system displays a line, box, outline (e.g., of the hands performing the first clap gesture), and/or ghosted image (e.g., of the hands performing the first clap gesture) indicating the location where the first clap gesture was performed to assist the user with aligning the second clap gesture with the first in the video media capture. Providing a guide indicator for spatially aligning a clap gesture for resuming capturing media with the clap gesture used to pause capturing the media provides improved visual feedback to the user and assists the user with composing media capture events. For example, guiding the user to perform the clap gestures in the same location assists the user in composing multi-clip captures with seamless transitions between the clips.

In some embodiments, after capturing the video media capture, the computer system modifies a video media item including the video media capture to include a first portion of the video media capture corresponding to a first respective clap gesture (e.g., a first portion of video data showing the clap and/or audio data with the clap sound) without including a second portion of the video media capture corresponding to a second respective clap gesture that is different from the first respective clap gesture (e.g., as described with respect to FIG. 8K). In some embodiments, the first respective clap gesture is the first clap gesture and the second respective clap gesture is the second clap gesture (e.g., a finalized video includes the pause clap and removes the resume clap). In some embodiments, the first respective clap gesture is the second clap gesture and the second respective clap gesture is the first clap gesture (e.g., a finalized video removes the pause clap and includes the resume clap). In some embodiments, the video media item includes a composite clap gesture. For example, the video media item includes an initial portion of the first clap gesture composited with a latter portion of the second clap gesture, and does not include a latter portion of the first clap gesture or the initial portion of the second clap gesture. Automatically modifying a finalized media item to include a single clap gesture when a first and second clap gesture were used to pause and resume capturing the media item reduces the number of inputs needed to compose media captures and assists the user with composing media capture events, for instance, by automatically creating a seamless transition, marked by a single clap, between multiple clips without requiring the user to manually edit the clips together.

Note that details of the processes described above with respect to method 900 (e.g., FIG. 9) are also applicable in an analogous manner to the methods described above with respect to FIG. 7 and below with respect to FIG. 10. For example, methods 700 and 1000 optionally include one or more of the characteristics of the various methods described above with reference to method 900. For example, changes to media framing made using speech and gesture inputs, as described with respect to method 1000, can be reverted using an air gesture as described with respect to method 900. For example, when capturing media that is modified as described with respect to method 700, the inputs and processes described with respect to methods 900 and 1000 are used to control the framing of the media capture. For brevity, these details are not repeated.

FIG. 10 is a flow diagram illustrating a method for changing framing of a camera view based on speech and gesture inputs using a computer system in accordance with some embodiments. Method 1000 is performed at a computer system (e.g., 100, 300, 500, 600) (e.g., including one or more mobile phones, personal computers, laptops, tablets, headsets, wearable devices, and/or other electronic devices) that is in communication with one or more display generation components (e.g., 602) (e.g., a display controller; a touch-sensitive display system; a display (e.g., integrated and/or connected), a 3D display, a transparent display, a projector, and/or a heads-up display) and one or more input devices (e.g., touch-sensitive surfaces, hardware input devices (e.g., hardware buttons, switches, keys, and/or dials), microphones, gesture input devices, air gesture input devices, and/or gaze input devices)including one or more cameras (e.g., 604A, 604B, 604C, and/or 604D) (e.g., one or more rear (user-facing) cameras, forward (environment-facing) cameras, and/or externally-connected cameras, and/or a plurality of cameras with different lenses (e.g., different fixed focal lengths), such as a standard camera, a telephoto camera, a wide-angle camera, and/or a macro camera). In some embodiments, the computer system is optionally in communication with one or more sensors, such as optical sensors, depth sensors, capacitive sensors, intensity sensors, motion sensors, vibration sensors, audio sensors, light sensors, temperature sensors, and/or biometric sensors.

As described below, method 1000 provides an intuitive way of changing framing of a camera view based on speech and gesture inputs. The method reduces the cognitive burden on a user when changing framing of a camera view based on speech and gesture inputs, thereby creating a more efficient human-machine interface. For battery-operated computing devices, enabling a user to change framing of a camera view based on speech and gesture inputs faster and more efficiently conserves power and increases the time between battery charges.

While displaying, via the one or more display generation components, a camera viewfinder (e.g., 610) including a representation of a first field-of-view of an environment captured using the one or more cameras (e.g., a camera preview (e.g., a live or near-live camera viewfinder), e.g., for a media capture user interface and/or camera application), the computer system detects, via the one or more input devices, a first set of one or more gesture inputs (e.g., 806A, 810A, 812, 816, 824, 826, 830, 834A, 836, 840A, 852A, 856A, and/or 858A) (e.g., air gesture inputs, touch inputs, spoken inputs, and/or hardware inputs) for reframing the camera viewfinder. In some embodiments, the first set of one or more inputs is detected while performing a media capture operation using the one or more cameras, such as a video and/or photo media capture operation.

In response to detecting the first set of one or more gesture inputs for reframing the camera viewfinder (1004) and in accordance with a determination that the first set of one or more gesture inputs for reframing the camera viewfinder satisfies a first set of criteria that includes a requirement that the one or more gesture inputs were detected along with a first speech input (e.g., 806B, 810B, 832, 834B, 838, 840B, 852B, 856B, and/or 858B) in order for the first set of criteria to be met, the computer system displays (1006), in the camera viewfinder, a representation of a second field-of-view of the environment that is different from (e.g., at least partially different from) the first field-of-view of the environment (e.g., as illustrated in FIGS. 8E, 8Q-8U, and/or 8Y-8AA) (e.g., reframing the camera viewfinder to the second field-of-view). For example, displaying the second field-of-view of the environment includes panning, changing the zoom level, cropping, changing the capture angle, and/or changing the camera and/or camera data used in order to represent a different view of the environment in the viewfinder.

In response to detecting the first set of one or more gesture inputs for reframing the camera viewfinder (1004) and in accordance with a determination that the first set of one or more gesture inputs for reframing the camera viewfinder satisfies a second set of criteria that includes a requirement that the one or more gesture inputs were detected along with a second speech input (e.g., 806B, 810B, 832, 834B, 838, 840B, 852B, 856B, and/or 858B), different from the first speech input, in order for the second set of criteria to be met, the computer system displays (1008), in the camera viewfinder, a representation of a third field-of-view of the environment that is different from (e.g., at least partially different from) the first field-of-view of the environment and different from the second field-of-view of the environment (e.g., reframing the camera viewfinder in a different manner than in response to the first speech input) (e.g., as illustrated in FIGS. 8E, 8Q, 8S-8U, and/or 8Y-8AA). For example, the second speech input that corresponds to a different reframing request than the first speech input. For example, the computer system reframes the camera viewfinder based on the contents of a detected speech input. For example, the second speech input includes a request for a different reframing action (e.g., changing a zoom level, panning, rotating, changing direction, and/or changing the camera used), a different reframing direction (e.g., the requested direction in which to zoom, pan, and/or rotate the field-of-view with respect to the environment), a different reframing amount (e.g., the requested magnitude by which to change the zoom level, camera position, and/or camera angle), and/or a different reframing subject (e.g., requested contents of the environment to frame within the camera viewfinder) than requested in the first speech input. In some embodiments, in accordance with a determination that the first set of one or more inputs for reframing the camera viewfinder does not include a speech input, the computer system reframes the camera viewfinder in a different manner (e.g., as described with respect to FIG. 9). In some embodiments, in accordance with a determination that the first set of one or more inputs for reframing the camera viewfinder does not satisfy a respective set of criteria (e.g., the first set and/or second set of criteria), the computer system maintains foregoes taking an action to change the field-of-view represented in the camera viewfinder (e.g., the computer system does not reframe the camera viewfinder). In some embodiments, in accordance with a determination that the first set of one or more inputs for reframing the camera viewfinder satisfies a respective set of criteria other than the first and second set of criteria, wherein the respective set of criteria includes a criterion satisfied when the first set of one or more inputs includes a different speech input, the computer system displays a representation of a different field-of-view of the environment. Providing user interfaces for reframing a camera view in response to gesture inputs, where the reframing operation performed is based on voice inputs received along with the gesture inputs, reduces the number of inputs needed to perform reframing operations and provides additional control options without cluttering the user interface with additional displayed controls, making the user-system interface more efficient, which, additionally, reduces power usage and improves battery life of the system by enabling the user to use the system more quickly and efficiently. Doing so also assists the user with composing media capture events and reduces the risk that transient media capture opportunities are missed or mis-captured (e.g., due to unintended capture framing), which enhances the operability and ergonomics of the system and makes the user-system interface more efficient by helping the user to provide proper inputs and reducing user mistakes when operating/interacting with the system. For example, gesture and voice inputs provide efficient and intuitive control of specific and/or complex reframing requests (e.g., using a gesture to specify a direction of reframing and a voice input to simultaneously specify a subject of reframing) without requiring the user to provide additional manual reframing inputs, inputs at the device (e.g., touch and/or button inputs) during an ongoing media (e.g., video) capture, and/or inputs to manually edit the media to the desired framing.

In some embodiments, the first speech input (e.g., 832 and/or 852B) corresponds to a request to reframe the camera viewfinder to include a person (e.g., the request indicates that camera viewfinder should include at least one person after reframing). In some embodiments, the request to reframe the camera viewfinder to include the person includes a reference to one or more specific people in the environment (e.g., including at least the respective person) and/or a general and/or descriptive reference to a person or people (e.g., “Look at that guy in the hat,” “Look at them,” or “Pan over to the crowd”). In some embodiments, the computer system interprets the speech input based on camera data from the one or more cameras (e.g., determining that the first speech input corresponds to a request to reframe the camera viewfinder to include a person based on detecting at least one person in a field-of-view of at least one camera). In some embodiments, displaying, via the one or more display generation components, the representation of the second field-of-view of the environment includes reframing the camera viewfinder to include a representation of a respective person in the environment (e.g., as illustrated in FIGS. 8Q and/or 8Y) (e.g., the second field-of-view of the environment at least partially includes the respective person). In some embodiments, in accordance with the determination that the first set of one or more gesture inputs for reframing the camera viewfinder satisfies the first set of criteria, the computer system detects one or more candidate persons (e.g., including at least the respective person) in the environment (e.g., the second field-of-view of the environment is selected based on the detected person(s)). In some embodiments, the second field-of-view is associated with the respective person (e.g., the second field-of-view is a particular person's assigned camera feed). For example, the first speech input corresponds to a request to reframe the camera viewfinder to include a user of the computer system (e.g., “Look at me”), and displaying the representation of the second field-of-view of the environment includes displaying a representation of a field-of-view of one or more user-facing (e.g., selfie) cameras. Reframing a camera view to a view that includes a person if the reframing gesture inputs were received along with a voice input requesting to reframe the camera view to include a person reduces the number of inputs needed to perform reframing operations, provides additional control options without cluttering the user interface with additional displayed controls, and assists the user with composing media capture events. For example, by reframing the camera view to include a person based on the voice input, the computer system provides the user with intuitive control of the reframing without requiring the user to provide additional inputs to ensure that the desired content (e.g., the person) is captured in the frame and/or to navigate additional displayed controls for selecting the desired content.

In some embodiments, the first speech input (e.g., 852B) includes a respective name (e.g., a proper name, nickname, title, and/or other personal identifier) associated with the respective person in the environment. Reframing a camera view to a view that includes a specific person if the reframing gesture inputs were received along with a voice input including the specific person's name reduces the number of inputs needed to perform reframing operations, provides additional control options without cluttering the user interface with additional displayed controls, and assists the user with composing media capture events. For example, by reframing the camera view to include a specific person identified by name in the voice input, the computer system provides the user with intuitive control of the reframing without requiring the user to provide additional inputs to ensure that the desired content (e.g., the specific person) is captured in the frame and/or to navigate additional displayed controls for identifying the person to include in the reframed view.

In some embodiments, reframing the camera viewfinder to include the representation of the respective person in the environment includes detecting (e.g., identifying using image processing and/or machine vision techniques, such as facial recognition techniques) the respective person in a respective field-of-view of the environment (e.g., captured via at least one of the one or more cameras) based on a set of one or more media items associated with the respective name (e.g., as described with respect to FIGS. 8X-8Y). For example, the one or more media items include one or more photo and/or video media items (e.g., from a user's media library) that include tagged and/or detected representations of the respective person. Reframing a camera view to a view that includes a specific person by detecting the specific person based on media items associated with the person's name (e.g., media items in which the person was previously identified and/or labeled) reduces the number of inputs needed to perform reframing operations, provides additional control options without cluttering the user interface with additional displayed controls, and assists the user with composing media capture events. For example, the computer system uses the media items to automatically detect the specific person in the environment and reframe the camera view to include the specific person, without requiring the user to provide additional inputs to ensure that the desired content (e.g., the specific person) is captured in the frame and/or to navigate additional displayed controls for identifying the person to include in the reframed view.

In some embodiments, the first speech input (e.g., 832 and/or 852B) includes one or more words referencing the person (e.g., a speech input including a name, nickname, pronoun, and/or description corresponding to the person, such as “Look at her,” “Pan over to Brianna,” or “Zoom in on that dancing person near the stage”). In some embodiments, reframing the camera viewfinder to include the representation of the respective person in the environment includes detecting, via the one or more cameras, one or more candidate persons (e.g., including at least the respective person) in the environment based on the first speech input (e.g., the second field-of-view of the environment is selected based on the detected person(s)).

In some embodiments, the first speech input (e.g., 806B, 810B, 834B, 838, and/or 840B) corresponds to a request to reframe the camera viewfinder to include a landmark (e.g., one or more objects, buildings, areas, and/or regions) (e.g., the request indicates that camera viewfinder should include at least one landmark after reframing). In some embodiments, the request to reframe the camera viewfinder to include the landmark includes a reference to (e.g., name and/or other specific identifiers of) one or more specific landmarks in the environment (e.g., including at least the respective landmark) and/or a general and/or descriptive reference to one or more landmarks (e.g., “Look up ahead,” “Look at the green one,” or “Pan over the skyline”). In some embodiments, displaying the representation of the second field-of-view of the environment includes reframing the camera viewfinder to include a representation of a respective landmark in the environment (e.g., as illustrated in FIGS. 8E and/or 8S-8U) (e.g., the second field-of-view of the environment at least partially includes the respective landmark). In some embodiments, in accordance with the determination that the first set of one or more gesture inputs for reframing the camera viewfinder satisfies the first set of criteria, the computer system detects the respective landmark in the environment (e.g., the second field-of-view of the environment is selected based on the detected landmark). Reframing a camera view to a view that includes a landmark if the reframing gesture inputs were received along with a voice input requesting to reframe the camera view to include a landmark reduces the number of inputs needed to perform reframing operations, provides additional control options without cluttering the user interface with additional displayed controls, and assists the user with composing media capture events. For example, by reframing the camera view to include a landmark based on the voice input, the computer system provides the user with intuitive control of the reframing without requiring the user to provide additional inputs to ensure that the desired content (e.g., the landmark) is captured in the frame and/or to navigate additional displayed controls for specifying the landmark to include in the reframed view.

In some embodiments, the first speech input (e.g., 806B, 810B, 838, and/or 840B) includes one or more words corresponding to a respective form (e.g., a relative and/or absolute shape and/or size) of a landmark (e.g., “the tall jar,” “the rounder one,” and/or “the A-frame house”), and reframing the camera viewfinder to include the representation of the respective landmark in the environment includes detecting (e.g., identifying using image processing and/or machine vision techniques) the respective landmark in a respective field-of-view of the environment (e.g., captured via at least one of the one or more cameras) based on the one or more words corresponding to the respective form of the landmark (e.g., the second field-of-view of the environment is selected based on detecting a landmark with the shape identified in the speech input) (e.g., as described with respect to FIG. 8S (e.g., detecting the object corresponding to the words “tall jar”)). Reframing the camera view to include a landmark of a particular shape or size provides additional control options without cluttering the user interface with additional displayed controls and assists the user with composing media capture events, for example, by allowing the user to intuitively describe the landmark to include in the reframed view without requiring the user to provide additional inputs to ensure that a specific landmark is captured in the frame and/or to navigate additional displayed controls for selecting the landmark to include in the reframed view.

In some embodiments, the first speech input (e.g., 810B and/or 840B) includes one or more words corresponding to a respective color of a landmark, and reframing the camera viewfinder to include the representation of the respective landmark in the environment includes detecting (e.g., identifying using image processing and/or machine vision techniques) the respective landmark in a respective field-of-view of the environment (e.g., captured via at least one of the one or more cameras) based on the one or more words corresponding to the respective color of the landmark (e.g., the second field-of-view of the environment is selected based on detecting a landmark of the color identified in the speech input) (e.g., as described with respect to FIG. 8T (e.g., detecting the object corresponding to the words “red curry paste”)). Reframing the camera view to include a landmark of a particular color provides additional control options without cluttering the user interface with additional displayed controls and assists the user with composing media capture events, for example, by allowing the user to intuitively describe the landmark to include in the reframed view without requiring the user to provide additional inputs to ensure that a specific landmark is captured in the frame and/or to navigate additional displayed controls for selecting the landmark to include in the reframed view.

In some embodiments, the first speech input (e.g., 806B, 810B, 838, and/or 840B) includes one or more words corresponding to a respective type of a landmark (e.g., “the shoe,” “the tower,” “the marble statue,” and/or “the A-frame house”), and reframing the camera viewfinder to include the representation of the respective landmark in the environment includes detecting (e.g., identifying using image processing and/or machine vision techniques) the respective landmark in a respective field-of-view of the environment (e.g., captured via at least one of the one or more cameras) based on the one or more words corresponding to the respective type of the landmark (e.g., the second field-of-view of the environment is selected based on detecting a landmark of the type identified in the speech input) (e.g., as described with respect to FIGS. 8S-8T (e.g., detecting the object corresponding to the words “the... jar” or “the bowl... of curry paste”)). Reframing the camera view to include a landmark of a particular type provides additional control options without cluttering the user interface with additional displayed controls and assists the user with composing media capture events, for example, by allowing the user to intuitively describe the landmark to include in the reframed view without requiring the user to provide additional inputs to ensure that a specific landmark is captured in the frame and/or to navigate additional displayed controls for selecting the landmark to include in the reframed view.

In some embodiments, the first set of one or more gesture inputs for reframing the camera viewfinder includes an air gesture (e.g., 834A, 836, 840A, 852A, 856A, and/or 858A) (e.g., an air gesture including a hand pose and/or movement, such as a pointing gesture that extends and/or moves at least one finger with respect to at least one other finger) that indicates (e.g., moves and/or points in) a respective direction (e.g., as illustrated in FIGS. 8R-8T and/or 8X-8Z). In some embodiments, in response to detecting the first set of one or more gesture inputs and in accordance with a determination that the first set of one or more gesture inputs for reframing the camera viewfinder satisfies a set of criteria (e.g., the first set of criteria or the second set of criteria): in accordance with a determination that the respective direction is a first direction, the computer system displays, in the camera viewfinder, a representation of a first changed field-of-view of the environment (e.g., a field-of-view that is shifted in the first direction relative to the first field-of-view of the environment); and in accordance with a determination that the respective direction is a second direction that is different from the first direction, a representation of a second changed field-of-view of the environment that is different from the first changed field-of-view of the environment (e.g., a field-of-view that is shifted in the second direction relative to the first field-of-view of the environment), for example, as illustrated in FIGS. 8Y-8AA. Providing user interfaces for reframing the camera view based on an air gesture that indicates a particular direction provides additional control options without cluttering the user interface with additional displayed controls and assists the user with composing media capture events, for example, by allowing the user to intuitively specify a direction in which to reframe the camera view without needing to provide additional inputs and/or navigate additional displayed controls for reframing in a desired direction.

In some embodiments, the first set of criteria includes a requirement that the respective direction is a first direction in order for the first set of criteria to be met (e.g., 856A and 856B as illustrated in FIGS. 8Y-8Z). For example, reframing the camera view from the first field-of-view of the environment to the second field-of-view of the environment includes panning the camera view in the first direction (e.g., the direction indicated by the air gesture input). In some embodiments, response to detecting the first set of one or more gesture inputs for reframing the camera viewfinder and in accordance with a determination that the first set of one or more gesture inputs for reframing the camera viewfinder satisfies a third set of criteria, the computer system displays, in the camera viewfinder, a representation of a fourth field-of-view of the environment that is different from (e.g., at least partially different from) the first field-of-view of the environment and the second field-of-view of the environment (e.g., reframing the camera viewfinder to the third field-of-view). For example, reframing the camera view from the first field-of-view of the environment to the fourth field-of-view of the environment includes panning the camera view in the second direction (e.g., the direction indicated by the air gesture input). In some embodiments, the third set of criteria includes the requirement that the one or more gesture inputs (e.g., 858A) were detected along with the first speech (e.g., 858B) input in order for the third set of criteria to be met and a requirement that the respective direction is a second direction that is different than the first direction in order for the third set of criteria to be met (e.g., as illustrated in FIGS. 8Z-8AA). In some embodiments, in accordance with a determination that the first set of one or more inputs for reframing the camera viewfinder does not include a speech input, the computer system reframes the camera viewfinder in a different manner (e.g., as described with respect to FIG. 9). For example, the computer system reframes the camera viewfinder differently in response to a set of gestures detected along with a particular speech input depending on a direction indicated by the gestures. In some embodiments, in accordance with a determination that either the requirement that the respective direction is the second direction is not satisfied (e.g., the first set of criteria is not satisfied) or the requirement that the respective direction is the second direction is not satisfied (e.g., the second set of criteria is not satisfied), the computer system displays, in the camera viewfinder, a changed field-of-view of the environment that is different than the first field-of-view of the environment, the second field-of-view of the environment, and the fourth field-of-view of the environment (e.g., the computer system reframes the camera view by panning in a different direction and/or performing a different reframing operation (e.g., zooming in or out and/or changing the camera(s) being used). Providing user interfaces for reframing the camera view based on an air gesture that indicates a particular direction provides additional control options without cluttering the user interface with additional displayed controls and assists the user with composing media capture events, for example, by allowing the user to refine a voice request for reframing using intuitive air gestures, without needing to provide additional inputs and/or navigate additional displayed controls for reframing in a desired direction.

In some embodiments, the first speech input (e.g., 810B, 832, 834B, 840B, 852B, 856B, 858B, 860, and/or 862) includes a reference to a respective reframing operation (e.g., one or more words and/or phrases associated with camera framing, such as “look,” “show,” “zoom,” “pan,” “change the view,” “pull back,” “reframe,” and/or “follow”). For example, the computer system identifies the reference to the respective reframing operation using a speech library, ontology, and/or large language model (e.g., LLM). In some embodiments, the computer system reframes the camera viewfinder based on the reference to the respective reframing operation and the first set of one or more inputs. For example, displaying the representation of the second field-of-view of the environment includes performing the respective reframing operation specified in the first speech input based on a respective direction and/or respective subject indicated by the first set of one or more gestures (e.g., zooming in on a particular subject based on a speech input including the phrase “zoom in” and a gesture input pointing to or framing the particular subject; panning in a particular direction based on a speech input including the phrase “look over there” and a gesture input pointing in the particular direction). Providing user interfaces for reframing the camera view based on one or more gesture inputs and a voice input that references reframing reduces the number of inputs needed to perform reframing operations, provides additional control options without cluttering the user interface with additional displayed controls, and assists the user with composing media capture events. For example, the computer system confirms the user's intent to reframe the camera view based on the voice input and thus reduces the risk of reframing the camera view in response to movements of the user's hands that are not intended as reframing inputs.

In some embodiments, displaying the representation of the first field-of-view of the environment includes displaying, via the one or more display generation components, a representation of a first portion of a respective field-of-view of the environment captured by a respective set of the one or more cameras (e.g., an overall field-of-view of the environment as captured by one or more particular cameras in a particular position and/or orientation within the physical environment); and displaying the representation of the second field-of-view of the environment includes displaying, via the one or more display generation components, a representation of a second portion of the respective field-of-view of the environment captured by the respective set of the one or more cameras, wherein the second portion of the respective field-of-view of the environment is a different portion of the respective field-of-view of the environment than the first portion of the respective field-of-view of the environment (e.g., the computer system digitally reframes the camera viewfinder to include a different portion of the captured field-of-view of the environment, e.g., without necessarily changing which cameras are used and/or their position and/or orientation within the environment). For example, changing from the first field-of-view of the environment to the second field-of-view of the environment includes performing one or more digital reframing processes, such as changing a digital magnification level, digitally cropping a different portion from the captured field-of-view of the environment, and/or digitally modifying the captured field-of-view of the environment to display a representation of the different portion (e.g., digitally removing warping and/or generating a rectified view from a field-of-view of the environment captured using a wide-angle lens). Providing user interfaces for digitally reframing a camera view using gesture and voice inputs provides additional control options without cluttering the user interface with additional displayed controls and assists the user with composing media capture events. For example, gesture and voice inputs allow users to efficiently and intuitively define the specific framing of media captured using particular cameras without needing to navigate additional displayed controls for performing the specific digital reframing operations.

In some embodiments, displaying the representation of the first field-of-view of the environment includes capturing the first field-of-view of the environment using a first physical configuration of the one or more cameras, and displaying the representation of the second field-of-view of the environment includes capturing the second field-of-view of the environment using a second physical configuration of the one or more cameras that is different from the first physical configuration of the one or more cameras. In some embodiments, the first physical configuration includes capturing the first field-of-view of the environment using a first set of the one or more cameras (e.g., using particular camera hardware, such as one or more environment-facing cameras) and the second physical configuration includes capturing the second field-of-view of the environment using a different set of the one or more cameras (e.g., using different environment-facing cameras and/or switching to one or more user-facing cameras). In some embodiments, the first physical configuration includes capturing the first field-of-view of the environment from a first position and/or orientation within the environment (e.g., the cameras being used are positioned at a particular place and/or aimed in a particular direction), and the second physical configuration includes capturing the first field-of-view of the environment from a different position and/or orientation within the environment (e.g., the computer system switches to one or more cameras positioned and/or oriented differently and/or moves the cameras using, e.g., a motorized camera mount system that is in communication with (e.g., controlled by) the computer system). Providing user interfaces for physically reframing a camera view using gesture and voice inputs provides additional control options without cluttering the user interface with additional displayed controls and assists the user with composing media capture events. For example, gesture and voice inputs allow users to efficiently and intuitively control the capture of media without needing to navigate additional displayed controls for different physical capture configurations (e.g., options for controlling the cameras used and/or the physical positioning of the cameras).

In some embodiments, the first speech input (e.g., 810B, 832, 834B, 840B, 852B, 856B, 858B, 860, and/or 862) includes a reference to a first type of reframing operation (e.g., a particular type, amount, direction, and/or basis of a change from the first field-of-view of the environment to the second field-of-view of the environment). For example, the first type of reframing operation includes reframing the environment in a particular way (e.g., panning, zooming, and/or changing camera), in a particular direction, with a particular magnitude, and/or based on a particular subject (e.g., one or more objects in the environment to follow). In some embodiments, displaying the representation of the second field-of-view of the environment includes performing the first type of reframing operation (e.g., as illustrated in FIGS. 8E, 8Q, 8S, 8U, and/or 8AB-8AC) (e.g., to change the camera viewfinder from the first field-of-view of the environment to the second field-of-view of the environment). In some embodiments, the computer system selects the second field-of-view of the environment based on both the first set of one or more gesture inputs and the first speech input (e.g., the gesture inputs refine and/or reinforce the reference to the first type of reframing operation). In some embodiments, the second speech input includes a reference to a second type of reframing operation that is different from the first type of reframing operation, and displaying the representation of the third field-of-view of the environment includes performing the second type of reframing operation. For example, the second speech input specifies a different reframing type, reframing direction, reframing magnitude, and/or subject than the first speech input. Reframing the camera view based on a type of reframing (e.g., a specific change to the framing) specified in a voice input provides additional control options without cluttering the user interface with additional displayed controls and assists the user with composing media capture events. For example, gesture and voice inputs allow users to efficiently and intuitively control the capture of media without needing to navigate additional displayed controls to perform different types of reframing operations.

In some embodiments, the reference to the first type of reframing operation includes a request to zoom in (e.g., 810B and/or 834B), and performing the first type of reframing operation includes increasing a zoom level of the camera viewfinder (e.g., in comparison to a zoom level of the first field-of-view of the environment) (e.g., as illustrated in FIGS. 8E, 8O, and/or 8S). For example, increasing the zoom level of the camera viewfinder includes displaying, in the camera viewfinder, a representation of a field-of-view that is smaller than (e.g., includes a smaller portion of the environment than) the first field-of-view of the environment. In some embodiments, increasing the zoom level of the camera viewfinder includes performing a digital zoom operation (e.g., cropping and/or upsampling a smaller portion of a field-of-view of a particular camera) and/or performing an optical zoom operation (e.g., capturing camera data at a higher optical zoom level, for instance, switching to using a lens with a higher magnification). In some embodiments, the reference to the first type of reframing operation includes a request to zoom out (e.g., 860), and displaying the representation of the second field-of-view of the environment includes decreasing a zoom level of the camera viewfinder (e.g., in comparison to a zoom level of the first field-of-view of the environment) (e.g., as illustrated in FIGS. 8L and/or 8AB). For example, decreasing the zoom level of the camera viewfinder includes displaying, in the camera viewfinder, a representation of a field-of-view that is larger than (e.g., includes a larger portion of the environment than) the first field-of-view of the environment. In some embodiments, decreasing the zoom level of the camera viewfinder includes performing a digital zoom operation (e.g., cropping to include a larger portion of a field-of-view of a particular camera) and/or performing an optical zoom operation (e.g., capturing camera data at a lower optical zoom level, for instance, switching to using a lens with a lower magnification).

In some embodiments, the reference to the first type of reframing operation includes a request for dynamic reframing based on a respective object in the environment (e.g., 832). In some embodiments, the computer system selects the second field-of-view of the environment based on the location of the respective object in the environment, such that the representation of the second field-of-view of the environment includes a representation of the respective object in the environment. In some embodiments, after displaying the representation of the second field-of-view of the environment, the computer system detects, via the one or more cameras, a movement of the respective object in the environment, and, in response to detecting the movement of the respective object in the environment, the computer system displays, via the one or more display generation components, in the camera viewfinder, a representation of a fourth field-of-view of the environment that is different from (e.g., at least partially different from) the fourth field-of-view of the environment (e.g., as illustrated in FIGS. 8G and/or 8Q-8R) (e.g., reframing the camera viewfinder to the fourth field-of-view). In some embodiments, the computer system selects the fourth field-of-view of the environment based on the location of the respective object in the environment following the movement of the respective object, such that the representation of the fourth field-of-view of the environment includes a representation of the respective object in the environment (e.g., in response to the first set of one or more gesture inputs and the first speech input, the computer system dynamically reframes the camera viewfinder to follow the respective object in the environment). Dynamically reframing the camera view based on detected movement of a physical object specified in a voice input reduces the number of inputs needed to perform reframing operations, provides additional control options without cluttering the user interface with additional displayed controls, and assists the user with composing media capture events. For example, gesture and voice inputs allow users to efficiently and intuitively control the capture of media based on the context of the physical environment without needing to navigate additional displayed controls to set up dynamic reframing for a particular object and/or to manually reframe the camera view as the particular object moves within the physical environment.

In some embodiments, while displaying the camera viewfinder including a representation of a first respective field-of-view of the environment, the computer system detects, via the one or more input devices, a second set of one or more gesture inputs (e.g., 806A, 810A, 812, 816, 824, 826, 830, 834A, 836, 840A, 852A, 856A, and/or 858A) for reframing the camera viewfinder. In some embodiments, a speech input is not detected along with the second set of one or more gesture inputs (e.g., the second set of one or more gesture inputs does not satisfy the first or second sets of criteria). In some embodiments, in response to detecting the second set of one or more gesture inputs and in accordance with a determination that the second set of one or more gesture inputs includes a respective gesture input of a respective type (e.g., a specific hand gesture performed with a particular pose and/or particular movement), the computer system displays, via the one or more display generation components, in the camera viewfinder, a representation of a second respective field-of-view of the environment that is different from the first respective field-of-view of the environment (e.g., as illustrated in FIG. 8E, 8I, 8M, 8O, 8Q, 8S-8U, and/or 8Y-8AA) (e.g., the computer system reframes the camera viewfinder based on the respective gesture input of the respective type without requiring a speech input, e.g., as described with respect to FIG. 9). For example, the respective gesture input is a specific hand gesture (e.g., a hand gesture performed with a particular pose and/or movement), which the computer system does not require a speech input to interpret and/or confirm as a valid reframing request. In some embodiments, the second respective field-of-view of the environment is the same as the second field-of-view of the environment (e.g., the second set of one or more gesture inputs results in the same reframing as the combination of the first set of one or more gesture inputs and the first speech input). In some embodiments, the second respective field-of-view of the environment is the same as the third field-of-view of the environment (e.g., the second set of one or more gesture inputs results in the same reframing as the combination of the first set of one or more gesture inputs and the second speech input). In some embodiments, in accordance with a determination that the second set of one or more gesture inputs includes a respective gesture input of a second respective type different from the respective type, the computer system displays, in the camera viewfinder, a representation of a third respective field-of-view of the environment that is different from the first respective field-of-view of the environment and the second respective field-of-view of the environment (e.g., different specific hand gestures are used to perform different reframing operations without needing to provide a voice input). Providing user interfaces for reframing a camera view in response to either specific gesture inputs or gesture inputs with accompanying voice inputs provides additional control options without cluttering the user interface with additional displayed controls and assists the user with composing media capture events. For example, providing the option to specify a camera view using gesture inputs with or without accompanying speech inputs gives users additional flexibility when controlling the framing of the camera view without needing to navigate additional displayed controls to achieve the desired framing.

In some embodiments, while displaying the camera viewfinder including a representation of a first respective field-of-view of the environment, the computer system detects, via the one or more input devices, a respective speech input. In some embodiments, a set of one or more gesture inputs is not detected along with the respective speech input. In some embodiments, in response to detecting the respective speech input and in accordance with a determination that the respective speech input includes a reference (e.g., one or more words and/or phrases) to a respective reframing operation (e.g., 810B, 832, 840B, 860, and/or 862), the computer system displays, via the one or more display generation components, in the camera viewfinder, a representation of a second respective field-of-view of the environment that is different from the first respective field-of-view of the environment (e.g., as illustrated in FIGS. 8E, 8Q, 8U, and/or 8AB-8AC). For example, the respective speech input is a specific spoken reframing request, which the computer system does not require gesture inputs to interpret and/or confirm as a valid reframing request. In some embodiments, the second respective field-of-view of the environment is the same as the second field-of-view of the environment (e.g., the respective speech input results in the same reframing as the combination of the first set of one or more gesture inputs and the first speech input). In some embodiments, the second respective field-of-view of the environment is the same as the third field-of-view of the environment (e.g., the respective speech input results in the same reframing as the combination of the first set of one or more gesture inputs and the second speech input). In some embodiments, in accordance with a determination that the respective speech input includes a reference to a second respective reframing operation that is different from the respective reframing operation (e.g., a spoken request that specifies a different type, direction, magnitude, and/or rate of change to the framing of the camera viewfinder), the computer system displays, in the camera viewfinder, a representation of a third respective field-of-view of the environment that is different from the first respective field-of-view of the environment and the second respective field-of-view of the environment (e.g., different specific voice inputs are used to perform different reframing operations without needing to provide gesture inputs). Providing user interfaces for reframing a camera view in response to either specific voice inputs or gesture inputs with accompanying voice inputs provides additional control options without cluttering the user interface with additional displayed controls and assists the user with composing media capture events. For example, providing the option to specify a camera view using voice inputs with or without accompanying gesture inputs gives users additional flexibility when controlling the framing of the camera view without needing to navigate additional displayed controls to achieve the desired framing.

Note that details of the processes described above with respect to method 1000 (e.g., FIG. 10) are also applicable in an analogous manner to the methods described above with respect to FIGS. 7 and 9. For example, methods 700 and 900 optionally include one or more of the characteristics of the various methods described above with reference to method 1000. For example, changes to media framing made using speech and gesture inputs, as described with respect to method 1000, can be reverted using an air gesture as described with respect to method 900. For example, when capturing media that is modified as described with respect to method 700, the inputs and processes described with respect to methods 900 and 1000 are used to control the framing of the media capture. For brevity, these details are not repeated.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve the generation of media items using computer systems. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to generate media items based on user-specific settings and/or context. Accordingly, use of such personal information data enables users to have personalized control of media generation. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of generating media items, the present technology can be configured to allow users to select to “opt in” or “opt out” of participation in the collection of personal information data during registration for services or anytime thereafter. In another example, users can select not to provide mood-associated data for generating media items. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, controls for generating media items can be personalized to users by inferring preferences based on non-personal information data or a bare minimum amount of personal information, such as the content being requested by the device associated with a user, other non-personal information available to the media generation systems, or publicly available information.

What is claimed is:

1. A computer system configured to communicate with one or more display generation components and one or more input devices including one or more cameras, the computer system comprising:
one or more processors; and
memory storing one or more programs configured to be executed by the one or more processors, the one or more programs including instructions for:
while displaying, via the one or more display generation components, a camera viewfinder including a representation of a first field-of-view of an environment captured using the one or more cameras, detecting, via the one or more input devices, a first set of one or more gesture inputs for reframing the camera viewfinder; and
in response to detecting the first set of one or more gesture inputs for reframing the camera viewfinder:
in accordance with a determination that the first set of one or more gesture inputs for reframing the camera viewfinder satisfies a first set of criteria that includes a requirement that the one or more gesture inputs were detected along with a first speech input in order for the first set of criteria to be met, displaying, in the camera viewfinder, a representation of a second field-of-view of the environment that is different from the first field-of-view of the environment; and
in accordance with a determination that the first set of one or more gesture inputs for reframing the camera viewfinder satisfies a second set of criteria that includes a requirement that the one or more gesture inputs were detected along with a second speech input, different from the first speech input, in order for the second set of criteria to be met, displaying, in the camera viewfinder, a representation of a third field-of-view of the environment that is different from the first field-of-view of the environment and different from the second field-of-view of the environment.

2. The computer system of claim 1, wherein:
the first speech input corresponds to a request to reframe the camera viewfinder to include a person; and
displaying, via the one or more display generation components, the representation of the second field-of-view of the environment includes reframing the camera viewfinder to include a representation of a respective person in the environment.

3. The computer system of claim 2, wherein the first speech input includes a respective name associated with the respective person in the environment.

4. The computer system of claim 3, wherein reframing the camera viewfinder to include the representation of the respective person in the environment includes:
detecting the respective person in a respective field-of-view of the environment based on a set of one or more media items associated with the respective name.

5. The computer system of claim 2, wherein the first speech input includes one or more words referencing the person.

6. The computer system of claim 1, wherein:
the first speech input corresponds to a request to reframe the camera viewfinder to include a landmark; and
displaying the representation of the second field-of-view of the environment includes reframing the camera viewfinder to include a representation of a respective landmark in the environment.

7. The computer system of claim 6, wherein:
the first speech input includes one or more words corresponding to a respective form of a landmark; and
reframing the camera viewfinder to include the representation of the respective landmark in the environment includes detecting the respective landmark in a respective field-of-view of the environment based on the one or more words corresponding to the respective form of the landmark.

8. The computer system of claim 6, wherein:
the first speech input includes one or more words corresponding to a respective color of a landmark; and
reframing the camera viewfinder to include the representation of the respective landmark in the environment includes detecting the respective landmark in a respective field-of-view of the environment based on the one or more words corresponding to the respective color of the landmark.

9. The computer system of claim 6, wherein:
the first speech input includes one or more words corresponding to a respective type of a landmark; and
reframing the camera viewfinder to include the representation of the respective landmark in the environment includes detecting the respective landmark in a respective field-of-view of the environment based on the one or more words corresponding to the respective type of the landmark.

10. The computer system of claim 1, wherein the first set of one or more gesture inputs for reframing the camera viewfinder includes an air gesture that indicates a respective direction.

11. The computer system of claim 10, wherein:
the first set of criteria includes a requirement that the respective direction is a first direction in order for the first set of criteria to be met; and
the one or more programs further include instructions for:
in response to detecting the first set of one or more gesture inputs for reframing the camera viewfinder:
in accordance with a determination that the first set of one or more gesture inputs for reframing the camera viewfinder satisfies a third set of criteria, displaying, in the camera viewfinder, a representation of a fourth field-of-view of the environment that is different from the first field-of-view of the environment and the second field-of-view of the environment, wherein the third set of criteria includes:
the requirement that the one or more gesture inputs were detected along with the first speech input in order for the third set of criteria to be met; and
a requirement that the respective direction is a second direction that is different than the first direction in order for the third set of criteria to be met.

12. The computer system of claim 1, wherein the first speech input includes a reference to a respective reframing operation.

13. The computer system of claim 1, wherein:
displaying the representation of the first field-of-view of the environment includes displaying, via the one or more display generation components, a representation of a first portion of a respective field-of-view of the environment captured by a respective set of the one or more cameras; and
displaying the representation of the second field-of-view of the environment includes displaying, via the one or more display generation components, a representation of a second portion of the respective field-of-view of the environment captured by the respective set of the one or more cameras, wherein the second portion of the respective field-of-view of the environment is a different portion of the respective field-of-view of the environment than the first portion of the respective field-of-view of the environment.

14. The computer system of claim 1, wherein:
displaying the representation of the first field-of-view of the environment includes capturing the first field-of-view of the environment using a first physical configuration of the one or more cameras; and
displaying the representation of the second field-of-view of the environment includes capturing the second field-of-view of the environment using a second physical configuration of the one or more cameras that is different from the first physical configuration of the one or more cameras.

15. The computer system of claim 1, wherein:
the first speech input includes a reference to a first type of reframing operation; and
displaying the representation of the second field-of-view of the environment includes performing the first type of reframing operation.

16. The computer system of claim 15, wherein:
the reference to the first type of reframing operation includes a request to zoom in; and
performing the first type of reframing operation includes increasing a zoom level of the camera viewfinder.

17. The computer system of claim 15, wherein:
the reference to the first type of reframing operation includes a request to zoom out; and
displaying the representation of the second field-of-view of the environment includes decreasing a zoom level of the camera viewfinder.

18. The computer system of claim 15, wherein:
the reference to the first type of reframing operation includes a request for dynamic reframing based on a respective object in the environment; and
the one or more programs further include instructions for:
after displaying the representation of the second field-of-view of the environment:
detecting, via the one or more cameras, a movement of the respective object in the environment; and
in response to detecting the movement of the respective object in the environment, displaying, via the one or more display generation components, in the camera viewfinder, a representation of a fourth field-of-view of the environment that is different from the fourth field-of-view of the environment.

19. The computer system of claim 1, the one or more programs further including instructions for:
while displaying the camera viewfinder including a representation of a first respective field-of-view of the environment, detecting, via the one or more input devices, a second set of one or more gesture inputs for reframing the camera viewfinder; and
in response to detecting the second set of one or more gesture inputs:
in accordance with a determination that the second set of one or more gesture inputs includes a respective gesture input of a respective type, displaying, via the one or more display generation components, in the camera viewfinder, a representation of a second respective field-of-view of the environment that is different from the first respective field-of-view of the environment.

20. The computer system of claim 1, the one or more programs further including instructions for:
while displaying the camera viewfinder including a representation of a first respective field-of-view of the environment, detecting, via the one or more input devices, a respective speech input; and
in response to detecting the respective speech input:
in accordance with a determination that the respective speech input includes a reference to a respective reframing operation, displaying, via the one or more display generation components, in the camera viewfinder, a representation of a second respective field-of-view of the environment that is different from the first respective field-of-view of the environment.

21. A non-transitory computer-readable storage medium storing one or more programs configured to be executed by one or more processors of a computer system that is in communication with one or more display generation components and one or more input devices including one or more cameras, the one or more programs including instructions for:
while displaying, via the one or more display generation components, a camera viewfinder including a representation of a first field-of-view of an environment captured using the one or more cameras, detecting, via the one or more input devices, a first set of one or more gesture inputs for reframing the camera viewfinder; and
in response to detecting the first set of one or more gesture inputs for reframing the camera viewfinder:
in accordance with a determination that the first set of one or more gesture inputs for reframing the camera viewfinder satisfies a first set of criteria that includes a requirement that the one or more gesture inputs were detected along with a first speech input in order for the first set of criteria to be met, displaying, in the camera viewfinder, a representation of a second field-of-view of the environment that is different from the first field-of-view of the environment; and
in accordance with a determination that the first set of one or more gesture inputs for reframing the camera viewfinder satisfies a second set of criteria that includes a requirement that the one or more gesture inputs were detected along with a second speech input, different from the first speech input, in order for the second set of criteria to be met, displaying, in the camera viewfinder, a representation of a third field-of-view of the environment that is different from the first field-of-view of the environment and different from the second field-of-view of the environment.

22. A method, comprising:
at a computer system that is in communication with one or more display generation components and one or more input devices including one or more cameras:
while displaying, via the one or more display generation components, a camera viewfinder including a representation of a first field-of-view of an environment captured using the one or more cameras, detecting, via the one or more input devices, a first set of one or more gesture inputs for reframing the camera viewfinder; and
in response to detecting the first set of one or more gesture inputs for reframing the camera viewfinder:
in accordance with a determination that the first set of one or more gesture inputs for reframing the camera viewfinder satisfies a first set of criteria that includes a requirement that the one or more gesture inputs were detected along with a first speech input in order for the first set of criteria to be met, displaying, in the camera viewfinder, a representation of a second field-of-view of the environment that is different from the first field-of-view of the environment; and
in accordance with a determination that the first set of one or more gesture inputs for reframing the camera viewfinder satisfies a second set of criteria that includes a requirement that the one or more gesture inputs were detected along with a second speech input, different from the first speech input, in order for the second set of criteria to be met, displaying, in the camera viewfinder, a representation of a third field-of-view of the environment that is different from the first field-of-view of the environment and different from the second field-of-view of the environment.
